(19) United States
(12) Patent Application Publication
(10) Pub. No.: US 2012/0133273 A1
(43) Pub. Date: May 31, 2012

(54) Organometallic Complex, Light-Emitting Element, Light-Emitting Device, Electronic Device, and Lighting Device

(75) Inventors: Hideko Inoue, Atsugi (JP); Tomoka Nakagawa, Atsugi (JP); Nobuharu Ohsawa, Zama (JP); Satoshi Seo, Sagamihara (JP)

(73) Assignee: Semiconductor Energy Laboratory Co., Ltd.

(21) Appl. No.: 13/304,027

(22) Filed: Nov. 23, 2011

(30) Foreign Application Priority Data
Nov. 26, 2010 (JP) 2010-264378
Jul. 20, 2011 (JP) 2011-159263

(51) Int. Cl. H01J 1/63; C07F 15/00

(52) U.S. Cl. 313/504; 548/103

(57) ABSTRACT

Provided is a novel organometallic complex that has an emission region in the wavelength band of green to blue and high reliability. Provided is an organometallic complex including a structure represented by a general formula (G1). The organometallic complex represented by the general formula (G1) is a novel organometallic complex that has an emission region in the wavelength band of green to blue and high reliability. Further provided is a light-emitting element including the organometallic complex, and a light-emitting device, an electronic device, and a lighting device each using the light-emitting element.

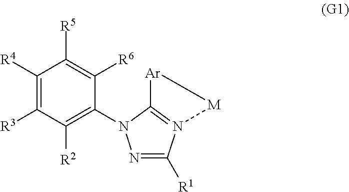

### TECHNICAL FIELD

The present invention relates to an organometallic complex. In particular, the present invention relates to an organometallic complex that can convert the energy of a triplet excited state into the energy of luminance. In addition, the present invention relates to a light-emitting element, a light-emitting device, an electronic device, and a lighting device each using the organometallic complex.

### BACKGROUND ART

In recent years, a light-emitting element using a light-emitting organic compound or inorganic compound as a light-emitting material has been actively developed. In particular, a light-emitting element called an EL (electroluminescence) element has attracted attention as a next-generation flat panel display element because it has a simple structure in which a light-emitting layer containing a light-emitting material is provided between electrodes, and characteristics such as feasibility of being thinner and more lightweight and responsive to input signals and capability of driving with direct current at a low voltage. In addition, a display using such a light-emitting element has a feature that it is excellent in contrast and image quality, and has a wide viewing angle. Further, since such a light-emitting element is a plane light source, the light-emitting element is considered to be applicable to a light source such as a backlight of a liquid crystal display and lighting.

In the case where the light-emitting substance is an organic compound having a light-emitting property, the emission mechanism of the light-emitting element is a carrier-injection type. That is, by applying a voltage with a light-emitting layer interposed between electrodes, electrons and holes injected from electrodes recombine to make the light-emitting substance excited, and light is emitted when the excited state returns to a ground state. There are two types of the excited states: a singlet excited state (S*) and a triplet excited state (T*). In addition, the statistical generation ratio thereof in a light-emitting element is considered to be S*:T*=1:3.

In general, the ground state of a light-emitting organic compound is a singlet state. Light emission from a singlet excited state (S*) is referred to as fluorescence where electron transition occurs between the same multiplicities. On the other hand, light emission from a triplet excited state (T*) is referred to as phosphorescence where electron transition occurs between different multiplicities. Here, in a compound emitting fluorescence (hereinafter referred to as a fluorescent compound), in general, phosphorescence is not observed at room temperature, and only fluorescence is observed. Accordingly, the internal quantum efficiency (the ratio of generated photons to injected carriers) in a light-emitting element using a fluorescent compound is assumed to have a theoretical limit of 25% based on S*:T*=1:3.

On the other hand, use of a phosphorescent compound can increase the internal quantum efficiency to 100% in theory. In other words, emission efficiency can be 4 times as much as that of the fluorescence compound. Therefore, the light-emitting element using a phosphorescent compound has been actively developed in recent years in order to achieve a highly efficient light-emitting element.

In particular, an organometallic complex in which iridium or the like is a central metal has attracted attention as a phosphorescent compound owing to its high phosphorescence quantum yield. As a typical phosphorescent material emitting green to blue light, there is a metal complex in which iridium (Ir) is a central metal (hereinafter referred to as an “Ir complex”) (for example, see Patent Document 1, Patent document 2, and Patent Document 3). Disclosed in Patent Document 1 is an Ir complex where a triazole derivative is a ligand.

In addition, as an Ir complex in which a triazole derivative is a ligand, a phosphorescent material including a propyl group at the 3-position of the triazole derivative is disclosed (Non-Patent Document 1).

### REFERENCE

### Patent Document

[Patent Document 1] Japanese Published Patent Application No. 2007-137872
[Patent Document 2] Japanese Published Patent Application No. 2008-069221
[Patent Document 3] PCT International Publication No. 2008-035664

### Non-Patent Document

[Non-Patent Document 1] “Chemistry of Materials” (2006), Vol. 18, Issue 21, pp. 5119-5129

### DISCLOSURE OF INVENTION

As reported in Patent Documents 1 to 3 and Non-Patent Document 1, although phosphorescent materials emitting green or blue light have been developed, there is room for improvement in team of emission efficiency, reliability, light-emitting characteristics, synthesis yield, cost, or the like, and further development is required for obtaining more excellent phosphorescent materials.

A material reported in Non-Patent Document 1, which is a phosphorescent material emitting blue light, has a problem in reliability of the element.

In view of the above problems, it is an object of one embodiment of the present invention to provide a novel substance that can emit phosphorescence having a wavelength band of green to blue. It is another object of one embodiment of the present invention to provide a novel substance that emits phosphorescence having a wavelength band of green to blue and has high emission efficiency. It is another object of one embodiment of the present invention to provide a novel substance that emits phosphorescence having a wavelength band of green to blue and has high reliability.

It is another object to provide a light-emitting element that emits light having a wavelength band of green to blue by using such a novel substance. Moreover, it is another object to provide a light-emitting device, an electronic device, and a lighting device each using the light-emitting element.

One embodiment of the present invention is an organometallic complex in which a 1H-1,2,4-triazole derivative is a ligand and an element belonging to Group 9 or an element belonging to Group 10 is a central metal. Specifically, one embodiment of the present invention is an organometallic complex including a structure represented by a general formula (G1).

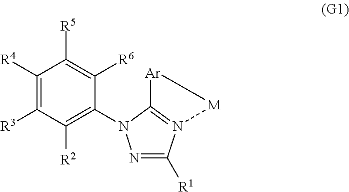

In the general formula (G1), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ represents an alkyl group having 1 to 4 carbon atoms or a substituted or unsubstituted phenyl group. M is a central metal and represents either an element belonging to Group 9 or an element belonging to Group 10.

Another embodiment of the present invention is an organometallic complex represented by a general formula (G2).

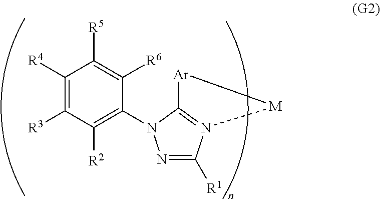

In the general formula (G2), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group: M is a central metal and represents either an element belonging to Group 9 or an element belonging to Group 10. In addition, n is 3 when the central metal M is an element belonging to Group 9, or n is 2 when the central metal M is an element belonging to Group 10.

Specific examples of Ar include a phenylene group, a phenylene group substituted by one or more alkyl groups, a phenylene group substituted by one or more alkoxy groups, a phenylene group substituted by one or more allylthio groups, a phenylene group substituted by one or more haloalkyl groups, a phenylene group substituted by one or more halogen groups, a phenylene group substituted by one or more phenyl groups, a biphenyl-diyl group, a naphthalene-diyl group, a fluorene-diyl group, a 9,9-dialkylfluorene-diyl group, and a 9,9-diarylfluorene-diyl group.

Specific examples of R¹ include a methyl group, an ethyl group, a propyl group, and an isopropyl group. Note that R¹ is preferably an alkyl group having 2 or less straight-chain carbon atoms. In other words, a methyl group, an ethyl group, and an isopropyl group are preferable; a methyl group is especially preferable. The present inventors found out that steric hindrance of a complex can be reduced and reliability of the light-emitting element can be improved with an alkyl group having 2 or less straight-chain carbon atoms.

An organometallic complex in which R¹ is an alkyl group having 1 to 3 carbon atoms is preferable to an organometallic complex in which R¹ is hydrogen because the synthesis yield is drastically improved.

Specific examples of an alkyl group having 1 to 4 carbon atoms in any of R² to R⁶ are a methyl group, an ethyl group, a propyl group, an isopropyl group, a butyl group, a sec-butyl group, an isobutyl group, and a tert-butyl group. Specific examples of a substituted phenyl group in any of R² to R⁶ include a phenyl group substituted by one or more alkyl groups, a phenyl group substituted by one or more alkoxy groups, a phenyl group substituted by one or more alkylthio groups, a phenyl group substituted by one or more haloalkyl groups, and a phenyl group substituted by one or more halogen groups.

In addition, at least one of R², R³, R⁵, and R⁶ preferably includes a substituent in which case generation of an organometallic complex in which the central metal M is ortho-metalated by R² or R⁶ can be suppressed and the synthesis yield is drastically improved.

Iridium and platinum are preferably used as the element belonging to Group 9 and the element belonging to Group 10, respectively. In terms of a heavy atom effect, a heavy metal is preferably used as the central metal of the organometallic complex in order to more efficiently emit phosphorescence.

Another embodiment of the present invention is an organometallic complex including a structure represented by a general formula (G3).

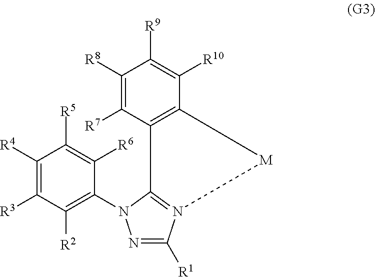

In the general formula (G3), R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. Further, R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10.

Another embodiment of the present invention is an organometallic complex represented by a general formula (G4).

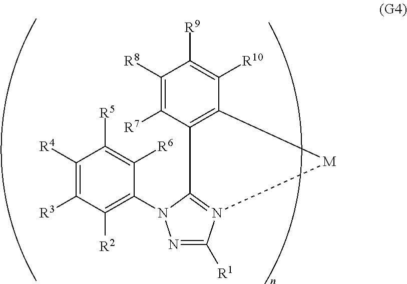

In the general formula (G4), R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. Further, R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10. In addition, n is 3 when the central metal M is an element belonging to Group 9, or n is 2 when the central metal M is an element belonging to Group 10.

Note that specific examples of R¹ and R² to R⁶ can be the same as those in the general formulas (G1) and (G2).

Specific examples of R⁷ to R¹⁰ are a methyl group, an ethyl group, a propyl group, an isopropyl group, a butyl group, a sec-butyl group, an isobutyl group, a tert-butyl group, a methoxy group, an ethoxy group, a propoxy group, an isopropoxy group, a butoxy group, a sec-butoxy group, an isobutoxy group, a tert-butoxy group, a methylsulfinyl group, an ethylsulfinyl group, a propylsulfinyl group, an isopropylsulfinyl group, a butylsulfinyl group, an isobutylsulfinyl group, a sec-butylsulfinyl group, a tert-butylsulfinyl group, a fluoro group, a fluoromethyl group, a difluoromethyl group, a trifluoromethyl group, a chloro group, a chloromethyl group, a dichloromethyl group, a trichloromethyl group, a bromomethyl group, a 2,2,2-trifluoroethyl group, a 3,3,3-trifluoropropyl group, a 1,1,1,3,3,3-hexafluoroisopropyl group, and the like.

In an organometallic complex including the structure represented by the above general formula (G3), the case where R³ to R⁶ are hydrogen is preferable to the case where R³ to R⁶ include substituents because there are advantages in terms of cost of materials, synthesis yield, and easy synthesis. For example, a complex in which only R² includes a substituent has much higher yield than a complex in which R² and R⁶ each include a substituent. Moreover, the present inventors found out that the central metal is not ortho-metalated on the R⁶ side as long as R² includes a substituent. That is, another embodiment of the present invention is an organometallic complex having a structure represented by a general formula (G5).

Another embodiment of the present invention is an organometallic complex including a structure represented by a general formula (G5).

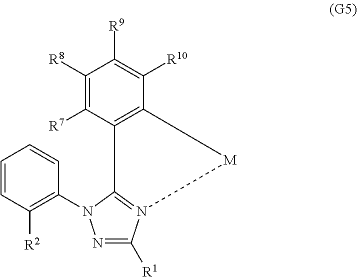

In the general formula (G5), R¹ represents an alkyl group having 1 to 3 carbon atoms, and R² represents either an allyl group having 1 to 4 carbon atoms or a substituted or unsubstituted phenyl group. Further, R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10.

Another embodiment of the present invention is an organometallic complex represented by a general formula (G6).

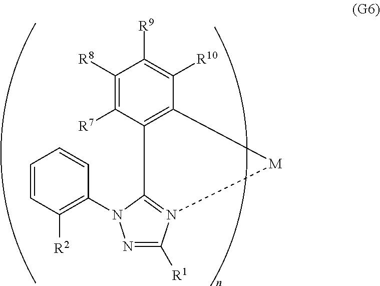

In the general formula (G6), R¹ represents an alkyl group having 1 to 3 carbon atoms, and R² represents either an alkyl group having 1 to 4 carbon atoms or a substituted or unsubstituted phenyl group. Further, R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10. In addition, n is 3 when the central metal M is an element belonging to Group 9, or n is 2 when the central metal M is an element belonging to Group 10.

Another embodiment of the present invention is a light-emitting element containing, between a pair of electrodes, any organometallic complex described above. In particular, any organometallic complex described above is preferably contained in a light-emitting layer.

A light-emitting device, an electronic device, and a lighting device each using the above light-emitting element also belong to the category of the present invention. Note that the light-emitting device in this specification includes an image display device and a light source. In addition, the light-emitting device includes, in its category, all of a module in which a connector such as a flexible printed circuit (FPC), a tape automated bonding (TAB) tape or a tape carrier package (TCP) is connected to a panel, a module in which a printed wiring board is provided on the tip of a TAB tape or a TCP, and a module in which an integrated circuit (IC) is directly mounted on a light-emitting element by a chip on glass (COG) method.

According to one embodiment of the present invention, a novel organometallic complex that has an emission region in the wavelength band of green to blue and high emission efficiency can be provided.

According to another embodiment of the present invention, a novel organometallic complex that has an emission region in the wavelength band of green to blue and high reliability can be provided.

According to another embodiment of the present invention, a light-emitting element using the organometallic complex, and a light-emitting device, an electronic device, and a lighting device each using the light-emitting element can be provided.

### BRIEF DESCRIPTION OF DRAWINGS

FIGS. 1A to 1C each illustrate a light-emitting element of one embodiment of the present invention.

FIGS. 2A to 2D illustrate a passive matrix light-emitting device.

FIG. 3 illustrates a passive matrix light-emitting device.

FIGS. 4A and 4B illustrate an active matrix light-emitting device.

FIGS. 5A to 5E illustrate electronic devices.

FIG. 6 illustrates lighting devices.

FIG. 7 is a ¹H NMR chart of an organometallic complex represented by a structural formula (100).

FIG. 8 shows an ultraviolet-visible absorption spectrum and an emission spectrum of the organometallic complex represented by the structural formula (100) in a dichloromethane solution.

FIG. 9 is a ¹H NMR chart of an organometallic complex represented by a structural formula (102).

FIG. 10 shows an ultraviolet-visible absorption spectrum and an emission spectrum of the organometallic complex represented by the structural formula (102) in a dichloromethane solution.

FIG. 11 is a ¹H NMR chart of an organometallic complex represented by a structural formula (103).

FIG. 12 shows an ultraviolet-visible absorption spectrum and an emission spectrum of the organometallic complex represented by the structural formula (103) in a dichloromethane solution.

FIG. 13 is a ¹H NMR chart of an organometallic complex represented by a structural formula (101).

FIG. 14 shows an ultraviolet-visible absorption spectrum and an emission spectrum of the organometallic complex represented by the structural formula (101) in a dichloromethane solution.

FIG. 15 is a ¹H NMR chart of an organometallic complex represented by a structural formula (112).

FIG. 16 shows an ultraviolet-visible absorption spectrum and an emission spectrum of the organometallic complex represented by the structural formula (112) in a dichloromethane solution.

FIG. 17 is a ¹H NMR chart of an organometallic complex represented by a structural formula (128).

FIG. 18 shows an ultraviolet-visible absorption spectrum and an emission spectrum of the organometallic complex represented by the structural formula (128) in a dichloromethane solution.

FIGS. 19A to 19D each illustrate a light-emitting element of Examples.

FIG. 20 shows current density versus luminance characteristics of a light-emitting element 1 which is one embodiment of the present invention.

FIG. 21 shows voltage versus luminance characteristics of the light-emitting element 1 which is one embodiment of the present invention.

FIG. 22 shows luminance versus current efficiency characteristics of the light-emitting element 1 which is one embodiment of the present invention.

FIG. 23 shows an emission spectrum of the light-emitting element 1 which is one embodiment of the present invention.

FIG. 24 shows current density versus luminance characteristics of a light-emitting element 2 which is one embodiment of the present invention.

FIG. 25 shows voltage versus luminance characteristics of the light-emitting element 2 which is one embodiment of the present invention.

FIG. 26 shows luminance versus current efficiency characteristics of the light-emitting element 2 which is one embodiment of the present invention.

FIG. 27 shows an emission spectrum of the light-emitting element 2 which is one embodiment of the present invention.

FIG. 28 shows current density versus luminance characteristics of a light-emitting element 3 which is one embodiment of the present invention.

FIG. 29 shows voltage versus luminance characteristics of the light-emitting element 3 which is one embodiment of the present invention.

FIG. 30 shows luminance versus current efficiency characteristics of the light-emitting element 3 which is one embodiment of the present invention.

FIG. 31 shows an emission spectrum of the light-emitting element 3 which is one embodiment of the present invention.

FIG. 32 shows time versus normalized luminance characteristics of the light-emitting elements 1 to 3 which are embodiments of the present invention.

FIG. 33 shows time versus voltage characteristics of the light-emitting elements 1 to 3 which are embodiments of the present invention.

FIG. 34 shows current density versus luminance characteristics of a light-emitting element 4 which is one embodiment of the present invention.

FIG. 35 shows voltage versus luminance characteristics of the light-emitting element 4 which is one embodiment of the present invention.

FIG. 36 shows luminance versus current efficiency characteristics of the light-emitting element 4 which is one embodiment of the present invention.

FIG. 37 shows an emission spectrum of the light-emitting element 4 which is one embodiment of the present invention.

FIG. 38 shows current density versus luminance characteristics of a light-emitting element 5 for comparison with the present invention.

FIG. 39 shows voltage versus luminance characteristics of the light-emitting element 5 for comparison with the present invention.

FIG. 40 shows luminance versus current efficiency characteristics of the light-emitting element 5 for comparison with the present invention.

FIG. 41 shows an emission spectrum of the light-emitting element 5 for comparison with the present invention.

FIG. 42 shows time versus normalized luminance characteristics of the light-emitting element 4 which is one embodiment of the present invention and the light-emitting element 5 for comparison.

FIG. 43 shows time versus voltage characteristics of the light-emitting element 4 which is one embodiment of the present invention and the light-emitting element 5 for comparison.

FIG. 44 shows current density versus luminance characteristics of a light-emitting element 6 which is one embodiment of the present invention.

FIG. 45 shows voltage versus luminance characteristics of the light-emitting element 6 which is one embodiment of the present invention.

FIG. 46 shows luminance versus current efficiency characteristics of the light-emitting element 6 which is one embodiment of the present invention.

FIG. 47 shows an emission spectrum of the light-emitting element 6 which is one embodiment of the present invention.

FIG. 48 shows current density versus luminance characteristics of a light-emitting element 7 which is one embodiment of the present invention.

FIG. 49 shows voltage versus luminance characteristics of the light-emitting element 7 which is one embodiment of the present invention.

FIG. 50 shows luminance versus current efficiency characteristics of the light-emitting element 7 which is one embodiment of the present invention.

FIG. 51 shows an emission spectrum of the light-emitting element 7 which is one embodiment of the present invention.

FIG. 52 shows current density versus luminance characteristics of a light-emitting element 8 which is one embodiment of the present invention.

FIG. 53 shows voltage versus luminance characteristics of the light-emitting element 8 which is one embodiment of the present invention.

FIG. 54 shows luminance versus current efficiency characteristics of the light-emitting element 8 which is one embodiment of the present invention.

FIG. 55 shows an emission spectrum of the light-emitting element 8 which is one embodiment of the present invention.

FIG. 56 shows time versus normalized luminance characteristics of the light-emitting elements 6 to 8 which are embodiments of the present invention.

FIG. 57 shows time versus voltage characteristics of the light-emitting elements 6 to 8 which are embodiments of the present invention.

FIG. 58 shows current density versus luminance characteristics of a light-emitting element 9 which is one embodiment of the present invention.

FIG. 59 shows voltage versus luminance characteristics of the light-emitting element 9 which is one embodiment of the present invention.

FIG. 60 shows luminance versus current efficiency characteristics of the light-emitting element 9 which is one embodiment of the present invention.

FIG. 61 shows an emission spectrum of the light-emitting element 9 which is one embodiment of the present invention.

FIG. 62 shows time versus normalized luminance characteristics of the light-emitting element 9 which is one embodiment of the present invention.

FIG. 63 shows time versus voltage characteristics of the light-emitting element 9 which is one embodiment of the present invention.

FIG. 64 shows current density versus luminance characteristics of a light-emitting element 10 which is one embodiment of the present invention.

FIG. 65 shows voltage versus luminance characteristics of the light-emitting element 10 which is one embodiment of the present invention.

FIG. 66 shows luminance versus current efficiency characteristics of the light-emitting element 10 which is one embodiment of the present invention.

FIG. 67 shows an emission spectrum of the light-emitting element 10 which is one embodiment of the present invention.

FIG. 68 shows current density versus luminance characteristics of a light-emitting element 11 which is one embodiment of the present invention.

FIG. 69 shows voltage versus luminance characteristics of the light-emitting element 11 which is one embodiment of the present invention.

FIG. 70 shows luminance versus current efficiency characteristics of the light-emitting element 11 which is one embodiment of the present invention.

FIG. 71 shows an emission spectrum of the light-emitting element 11 which is one embodiment of the present invention.

FIG. 72 shows time versus normalized luminance characteristics of the light-emitting element 11 which is one embodiment of the present invention.

FIG. 73 shows time versus voltage characteristics of the light-emitting element 11 which is one embodiment of the present invention.

### BEST MODE FOR CARRYING OUT THE INVENTION

Embodiments will be described in detail with reference to the accompanying drawings. Note that the invention is not limited to the following description, and it will be easily understood by those skilled in the art that various changes and modifications can be made without departing from the spirit and scope of the invention. Therefore, the invention should not be construed as being limited to the description in the following embodiments. Note that in the structures of the invention described below, the same portions or portions having similar functions are denoted by the same reference numerals in different drawings, and description of such portions is not repeated.

### Embodiment 1

In Embodiment 1, an organometallic complex of one embodiment of the present invention is described.

One embodiment of the present invention is an organometallic complex in which a 1H-1,2,4-triazole derivative is a ligand and an element belonging to Group 9 or an element belonging to Group 10 is a central metal. Specifically, one embodiment of the present invention is an organometallic complex including a structure represented by a general formula (G1).

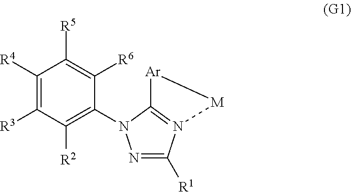

In the general formula (G1), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. M is a central metal and represents either an element belonging to Group 9 or an element belonging to Group 10.

Another embodiment of the present invention is an organometallic complex represented by a general formula (G2).

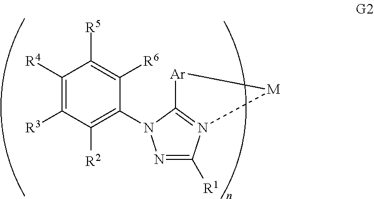

In the general formula (G2), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. M is a central metal and represents either an element belonging to Group 9 or an element belonging to Group 10. In addition, n is 3 when the central metal M is an element belonging to Group 9, or n is 2 when the central metal M is an element belonging to Group 10.

Another embodiment of the present invention is an organometallic complex including a structure represented by a general formula (G3).

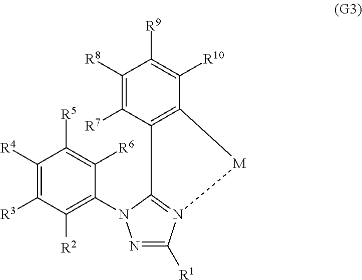

In the general formula (G3), R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. Further, R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10.

Another embodiment of the present invention is an organometallic complex represented by a general formula (G4).

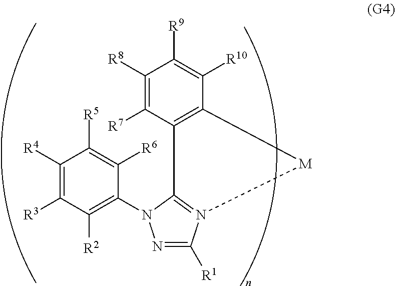

In the general formula (G4), R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. Further, R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10. In addition, n is 3 when the central metal M is an element belonging to Group 9, or n is 2 when the central metal M is an element belonging to Group 10.

Another embodiment of the present invention is an organometallic complex including a structure represented by a general formula (G5).

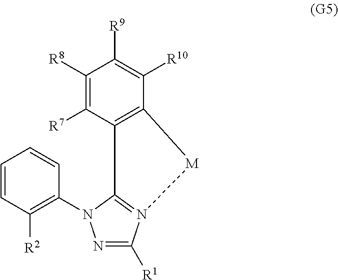

In the general formula (G5), R¹ represents an alkyl group having 1 to 3 carbon atoms, and R² represents either an alkyl group having 1 to 4 carbon atoms or a substituted or unsubstituted phenyl group. Further, R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10.

Another embodiment of the present invention is an organometallic complex represented by a general formula (G6).

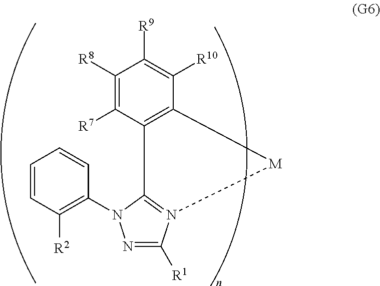

In the general formula (G6), R¹ represents an alkyl group having 1 to 3 carbon atoms, and R² represents either an alkyl group having 1 to 4 carbon atoms or a substituted or unsubstituted phenyl group. Further, R⁷ to R¹⁰) individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group. M is a central metal and represents either an element belonging to Group 9 or an element belonging to Group 10. In addition, n is 3 when the central metal M is an element belonging to Group 9, or n is 2 when the central metal M is an element belonging to Group 10.

### [Method of Synthesizing Organometallic Complex Including Structure Represented by General Formula (G1)]

An example of a method of synthesizing an organometallic complex including the structure represented by the general formula (G1) below is described.

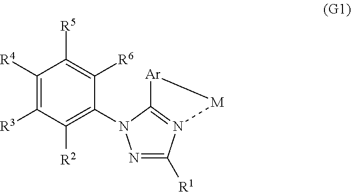

In the general formula (G1), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. M is a central metal and represents either an element belonging to Group 9 or an element belonging to Group 10.

### Step 1: Method of Synthesizing 1H-1,2,4-Triazole Derivative

First, an example of a method of synthesizing a 1H-1,2,4-triazole derivative represented by a general formula (G0) below is described.

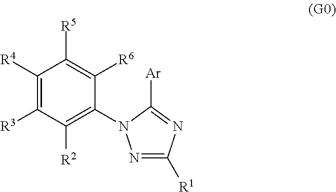

In the general formula (G0), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group.

As shown in a scheme (a) below, an acylamidine compound (A1) and a hydrazine compound (A2) react with each other, so that a 1H-1,2,4-triazole derivative can be obtained. Note that Z in the formula represents a group (a leaving group) that is detached through a ring closure reaction, such as an alkoxy group, an alkylthio group, an amino group, or a cyano group.

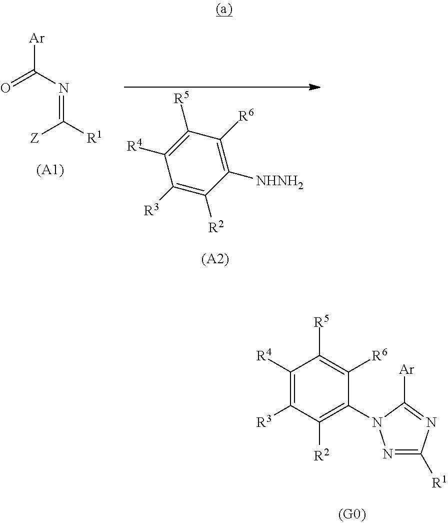

In the scheme (a), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group.

Note that the method of synthesizing a 1H-1,2,4-triazole derivative is not limited to the scheme (a). For example, there is also a method in which a 1,3,4-oxadiazole derivative and arylamine are heated.

As described above, a 1H-1,2,4-triazole derivative represented by the general formula (G0) can be synthesized by a simple synthesis scheme.

Note that various kinds of the above-described compounds (A1) and (A2) are commercially available or can be synthesized. For example, the acylamidine compound (A1) can be synthesized by making aroyl chloride and alkyl imino ether react with each other; in this case, the leaving group Z is an alkoxyl group. In this manner, various types of the 1H-1,2,4-triazole derivative represented by the general formula (G0) can be synthesized. Thus, abundant variations in ligands feature an organometallic complex of one embodiment of the present invention represented by the general formula (G1). By using such an organometallic complex having wide variations of a ligand in manufacture of a light-emitting element, fine adjustment of element characteristics required for the light-emitting element can be performed easily.

### Step 2: Method of Synthesizing Orthometalated Complex Including 1H-1,2,4-Triazole Derivative as Ligand

As shown in a synthesis scheme (b) below, by mixing the 1H-1,2,4-triazole derivative (G0), which can be obtained in Step 1, and a Group 9 or Group 10 metal compound containing a halogen (e.g., rhodium chloride hydrate, palladium chloride, iridium chloride hydrate, ammonium hexachloroiridate, or potassium tetrachloroplatinate) or a Group 9 or Group 10 organometallic complex compound (e.g., an acetylacetonate complex or a diethylsulfide complex), and then by heating the mixture, an organometallic complex having the structure represented by the general formula (G1) can be obtained.

There is no particular limitation on a heating means, and an oil bath, a sand bath, or an aluminum block may be used as a heating means. Alternatively, microwaves can be used as a heating means. This heating process can be performed after the 1H-1,2,4-triazole derivative (G0), which can be obtained in Step 1, and a Group 9 or Group 10 metal compound containing a halogen or a Group 9 or Group 10 organometallic complex compound are dissolved in an alcohol-based solvent (e.g., glycerol, ethylene glycol, 2-metoxyethanol, or 2-ethoxyethanol).

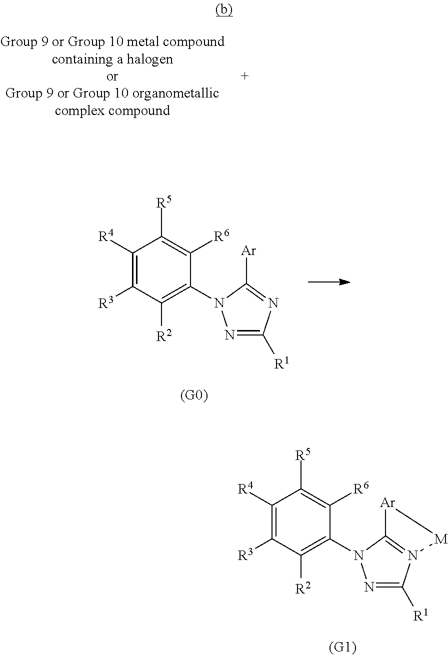

In the scheme (b), Ar represents an arylene group having 6 to 13 carbon atoms. In addition, R¹ represents an alkyl group having 1 to 3 carbon atoms, R² to R⁶ individually represent any of hydrogen, an alkyl group having 1 to 4 carbon atoms, and a substituted or unsubstituted phenyl group, and at least one of R², R³, R⁵, and R⁶ includes an alkyl group having 1 to 4 carbon atoms or a substituted or unsubstituted phenyl group. M is a central metal and represents either an element belonging to Group 9 or an element belonging to Group 10.

Although examples of the synthesis methods are described above, organometallic complexes which are disclosed embodiments of the present invention may be synthesized by any other synthesis method.

Specific structural formulas of an organometallic complex which is one embodiment of the present invention are illustrated in structural formulas (100) to (131) below. Note that the present invention is not limited to these complexes.

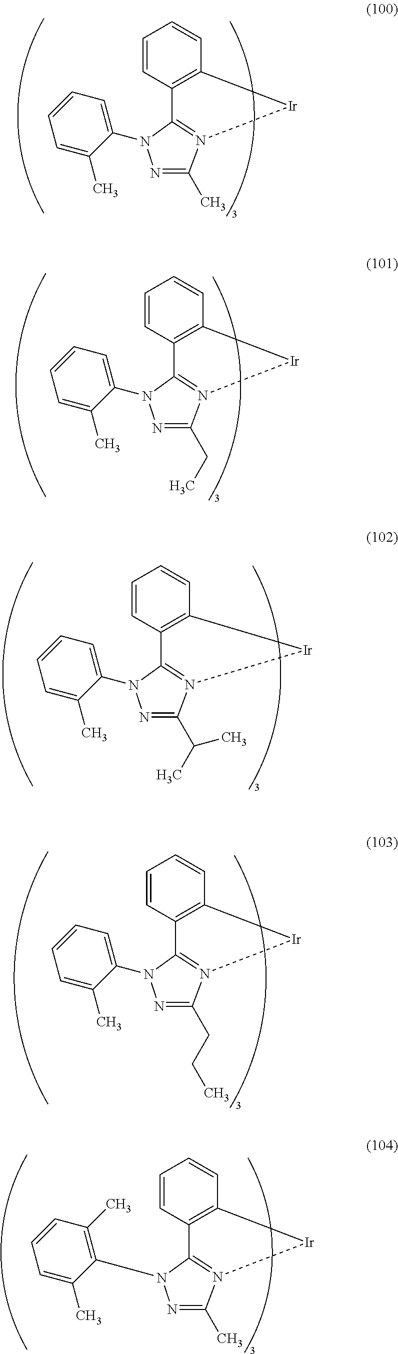

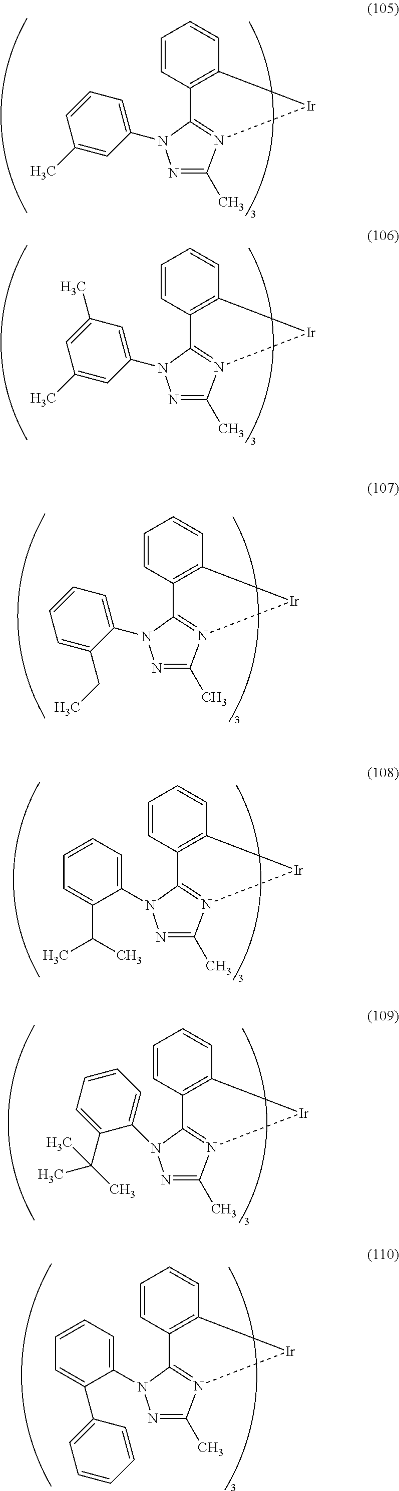

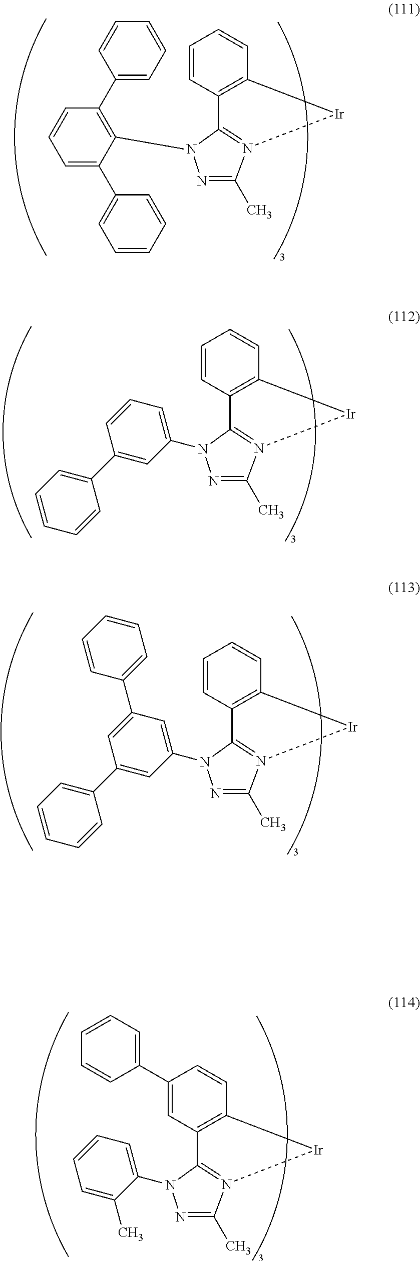

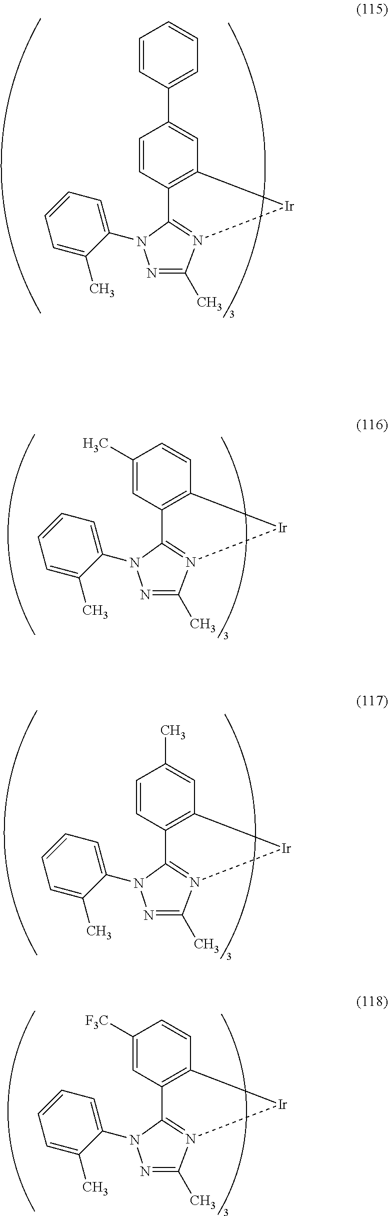

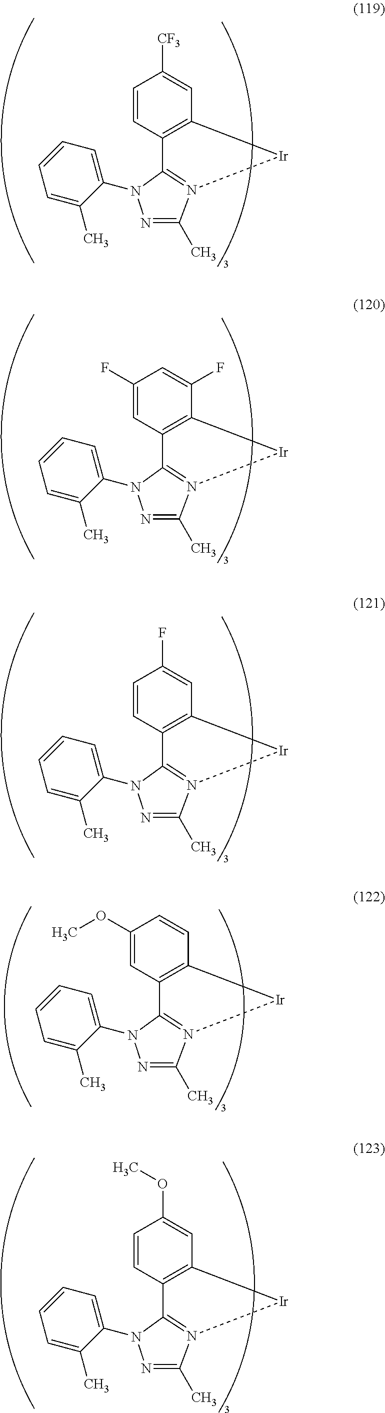

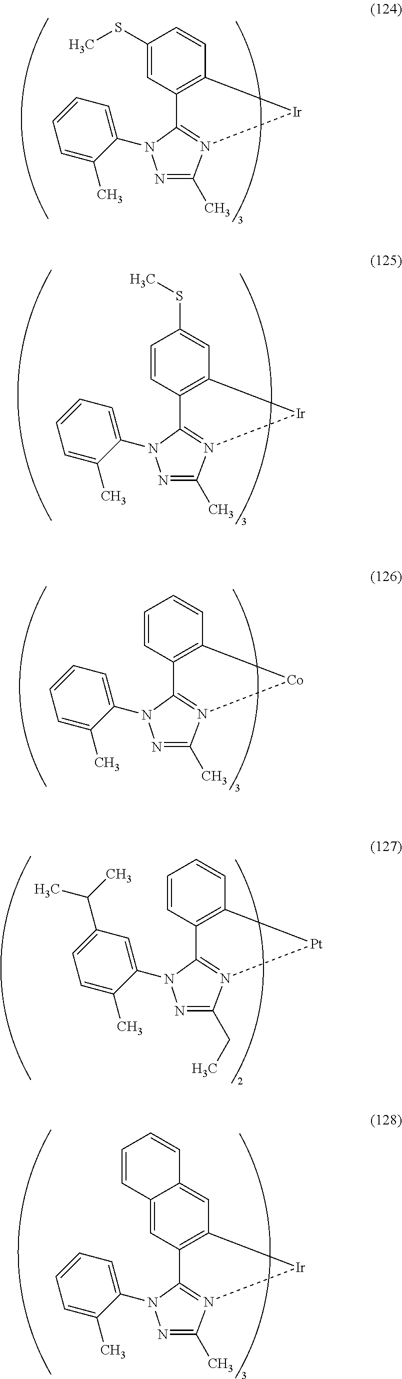

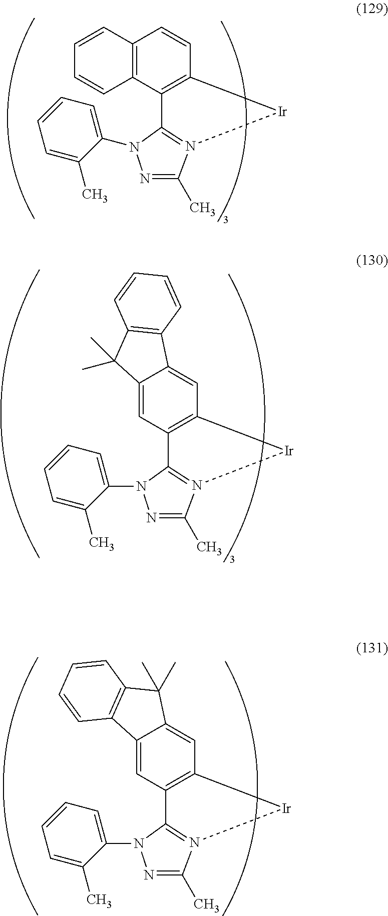

Depending on the type of the ligand, there can be stereoisomers of the organometallic complexes represented by the above structural formulas (100) to (131), and such isomers are included in the category of an organometallic complex of one embodiment of the present invention.

Any of the above-described organometallic complexes, which are embodiments of the present invention, has high reliability and an emission region of green to blue, and thus can be used as a light-emitting material or a light-emitting substance of a light-emitting element.

### Embodiment 2

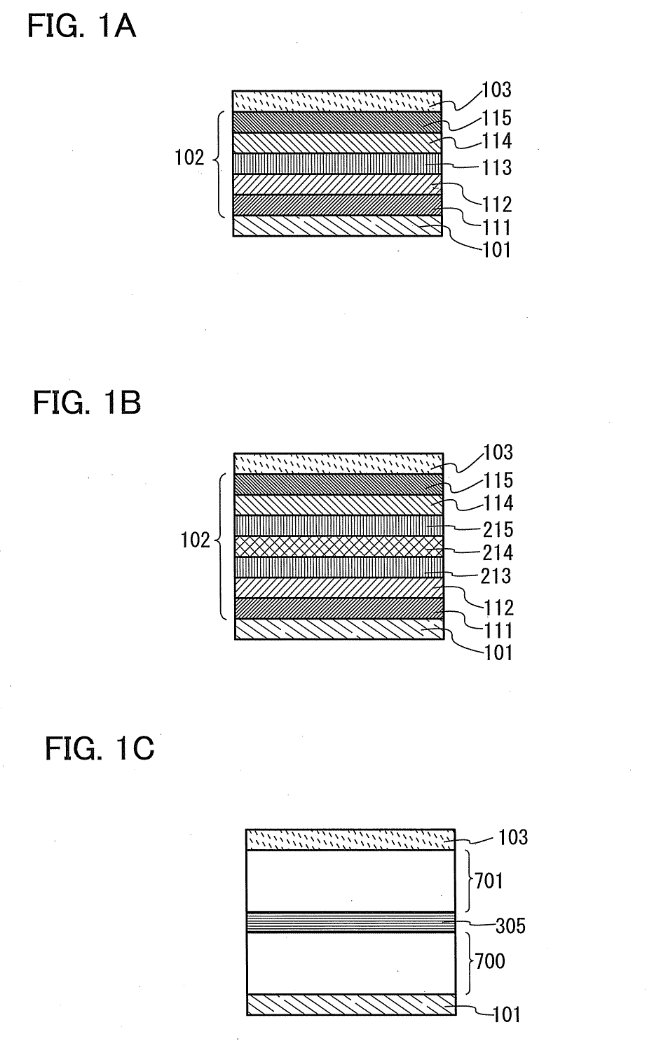

In Embodiment 2, as one embodiment of the present invention, a light-emitting element in which an organometallic complex described in Embodiment 1 is used for a light-emitting layer is described with reference to FIG. 1A.

FIG. 1A illustrates a light-emitting element having an EL layer 102 between a first electrode 101 and a second electrode 103. The EL layer 102 includes a light-emitting layer 113. The light-emitting layer 113 contains an organometallic complex of one embodiment of the present invention which is described in Embodiment 1.

By application of a voltage to such a light-emitting element, holes injected from the first electrode 101 side and electrons injected from the second electrode 103 side recombine in the light-emitting layer 113 to raise the organometallic complex to an excited state. Light is emitted when the organometallic complex in the excited state returns to the ground state. Thus, the organometallic complex of one embodiment of the present invention functions as a light-emitting substance in the light-emitting element. Note that, in the light-emitting element described in this embodiment, the first electrode 101 functions as an anode and the second electrode 103 functions as a cathode.

For the first electrode 101 functioning as an anode, any of metals, alloys, electrically conductive compounds, mixtures thereof, and the like which has a high work function (specifically, a work function of 4.0 eV or more) is preferably used. Specifically, indium oxide-tin oxide (ITO: indium tin oxide), indium oxide-tin oxide containing silicon or silicon oxide, indium oxide-zinc oxide, indium oxide containing tungsten oxide and zinc oxide, or the like is given, for example. Other than these, gold, platinum, nickel, tungsten, chromium, molybdenum, iron, cobalt, copper, palladium, titanium, or the like can be used.

Note that, in the case where in the EL layer 102, a layer formed in contact with the first electrode 101 is formed using a composite material in which an organic compound and an electron acceptor (acceptor) which are described later are mixed, the first electrode 101 can be formed using any of various types of metals, alloys, and electrically conductive compounds, mixtures thereof, and the like regardless of the work function. For example, aluminum, silver, an alloy containing aluminum (e.g., Al—Si), or the like can be used.

The first electrode 101 can be formed by, for example, a sputtering method, an evaporation method (including a vacuum evaporation method), or the like.

The EL layer 102 formed over the first electrode 101 includes at least the light-emitting layer 113 and is formed by containing an organometallic complex which is one embodiment of the present invention. For part of the EL layer 102, a known substance can be used, and either a low molecular compound or a high molecular compound can be used. Note that substances forming the EL layer 102 may consist of organic compounds or may include an inorganic compound as a part.

Further, as illustrated in FIG. 1A, the EL layer 102 is fowled by stacking as appropriate a hole-injection layer 111 containing a substance having a high hole-injection property, a hole-transport layer 112 containing a substance having a high hole-transport property, an electron-transport layer 114 containing a substance having a high electron-transport property, an electron-injection layer 115 containing a substance having a high electron-injection property, and the like in addition to the light-emitting layer 113.

The hole-injection layer 111 is a layer containing a substance having a high hole-injection property. As the substance having a high hole-injection property, metal oxide such as molybdenum oxide, titanium oxide, vanadium oxide, rhenium oxide, ruthenium oxide, chromium oxide, zirconium oxide, hafnium oxide, tantalum oxide, silver oxide, tungsten oxide, or manganese oxide can be used. A phthalocyanine-based compound such as phthalocyanine (abbreviation: H₂Pc), or copper(II) phthalocyanine (abbreviation: CuPc) can also be used.

Alternatively, any of the following aromatic amine compounds which are low molecular organic compounds can be used: 4,4′,4″-tris(N,N-diphenylamino)triphenylamine (abbreviation: TDATA), 4,4′,4″-tris[N-(3-methylphenyl)-N-phenylamino]triphenylamine (abbreviation: MTDATA), 4,4′-bis[N-(4-diphenylaminophenyl)-N-phenylamino]biphenyl (abbreviation: DPAB), 4,4′-bis(N-{4-[N′-(3-methylphenyl)-N′-phenylamino]phenyl}-N-phenylamino)biphenyl (abbreviation: DNTPD), 1,3,5-tris[N-(4-diphenylaminophenyl)-N-phenylamino]benzene (abbreviation: DPA3B), 3-[N-(9-phenylcarbazol-3-yl)-N-phenylamino]-9-phenylcarbazole (abbreviation: PCzPCA1), 3,6-bis[N-(9-phenylcarbazol-3-yl)-N-phenylamino]-9-phenylcarbazole (abbreviation: PCzPCA2), 3-[N-(1-naphthyl)-N-(9-phenylcarbazol-3-yl)amino]-9-phenylcarbazole (abbreviation: PCzPCN1), and the like.

Further alternatively, any of high molecular compounds (e.g., oligomers, dendrimers, or polymers) can be used. Examples of high molecular compounds include poly(N-vinylcarbazole) (abbreviation: PVK), poly(4-vinyltriphenylamine) (abbreviation: PVTPA), poly[N-(4-{N′-[4-(4-diphenylamino)phenyl]phenyl-N′-phenylamino}phenyl)methacrylamide] (abbreviation: PTPDMA), and poly[N,N′-bis(4-butylphenyl)-N,N′-bis(phenyl)benzidine (abbreviation: Poly-TPD). Further alternatively, a high molecular compound doped with acid, such as poly(3,4-ethylenedioxythiophene)/poly(styrenesulfonic acid) (PEDOT/PSS) or polyaniline/poly(styrenesulfonic acid) (PAni/PSS) can be used.

A composite material in which an organic compound and an electron acceptor (acceptor) are mixed may be used for the hole-injection layer 111. Such a composite material is superior in a hole-injection property and a hole-transport property, since holes are generated in the organic compound by the electron acceptor. In this case, the organic compound is preferably a material excellent in transporting the generated holes (a substance having a high hole-transport property).

As the organic compound used for the composite material, various compounds such as an aromatic amine compound, a carbazole derivative, aromatic hydrocarbon, and a high molecular compound (such as oligomer, dendrimer, or polymer) can be used. The organic compound used for the composite material is preferably an organic compound having a high hole-transport property. Specifically, a substance having a hole mobility of 10⁻⁶ cm²/V·s or higher is preferably used. However, substances other than the above-described materials may also be used as long as the substances have higher hole-transport properties than electron-transport properties. The organic compounds which can be used for the composite material are specifically shown below.

Examples of the organic compound that can be used for the composite material are aromatic amine compounds such as TDATA, MTDATA, DPAB, DNTPD, DPA3B, PCzPCA1, PCzPCA2, PCzPCN1, 4,4′-bis[N-(1-naphthyl)-N-phenylamino]biphenyl (abbreviation: NPB or α-NPD), N,N′-bis(3-methylphenyl)-N,N′-diphenyl-[1,1′-biphenyl]-4,4′-diamine (abbreviation: TPD), and 4-phenyl-4′-(9-phenylfluoren-9-yl)triphenylamine (abbreviation: BPAFLP), and carbazole derivatives such as 4,4′-di(N-carbazolyl)biphenyl (abbreviation: CBP), 1,3,5-tris[4-(N-carbazolyl)phenyl]benzene (abbreviation: TCPB), 9-[4-(N-carbazolyl)phenyl]-10-phenylanthracene (abbreviation: CzPA), 9-phenyl-3-[4-(10-phenyl-9-anthryl)phenyl]-9H-carbazole (abbreviation: PCzPA), and 1,4-bis[4-(N-carbazolyl)phenyl-2,3,5,6-tetraphenylbenzene.

Alternatively, an aromatic hydrocarbon compound such as 2-tert-butyl-9,10-di(2-naphthyl)anthracene (abbreviation: t-BuDNA), 2-tert-butyl-9,10-di(1-naphthyl)anthracene, 9,10-bis(3,5-diphenylphenyl)anthracene (abbreviation: DPPA), 2-tert-butyl-9,10-bis(4-phenylphenyl)anthracene (abbreviation: t-BuDBA), 9,10-di(2-naphthyl)anthracene (abbreviation: DNA), 9,10-diphenylanthracene (abbreviation: DPAnth), 2-tert-butylanthracene (abbreviation: t-BuAnth), 9,10-bis(4-methyl-1-naphthyl)anthracene (abbreviation: DMNA), 9,10-bis[2-(1-naphthyl)phenyl)-2-tert-butylanthracene, 9,10-bis[2-(1-naphthyl)phenyl]anthracene, or 2,3,6,7-tetramethyl-9,10-di(1-naphthyl)anthracene can be used.

Further alternatively, an aromatic hydrocarbon compound such as 2,3,6,7-tetramethyl-9,10-di(2-naphthyl)anthracene, 9,9′-bianthryl, 10,10′-diphenyl-9,9′-bianthryl, 10,10′-bis(2-phenylphenyl)-9,9′-bianthryl, 10,10′-bis[(2,3,4,5,6-pentaphenyl)phenyl]-9,9′-bianthryl, anthracene, tetracene, rubrene, perylene, 2,5,8,11-tetra(tert-butyl)perylene, pentacene, coronene, 4,4′-bis(2,2-diphenylvinyl)biphenyl (abbreviation: DPVBi), or 9,10-bis[4-(2,2-diphenylvinyl)phenyl]anthracene (abbreviation: DPVPA) can be used.

As the electron acceptor, organic compounds such as 7,7,8,8-tetracyano-2,3,5,6-tetrafluoroquinodimethane (abbreviation: F₄-TCNQ) and chloranil; and transition metal oxides can be given. In addition, oxides of metals belonging to Groups 4 to 8 in the periodic table can also be given. Specifically, vanadium oxide, niobium oxide, tantalum oxide, chromium oxide, molybdenum oxide, tungsten oxide, manganese oxide, and rhenium oxide are preferable since their electron-accepting property is high. Among these, molybdenum oxide is especially preferable since it is stable in the air and its hygroscopic property is low and is easily treated.

Note that the hole-injection layer 111 may be formed using a composite material of the above-described high molecular compound, such as PVK, PVTPA, PTPDMA, or Poly-TPD, and the above-described electron acceptor.

The hole-transport layer 112 is a layer containing a substance having a high hole-transport property. Examples of the substance having a high hole-transport property are aromatic amine compounds such as NPB, TPD, BPAFLP, 4,4′-bis[N-(9,9-dimethylfluoren-2-yl)-N-phenylamino]biphenyl (abbreviation: DFLDPBi), and 4,4′-bis[N-(spiro-9,9′-bifluoren-2-yl)-N-phenylamino]biphenyl (abbreviation: BSPB). The substances mentioned here are mainly ones that have a hole mobility of 10⁻⁶ cm²/V·s or higher. However, substances other than the above described materials may also be used as long as the substances have higher hole-transport properties than electron-transport properties. The layer containing a substance having a high hole-transport property is not limited to a single layer, and two or more layers containing the aforementioned substances may be stacked.

For the hole-transport layer 112, a carbazole derivative such as CBP, CzPA, or PCzPA or an anthracene derivative such as t-BuDNA, DNA, or DPAnth may also be used.

Alternatively, for the hole-transport layer 112, a high molecular compound such as PVK, PVTPA, PTPDMA, or Poly-TPD can be used.

The light-emitting layer 113 is a layer containing an organometallic complex which is one embodiment of the present invention. The light-emitting layer 113 may be formed with a thin film containing an organometallic complex of one embodiment of the present invention. The light-emitting layer 113 may alternatively be a thin film in which the organometallic complex which is one embodiment of the present invention is dispersed as a guest in a substance as a host which has higher triplet excitation energy than the organometallic complex of one embodiment of the present invention. For example, 1,3-bis(N-carbazolyl)benzene (abbreviation: mCP) or the like can be used as a host. Thus, quenching of light emitted from the organometallic complex caused depending on the concentration can be prevented. Note that the triplet excitation energy indicates an energy gap between a ground state and a triplet excited state.

The electron-transport layer 114 is a layer containing a substance having a high electron-transport property. For the electron-transport layer 114, metal complexes such as Alq₃, tris(4-methyl-8-quinolinolato)aluminum (abbreviation: Almq₃), bis(10-hydroxybenzo[h]quinolinato)beryllium (abbreviation: BeBq₂), BAlq, Zn(BOX)₂, or bis[2-(2′-hydroxyphenyl)benzothiazolato]zinc (abbreviation: Zn(BTZ)₂) can be given. Further, a heteroaromatic compound such as 2-(4-biphenylyl)-5-(4-tert-butylphenyl)-1,3,4-oxadiazole (abbreviation: PBD), 1,3-bis[5-(p-tert-butylphenyl)-1,3,4-oxadiazol-2-yl]benzene (abbreviation: OXD-7), 3-(4-tert-butylphenyl)-4-phenyl-5-(4-biphenylyl)-1,2,4-triazole (abbreviation: TAZ), 3-(4-tert-butylphenyl)-4-(4-ethylphenyl)-5-(4-biphenylyl)-1,2,4-triazole (abbreviation: p-EtTAZ), bathophenanthroline (abbreviation: BPhen), bathocuproine (abbreviation: BCP), or 4,4′-bis(5-methylbenzoxazol-2-yl)stilbene (abbreviation: BzOs) can also be used. Further alternatively, a high molecular compound such as poly(2,5-pyridinediyl) (abbreviation: PPy), poly[(9,9-dihexylfluorene-2,7-diyl)-co-(pyridine-3,5-diyl)] (abbreviation: PF-Py) or poly[(9,9-dioctylfluorene-2,7-diyl)-co-(2,2′-bipyridine-6,6′-diyl)] (abbreviation: PF-BPy) can be used. The substances mentioned here are mainly ones that have an electron mobility of 10⁻⁶ cm²/V·s or higher. Note that any substance other than the above substances may be used for the electron-transport layer as long as it is a substance in which the electron-transport property is higher than the hole-transport property.

Furthermore, the electron-transport layer is not limited to a single layer, and two or more layers made of the aforementioned substances may be stacked.

The electron-injection layer 115 is a layer containing a substance having a high electron-injection property. For the electron-injection layer 115, an alkali metal, an alkaline earth metal, or a compound thereof, such as lithium, cesium, calcium, lithium fluoride, cesium fluoride, calcium fluoride, or lithium oxide, can be used. In addition, a rare earth metal compound such as erbium fluoride can also be used. Alternatively, the above-mentioned substances for forming the electron-transport layer 114 can also be used.

Alternatively, a composite material in which an organic compound and an electron donor (donor) are mixed may be used for the electron-injection layer 115. Such a composite material is superior in an electron-injection property and an electron-transport property, since electrons are generated in the organic compound by the electron donor. In this case, the organic compound is preferably a material excellent in transporting the generated electrons. Specifically, the above-described substances for forming the electron-transport layer 114 (e.g., a metal complex or a heteroaromatic compound) can be used, for example. As the electron donor, a substance exhibiting an electron-donating property to the organic compound may be used. Specifically, an alkali metal, an alkaline-earth metal, or a rare earth metal, such as lithium, cesium, magnesium, calcium, erbium, or ytterbium, is preferable. Further, an alkali metal oxide or an alkaline-earth metal oxide is preferable, and there are, for example, lithium oxide, calcium oxide, barium oxide, and the like. Alternatively, Lewis base such as magnesium oxide can also be used. Further alternatively, an organic compound such as tetrathiafulvalene (abbreviation: TTF) can be used.

Note that each of the above-described hole-injection layer 111, hole-transport layer 112, light-emitting layer 113, electron-transport layer 114, and electron-injection layer 115 can be formed by a method such as an evaporation method (e.g., a vacuum evaporation method), an inkjet method, or a coating method.

For the second electrode 103 functioning as a cathode, any of metals, alloys, electrically conductive compounds, mixtures thereof, and the like which has a low work function (specifically, a work function of 3.8 eV or less) is preferably used. Specifically, any of elements that belong to Groups 1 and 2 in the periodic table, that is, alkali metals such as lithium and cesium, alkaline earth-metals such as magnesium, calcium, and strontium, alloys thereof (e.g., Mg—Ag and Al—Li), rare earth-metals such as europium and ytterbium, alloys thereof, aluminum, silver, and the like can be used.

Note that, in the case where in the EL layer 102, a layer formed in contact with the second electrode 103 is formed using a composite material in which the organic compound and the electron donor (donor), which are described above, are mixed, a variety of conductive materials such as Al, Ag, ITO, and indium oxide-tin oxide containing silicon or silicon oxide can be used regardless of the work function.

Note that the second electrode 103 can be formed by a vacuum evaporation method or a sputtering method. Alternatively, in the case of using a silver paste or the like, a coating method, an inkjet method, or the like can be used

In the above-described light-emitting element, current flows due to a potential difference generated between the first electrode 101 and the second electrode 103 and holes and electrons recombine in the EL layer 102, whereby light is emitted. Then, the emitted light is extracted outside through one or both of the first electrode 101 and the second electrode 103. Therefore, one or both of the first electrode 101 and the second electrode 103 is/are an electrode having a property of transmitting visible light.

Note that by use of the light-emitting element described in this embodiment, a passive matrix light-emitting device or an active matrix light-emitting device in which driving of the light-emitting element is controlled by a thin film transistor (TFT) can be manufactured.

Note that there is no particular limitation on the structure of the TFT in the case of fabricating an active matrix light-emitting device. For example, a staggered TFT or an inverted staggered TFT can be used as appropriate. Further, a driver circuit formed over a TFT substrate may be formed using both of an n-channel TFT and a p-channel TFT or only either an n-channel TFT or a p-channel TFT. Furthermore, there is no particular limitation on the crystallinity of a semiconductor film used for the TFT. For example, an amorphous semiconductor film, a crystalline semiconductor film, an oxide semiconductor film, or the like can be used.

Note that, in Embodiment 2, an organometallic complex of one embodiment of the present invention, which is used for the light-emitting layer 113, has high reliability and emits light in a wavelength region of green to blue. Thus, a light-emitting element having high reliability can be realized.

Note that in this embodiment, any of the structures described in Embodiment 1 can be used in appropriate combination.

### Embodiment 3

A light-emitting element which is one embodiment of the present invention may have a plurality of light-emitting layers. By providing a plurality of light-emitting layers, light which is a combination of the light emitted from the plurality of layers can be obtained. Thus, white light emission can be obtained, for example. In Embodiment 3, a mode of a light-emitting element having a plurality of light-emitting layers is described with reference to FIG. 1B.

FIG. 1B illustrates a light-emitting element having an EL layer 102 between a first electrode 101 and a second electrode 103. The EL layer 102 includes a first light-emitting layer 213 and a second light-emitting layer 215, so that light emission that is a mixture of light emission from the first light-emitting layer 213 and light emission from the second light-emitting layer 215 can be obtained in the light-emitting element illustrated in FIG. 1B. A separation layer 214 is preferably formed between the first light-emitting layer 213 and the second light-emitting layer 215.

Embodiment 3 gives descriptions of a light-emitting element that emits white light, in which the first light-emitting layer 213 contains an organometallic complex of one embodiment of the present invention and the second light-emitting layer 215 contains an organic compound that emits yellow to red light, but the present invention is not limited thereto.

While an organometallic complex which is one embodiment of the present invention is used for the second light-emitting layer 215, another light-emitting substance may be applied to the first light-emitting layer 213.

The EL layer 102 may have three or more light-emitting layers.

When a voltage is applied such that the potential of the first electrode 101 is higher than the potential of the second electrode 103, a current flows between the first electrode 101 and the second electrode 103, and holes and electrons recombine in the first light-emitting layer 213, the second light-emitting layer 215, or a separation layer 214. Generated excitation energy is distributed to both the first light-emitting layer 213 and the second light-emitting layer 215 to excite a first light-emitting substance contained in the first light-emitting layer 213 and a second light-emitting substance contained in the second light-emitting layer 215. The excited first and second light-emitting substances emit light while returning to the ground state.

The first light-emitting layer 213 contains an organometallic complex which is one embodiment of the present invention, and blue light emission with high reliability can be obtained. The first light-emitting layer 213 can have the same structure as the light-emitting layer 113 described in Embodiment 2.

The second light-emitting layer 215 contains a light-emitting substance typified by the following compounds: fluorescent compounds, such as 2-(2-{2-[4-(dimethylamino)phenyl]ethenyl}-6-methyl-4H-pyran-4-ylidene)propanedinitrile (abbreviation: DCM1), 2-{2-methyl-6-[2-(2,3,6,7-tetrahydro-1H,5H-benzo[ij]quinolizin-9-yl)ethenyl]-4H-pyran-4-ylidene}propanedinitrile (abbreviation: DCM2), N,N,N′,N′-tetrakis(4-methylphenyl)tetracene-5,11-diamine (abbreviation: p-mPhTD), 7,14-diphenyl-N,N,N′,N′-tetrakis(4-methylphenyl)acenaphtho[1,2-a]fluoranthene-3,10-diamine (abbreviation: p-mPhAFD), 2-{2-isopropyl-6-[2-(1,1,7,7-tetramethyl-2,3,6,7-tetrahydro-1H,5H-benzo[α]quinolizin-9-yl)ethenyl]-4H-pyran-4-ylidene}propanedinitrile (abbreviation: DCJTI), 2-{2-tert-butyl-6-[2-(1,1,7,7-tetramethyl-2,3,6,7-tetrahydro-1H,5H-benzo[ij]quinolizin-9-yl)ethenyl]-4H-pyran-4-ylidene}propanedinitrile (abbreviation: DCJTB), 2-(2,6-bis{2-[4-(dimethylamino)phenyl]ethenyl}-4H-pyran-4-ylidene)propanedinitrile (abbreviation: BisDCM), and 2-{2,6-bis[2-(8-methoxy-1,1,7,7-tetramethyl-2,3,6,7-tetrahydro-1H,5H-benzo[ij]quinolizin-9-yl)ethenyl]-4H-pyran-4-ylidene}propanedinitrile (abbreviation: BisDCJTM); and phosphorescent compounds, such as bis[2-(2′-benzo[4,5-a]thienyl)pyridinato-N,C^{3′}]iridium(III)acetylacetonate (abbreviation: Ir(btp)₂(acac)), bis(1-phenylisoquinolinato-N,C^{2′})iridium(III)acetylacetonate (abbreviation: Ir(piq)₂(acac)), (acetylacetonato)bis[2,3-bis(4-fluorophenyl)quinoxalinato]iridium(III) (abbreviation: Ir(Fdpq)₂(acac)), (acetylacetonato)bis(2,3,5-triphenylpyrazinato)iridium(III) (abbreviation: Ir(tppr)₂(acac)), 2,3,7,8,12,13,17,18-octaethyl-21H,23H-porphyrinplatinum(II) (abbreviation: PtOEP), tris(1,3-diphenyl-1,3-propanedionato)(monophenanthroline)europium(III) (abbreviation: Eu(DBM)₃(Phen)), and tris[1-(2-thenoyl)-3,3,3-trifluoroacetonato](monophenanthroline)europium(III) (abbreviation: Eu(TTA)₃(Phen)), from which light emission having an emission peak at 560 nm to 700 nm (i.e. light emission from yellow to red) is obtained.

In addition, when the second light-emitting substance is a fluorescent compound, the second light-emitting layer 215 preferably has a structure in which the second light-emitting substance is dispersed as a guest in a substance as a first host which has higher singlet excitation energy than the second light-emitting substance. When the second light-emitting substance is a phosphorescent compound, the second light-emitting layer 215 preferably has a structure in which the second light-emitting substance is dispersed as a guest in a substance as a host material which has higher triplet excitation energy than the second light-emitting substance. The host material can be the above-described NPB or CBP, DNA, t-BuDNA, or the like. Note that the singlet excitation energy is an energy difference between a ground state and a singlet excited state. In addition, the triplet excitation energy is an energy difference between a ground state and a triplet excited state.

Specifically, the separation layer 214 can be formed using TPAQn, NPB, CBP, TCTA, Znpp₂, ZnBOX or the like described above. By thus providing the separation layer 214, a defect that emission intensity of one of the first light-emitting layer 213 and the second light-emitting layer 215 is stronger than that of the other can be prevented. Note that the separation layer 214 is not necessarily provided, and it may be provided as appropriate so that the ratio in emission intensity of the first light-emitting layer 213 and the second light-emitting layer 215 can be adjusted.

Other than the light-emitting layers, a hole-injection layer 111, a hole-transport layer 112, an electron-transport layer 114, and an electron-injection layer 115 are provided in the EL layer 102; as for structures of these layers, the structures of the respective layers described in Embodiment 2 can be applied. However, these layers are not necessarily provided and may be provided as appropriate according to element characteristics.

Note that the structure described in this embodiment can be combined with the structure described in Embodiment 1 or 2 as appropriate.

### Embodiment 4

In Embodiment 4, as one embodiment of the present invention, a structure of a light-emitting element which includes a plurality of EL layers (hereinafter, referred to as a stacked-type element) is described with reference to FIG. 1C. This light-emitting element is a stacked-type light-emitting element having a plurality of EL layers (a first EL layer 700 and a second EL layer 701) between a first electrode 101 and a second electrode 103. Note that, although the structure in which two EL layers are formed is described in this embodiment, a structure in which three or more EL layers are formed may be employed.

In Embodiment 4, the structures described in Embodiment 2 can be applied to the first electrode 101 and the second electrode 103.

In Embodiment 4, all or any of the plurality of EL layers (the first EL layer 700 and the second EL layer 701) may have the same structure as the EL layer described in Embodiment 2. In other words, the structures of the first EL layer 700 and the second EL layer 701 may be the same as or different from each other and can be the same as in Embodiment 2.

Further, a charge generation layer 305 is provided between the plurality of EL layers (the first EL layer 700 and the second EL layer 701). The charge generation layer 305 has a function of injecting electrons into one of the EL layers and injecting holes into the other of the EL layers when a voltage is applied between the first electrode 101 and the second electrode 103. In the case of this embodiment, when a voltage is applied such that the potential of the first electrode 101 is higher than that of the second electrode 103, the charge generation layer 305 injects electrons into the first EL layer 700 and injects holes into the second EL layer 701.

Note that the charge generation layer 305 preferably has a property of transmitting visible light in teens of light extraction efficiency. Further, the charge generation layer 305 functions even if it has lower conductivity than the first electrode 101 or the second electrode 103.

The charge generation layer 305 may have either a structure containing an organic compound having a high hole-transport property and an electron acceptor (acceptor) or a structure containing an organic compound having a high electron-transport property and an electron donor (donor). Alternatively, both of these structures may be stacked.

In the case of the structure in which an electron acceptor is added to an organic compound having a high hole-transport property, as the organic compound having a high hole-transport property, for example, an aromatic amine compound such as NPB, TPD, TDATA, MTDATA, or 4,4′-bis[N-(Spiro-9,9′-bifluoren-2-yl)-N-phenylamino]biphenyl (abbreviation: BSPB), or the like can be used. The substances mentioned here are mainly ones that have a hole mobility of 10⁻⁶ cm²/V·s or higher. However, substances other than the above substances may be used as long as they are organic compounds having a hole-transport property higher than an electron-transport property.

Further, as the electron acceptor, 7,7,8,8-tetracyano-2,3,5,6-tetrafluoroquinodimethane (abbreviation: F₄-TCNQ), chloranil, and the like can be given. In addition, a transition metal oxide can be given. In addition, an oxide of metals that belong to Group 4 to Group 8 of the periodic table can be given. Specifically, vanadium oxide, niobium oxide, tantalum oxide, chromium oxide, molybdenum oxide, tungsten oxide, manganese oxide, and rhenium oxide are preferable since their electron-accepting property is high. Among these, molybdenum oxide is especially preferable since it is stable in the air and its hygroscopic property is low and is easily treated.

On the other hand, in the case of the structure in which an electron donor is added to an organic compound having a high electron-transport property, as the organic compound having a high electron-transport property, for example, a metal complex having a quinoline skeleton or a benzoquinoline skeleton, such as Alq, Almq₃, BeBq₂, or BAlq, or the like can be used. Alternatively, a metal complex having an oxazole-based ligand or a thiazole-based ligand, such as Zn(BOX)₂ or Zn(BTZ)₂ can be used. Alternatively, in addition to such a metal complex, PBD, OXD-7, TAZ, BPhen, BCP, or the like can be used. The substances mentioned here are mainly ones that have an electron mobility of 10⁻⁶ cm²/V·s or higher. Note that substances other than the above substances may be used as long as they are organic compounds having an electron-transport property higher than a hole-transport property.

Further, as the electron donor, an alkali metal, an alkaline earth metal, a rare earth metal, a metal belonging to Group 13 of the periodic table, or an oxide or carbonate thereof can be used. Specifically, lithium, cesium, magnesium, calcium, ytterbium, indium, lithium oxide, cesium carbonate, or the like is preferably used. Alternatively, an organic compound such as tetrathianaphthacene may be used as the electron donor.

Note that forming the charge generation layer 305 by using the above materials can suppress an increase in drive voltage caused by the stack of the EL layers.

Although the light-emitting element having two EL layers has been described in this embodiment, the present invention can be similarly applied to a light-emitting element in which three or more EL layers are stacked. As in the case of the light-emitting element described in this embodiment, by arranging a plurality of EL layers to be partitioned from each other with charge-generation layers between a pair of electrodes, light emission in a high luminance region can be achieved with current density kept low. Since current density can be kept low, the element can have long lifetime. When the light-emitting element is applied for illumination, voltage drop due to resistance of an electrode material can be reduced, thereby achieving homogeneous light emission in a large area. Moreover, a light-emitting device of low power consumption, which can be driven at a low voltage, can be achieved.

Further, by forming EL layers to emit light of different colors from each other, a light-emitting element as a whole can provide light emission of a desired color. For example, by forming a light-emitting element having two EL layers such that the emission color of the first EL layer and the emission color of the second EL layer are complementary colors, the light-emitting element can provide white light emission as a whole. Note that the word “complementary” means color relationship in which an achromatic color is obtained when colors are mixed. That is, a mixture of light emissions with complementary colors gives white light emission.

Further, the same can be applied to a light-emitting element having three EL layers. For example, the light-emitting element as a whole can provide white light emission when the emission color of the first EL layer is red, the emission color of the second EL layer is green, and the emission color of the third EL layer is blue.

Note that the structure described in this embodiment can be combined with any of the structures described in Embodiments 1 to 3 as appropriate.

### Embodiment 5

In Embodiment 5, as one embodiment of the present invention, a passive matrix light-emitting device and an active matrix light-emitting device each of which is a light-emitting device fabricated using a light-emitting element are described.

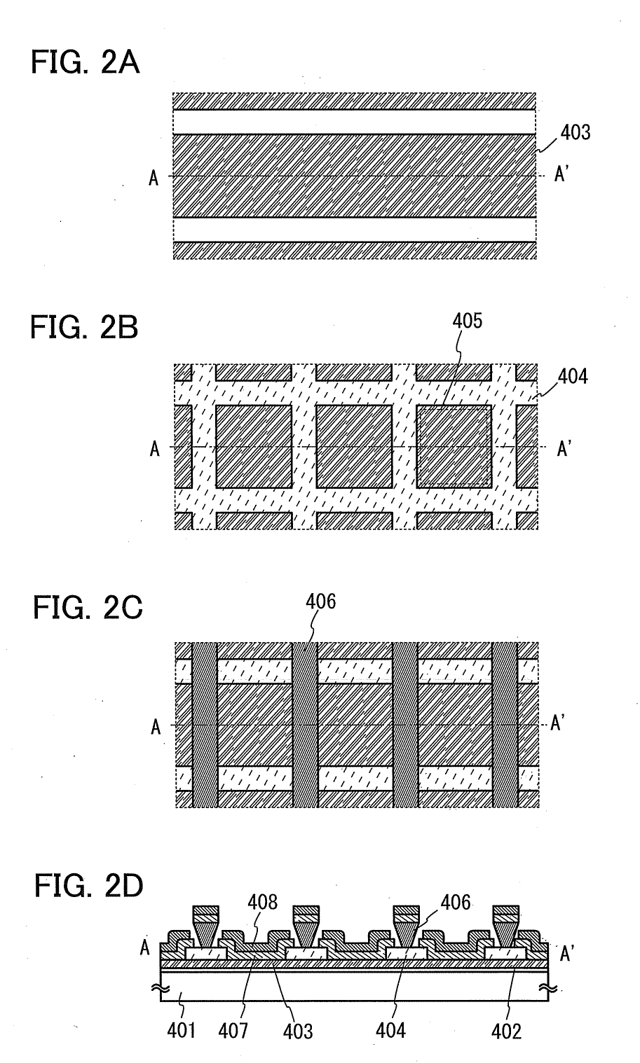

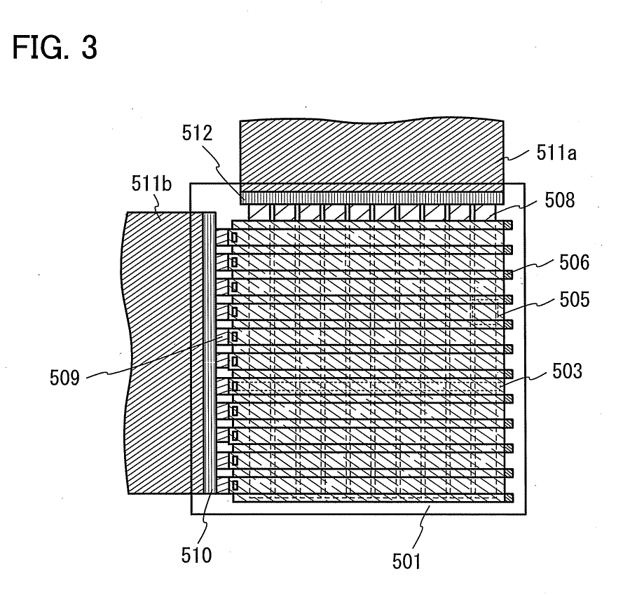

Examples of the passive matrix light-emitting device are illustrated in FIGS. 2A to 2D and FIG. 3.

In a passive matrix (also called simple matrix) light-emitting device, a plurality of anodes arranged in stripes (in stripe form) are provided to be perpendicular to a plurality of cathodes arranged in stripes. A light-emitting layer is interposed at each intersection. Therefore, a pixel at an intersection of an anode selected (to which a voltage is applied) and a cathode selected emits light.

FIGS. 2A to 2C are top views of a pixel portion before sealing. FIG. 2D is a cross-sectional view taken along chain line A-A′ in FIGS. 2A to 2C.

An insulating layer 402 is formed as a base insulating layer over a substrate 401. Note that the base insulating layer may not be provided if not necessary. A plurality of first electrodes 403 are arranged in stripes at regular intervals over the insulating layer 402 (see FIG. 2A).

In addition, a partition 404 having openings each corresponding to a pixel is provided over the first electrodes 403. The partition 404 having the openings is formed of an insulating material (a photosensitive or nonphotosensitive organic material (e.g., polyimide, acrylic, polyamide, polyimide amide, resist, or benzocyclobutene) or an SOG film (e.g., a SiOₓ film containing an alkyl group). Note that openings 405 corresponding to the pixels serve as light-emitting regions (FIG. 2B).

Over the partition 404 having the openings, a plurality of reversely tapered partitions 406 which are parallel to each other are provided to intersect with the first electrodes 403 (FIG. 2C). The reversely tapered partitions 406 are formed by a photolithography method using a positive-type photosensitive resin, portion of which unexposed to light remains as a pattern, and by adjustment of the amount of light exposure or the length of development time so that a lower portion of a pattern is etched more.

After the reversely tapered partitions 406 are formed as illustrated in FIG. 2C and FIG. 2D, an EL layer 407 and a second electrode 408 are sequentially formed as illustrated in FIG. 2D. The total thickness of the partition 404 having the openings and the reversely tapered partition 406 is set to be larger than the total thickness of the EL layer 407 and the second electrode 408; thus, as illustrated in FIG. 2D, EL layers 407 and second electrodes 408 which are separated for plural regions are formed. Note that the plurality of separated regions are electrically isolated from one another.

The second electrodes 408 are electrodes in stripe faun that are parallel to each other and extend along a direction intersecting with the first electrodes 403. Note that parts of a layer for forming the EL layers 407 and parts of a conductive layer for forming the second electrodes 408 are also fowled over the reversely tapered partitions 406; however, these parts are separated from the EL layers 407 and the second electrodes 408.

Note that there is no particular limitation on the first electrode 403 and the second electrode 408 in this embodiment as long as one of them is an anode and the other is a cathode. Note that a stacked structure in which the EL layer 407 is included may be adjusted as appropriate in accordance with the polarity of the electrode.

Further, if necessary, a sealing material such as a sealing can or a glass substrate may be attached to the substrate 401 for sealing with an adhesive such as a sealant, so that the light-emitting element is placed in the sealed space. Thereby, deterioration of the light-emitting element can be prevented. The sealed space may be filled with filler or a dry inert gas. Furthermore, a desiccant or the like may be put between the substrate and the sealant in order to prevent deterioration of the light-emitting element due to moisture. The desiccant removes a minute amount of moisture, thereby achieving sufficient desiccation. The desiccant can be a substance which absorbs moisture by chemical adsorption such as an oxide of an alkaline earth metal typified by calcium oxide or barium oxide. Additionally, a substance which adsorbs moisture by physical adsorption such as zeolite or silica gel may be used as well, as a desiccant.

FIG. 3 is a top view of the passive matrix light-emitting device illustrated in FIGS. 2A to 2D that is provided with a flexible printed circuit (an FPC) and the like.

As illustrated in FIG. 3, in a pixel portion forming an image display, scanning lines and data lines are arranged to intersect with each other so that the scanning lines and the data lines are perpendicular to each other.

The first electrodes 403 in FIGS. 2A to 2D correspond to scan lines 503 in FIG. 3; the second electrodes 408 in FIGS. 2A to 2D correspond to data lines 508 in FIG. 3; and the reversely tapered partitions 406 correspond to partitions 506. The EL layer 407 in FIGS. 2A to 2D is interposed between the data lines 508 and the scan lines 503, and an intersection indicated as a region 505 corresponds to one pixel.

Note that the scan lines 503 are electrically connected at their ends to connection wirings 509, and the connection wirings 509 are connected to an FPC 511b through an input terminal 510. In addition, the data lines are connected to an FPC 511a through the input terminal 512.

If necessary, an optical film such a polarizing plate, a circularly polarizing plate (including an elliptically polarizing plate), a retardation plate (a quarter-wave plate or a half-wave plate), and a color filter may be provided as appropriate on a surface through which light is emitted. Further, the polarizing plate or the circularly polarizing plate may be provided with an anti-reflection film. For example, anti-glare treatment by which reflected light can be diffused by projections and depressions on the surface so as to reduce the glare can be performed.

Although FIG. 3 illustrates the example in which a driver circuit is not provided over a substrate 501, an IC chip including a driver circuit may be mounted on the substrate 501.

When the IC chip is mounted, a data line side IC and a scan line side IC, in each of which a driver circuit for transmitting a signal to a pixel portion is formed, are mounted on the periphery of the pixel portion (outside the pixel portion) by a COG method. The mounting may be performed using a TCP or a wire bonding method other than the COG method. The TCP is a TAB tape mounted with the IC, and the TAB tape is connected to a wiring over an element formation substrate to mount the IC. Each of the data line side IC and the scanning line side IC may be formed using a silicon substrate. Alternatively, it may be that in which a driver circuit is formed using TFTs over a glass substrate, a quartz substrate, or a plastic substrate.

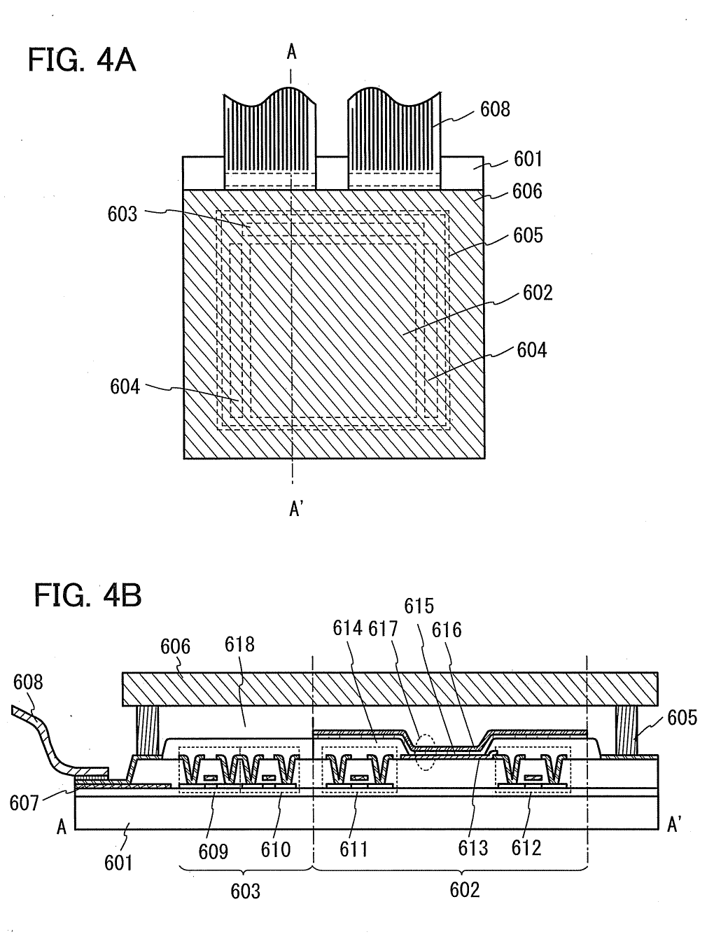

Next, an example of the active matrix light-emitting device is described with reference to FIGS. 4A and 4B. FIG. 4A is a top view illustrating a light-emitting device and FIG. 4B is a cross-sectional view taken along dashed line A-A′ in FIG. 4A. The active matrix light-emitting device according to this embodiment includes a pixel portion 602 provided over an element substrate 601, a driver circuit portion (a source side driver circuit) 603, and a driver circuit portion (a gate side driver circuit) 604. The pixel portion 602, the driver circuit portion 603, and the driver circuit portion 604 are sealed, with a sealing material 605, between the element substrate 601 and a sealing substrate 606.

In addition, over the element substrate 601, a lead wiring 607 for connecting an external input terminal, through which a signal (e.g., a video signal, a clock signal, a start signal, a reset signal, or the like) or an electric potential is transmitted to the driver circuit portion 603 and the driver circuit portion 604, is provided. Here, an example is described in which a flexible printed circuit (FPC) 608 is provided as the external input terminal. Although only the FPC is illustrated here, a printed wiring board (PWB) may be attached to the FPC. The light-emitting device in the present specification includes, in its category, not only the light-emitting device itself but also the light-emitting device provided with the FPC or the PWB.

Next, a cross-sectional structure is described with reference to FIG. 4B. The driver circuit portion and the pixel portion are Bawled over the element substrate 601, and in FIG. 4B, the driver circuit portion 603 that is a source side driver circuit and the pixel portion 602 are illustrated.

An example is illustrated in which a CMOS circuit which is a combination of an n-channel TFT 609 and a p-channel TFT 610 is formed as the driver circuit portion 603. Note that a circuit included in the driver circuit portion may be formed using various CMOS circuits, PMOS circuits, or NMOS circuits. Although a driver integrated type in which the driver circuit is formed over the substrate is described in this embodiment, the driver circuit may not necessarily be formed over the substrate, and the driver circuit can be formed outside, not over the substrate.

The pixel portion 602 is formed of a plurality of pixels each of which includes a switching TFT 611, a current control TFT 612, and an anode 613 which is electrically connected to a wiring (a source electrode or a drain electrode) of the current control TFT 612. Note that an insulator 614 is formed to cover end portions of the anode 613. In this embodiment, the insulator 614 is formed using a positive photosensitive acrylic resin.

The insulator 614 is preferably formed so as to have a curved surface with curvature at an upper end portion or a lower end portion thereof in order to obtain favorable coverage by a film which is to be stacked over the insulator 614. For example, in the case of using a positive photosensitive acrylic resin as a material for the insulator 614, the insulator 614 is preferably formed so as to have a curved surface with a curvature radius (0.2 μm to 3 μm) at the upper end portion. Note that either a negative photosensitive material that becomes insoluble in an, etchant by light irradiation or a positive photosensitive material that becomes soluble in an etchant by light irradiation can be used for the insulator 614. As the insulator 614, without limitation to an organic compound, either an organic compound or an inorganic compound such as silicon oxide or silicon oxynitride can be used.

An EL layer 615 and a cathode 616 are stacked over the anode 613. Note that when an ITO film is used as the anode 613, and a stacked film of a titanium nitride film and a film containing aluminum as its main component or a stacked film of a titanium nitride film, a film containing aluminum as its main component, and a titanium nitride film is used as the wiring of the current controlling TFT 612 which is connected to the anode 613, resistance of the wiring is low and favorable ohmic contact with the ITO film can be obtained. Note that, although not illustrated in FIGS. 4A and 4B, the cathode 616 is electrically connected to an FPC 608 which is an external input terminal.

Note that in the EL layer 615, at least a light-emitting layer is provided, and in addition to the light-emitting layer, a hole-injection layer, a hole-transport layer, an electron-transport layer, or an electron-injection layer is provided as appropriate. A light-emitting element 617 is fowled of a stacked structure of the anode 613, the EL layer 615, and the cathode 616.

Although the cross-sectional view of FIG. 4B illustrates only one light-emitting element 617, a plurality of light-emitting elements are arranged in matrix in the pixel portion 602. Light-emitting elements which provide three kinds of emissions (R, G, and B) are selectively formed in the pixel portion 602, whereby a light-emitting device capable of full color display can be formed. Alternatively, a light-emitting device which is capable of full color display may be manufactured by a combination with color filters.

Further, the sealing substrate 606 is attached to the element substrate 601 with the sealing material 605, whereby a light-emitting element 617 is provided in a space 618 surrounded by the element substrate 601, the sealing substrate 606, and the sealing material 605. The space 618 may be filled with an inert gas (such as nitrogen or argon), or the sealing material 605.

An epoxy based resin is preferably used for the sealing material 605. A material used for these is desirably a material which does not transmit moisture or oxygen as much as possible. As a material used for the sealing substrate 606, a plastic substrate formed of FRP (fiberglass-reinforced plastics), PVF (polyvinyl fluoride), polyester, acrylic, or the like can be used other than a glass substrate or a quartz substrate.

As described above, an active matrix light-emitting device can be obtained.

Note that the structure described in this embodiment can be combined with any of the structures described in Embodiments 1 to 4 as appropriate.

### Embodiment 6

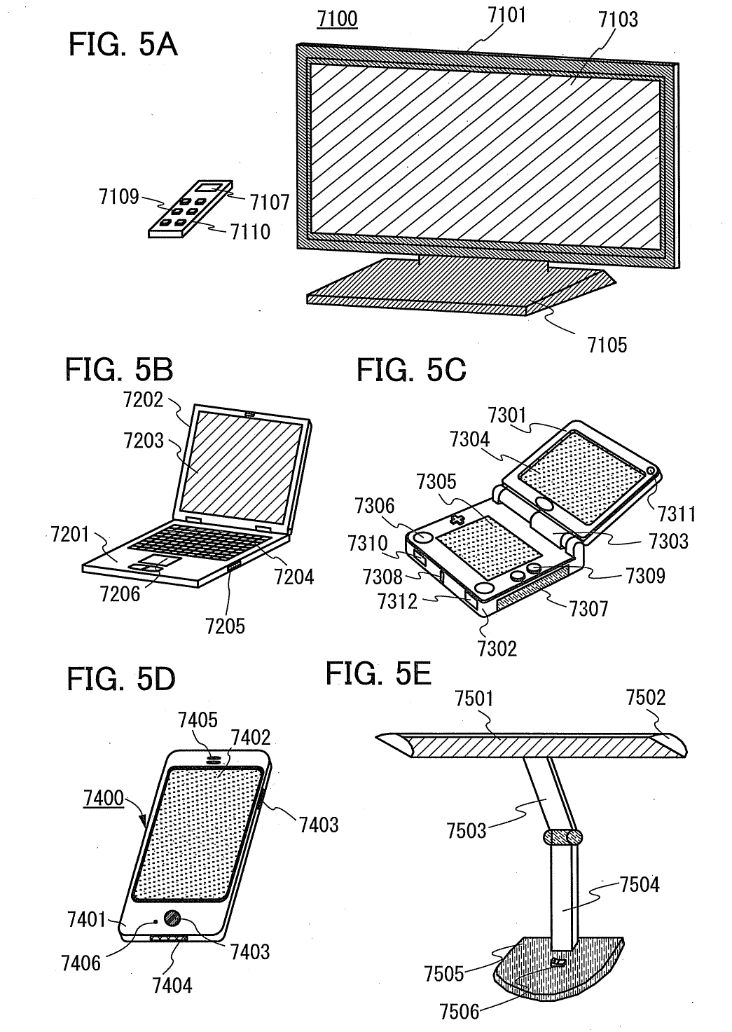

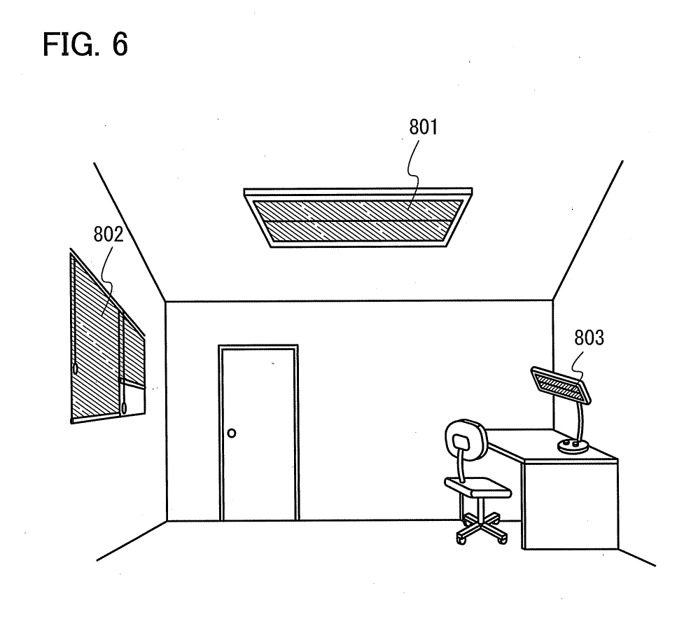

In Embodiment 6, with reference to FIGS. 5A to 5E and FIG. 6, description is given of examples of a variety of electronic devices and lighting devices that are completed by using a light-emitting device which is one embodiment of the present invention.

Examples of the electronic devices to which the light-emitting device is applied include television sets (also referred to as televisions or television receivers), monitors of computers or the like, cameras such as digital cameras or digital video cameras, digital photo frames, cellular phones (also referred to as mobile phones or cellular phone sets), portable game consoles, portable information terminals, audio reproducing devices, large game machines such as pachinko machines, and the like. Specific examples of these electronic devices and a lighting device are illustrated in FIGS. 5A to 5E.

FIG. 5A illustrates an example of a television device. In a television device 7100, a display portion 7103 is incorporated in a housing 7101. Images can be displayed by the display portion 7103, and the light-emitting device can be used for the display portion 7103. In addition, here, the housing 7101 is supported by a stand 7105.

The television device 7100 can be operated by an operation switch of the housing 7101 or a separate remote controller 7110. With operation keys 7109 of the remote controller 7110, channels and volume can be controlled and images displayed on the display portion 7103 can be controlled. Furthermore, the remote controller 7110 may be provided with a display portion 7107 for displaying data output from the remote controller 7110.

Note that the television device 7100 is provided with a receiver, a modem, and the like. Moreover, when the display device is connected to a communication network with or without wires via the modem, one-way (from a sender to a receiver) or two-way (between a sender and a receiver or between receivers) information communication can be performed.

FIG. 5B illustrates a computer having a main body 7201, a housing 7202, a display portion 7203, a keyboard 7204, an external connection port 7205, a pointing device 7206, and the like. This computer is manufactured by using a light-emitting device for the display portion 7203.

FIG. 5C illustrates a portable game machine having two housings, a housing 7301 and a housing 7302, which are connected with a joint portion 7303 so that the portable game machine can be opened or folded. A display portion 7304 is incorporated in the housing 7301 and a display portion 7305 is incorporated in the housing 7302. In addition, the portable game machine illustrated in FIG. 5C includes a speaker portion 7306, a recording medium insertion portion 7307, an LED lamp 7308, an input means (an operation key 7309, a connection terminal 7310, a sensor 7311 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), or a microphone 7312), and the like. It is needless to say that the structure of the portable games machine is not limited to the above as long as the light-emitting device is used for at least either the display portion 7304 or the display portion 7305, or both, and may include other accessories as appropriate. The portable game machine illustrated in FIG. 5C has a function of reading out a program or data stored in a storage medium to display it on the display portion, and a function of sharing information with another portable game machine by wireless communication. The portable game machine illustrated in FIG. 5C can have a variety of functions without limitation to the above.

FIG. 5D illustrates an example of a cellular phone. A cellular phone 7400 is provided with a display portion 7402 incorporated in a housing 7401, operation buttons 7403, an external connection port 7404, a speaker 7405, a microphone 7406, and the like. Note that the cellular phone 7400 is manufactured by using a light-emitting device for the display portion 7402.

When the display portion 7402 of the cellular phone 7400 illustrated in FIG. 5D is touched with a finger or the like, data can be input into the cellular phone 7400. Further, operations such as making a call and creating e-mail can be performed by touch on the display portion 7402 with a finger or the like.

There are mainly three screen modes of the display portion 7402. The first mode is a display mode mainly for displaying images. The second mode is an input mode mainly for inputting data such as text. The third mode is a display-and-input mode in which two modes of the display mode and the input mode are combined.

For example, in the case of making a call or creating e-mail, a text input mode mainly for inputting text is selected for the display portion 7402 so that text displayed on a screen can be inputted. In that case, it is preferable to display a keyboard or number buttons on almost all the area of the screen of the display portion 7402.

When a detection device including a sensor for detecting inclination, such as a gyroscope or an acceleration sensor, is provided inside the cellular phone 7400, display on the screen of the display portion 7402 can be automatically changed by determining the orientation of the cellular phone 7400 (whether the cellular phone is placed horizontally or vertically for a landscape mode or a portrait mode).

The screen modes are switched by touching the display portion 7402 or operating the operation buttons 7403 of the housing 7401. Alternatively, the screen modes can be switched depending on kinds of images displayed on the display portion 7402. For example, when a signal of an image displayed on the display portion is a signal of moving image data, the screen mode is switched to the display mode. When the signal is a signal of text data, the screen mode is switched to the input mode.

Moreover, in the input mode, when input by touching the display portion 7402 is not performed within a specified period while a signal detected by an optical sensor in the display portion 7402 is detected, the screen mode may be controlled so as to be switched from the input mode to the display mode.

The display portion 7402 may function as an image sensor. For example, an image of a palm print, a fingerprint, or the like is taken by touch on the display portion 7402 with the palm or the finger, whereby personal authentication can be performed. Further, by providing a backlight or a sensing light source which emits a near-infrared light in the display portion, an image of a finger vein, a palm vein, or the like can be taken.

FIG. 5E illustrates a desk lamp including a lighting portion 7501, a shade 7502, an adjustable arm 7503, a support 7504, a base 7505, and a power switch 7506. The desk lamp is manufactured by using a light-emitting device for the lighting portion 7501. Note that the lighting device includes a ceiling light, a wall light, and the like.

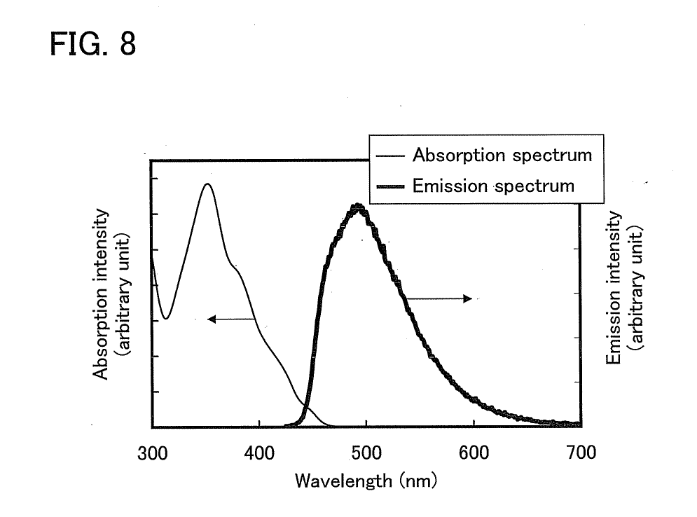

FIG. 6 illustrates an example in which a light-emitting device is used for an interior lighting device 801. Since the light-emitting device can have a larger area, the light-emitting device can be used as a lighting device having a large area. Alternatively, the light-emitting device can be used as a roll-type lighting device 802. Note that as illustrated in FIG. 8, a desk lamp 803 described with reference to FIG. 5E may be used together in a room provided with the indoor lighting device 801.

As described above, electronic devices and a lighting device can be obtained by application of the light-emitting device. The light-emitting device has a remarkably wide application range, and can be applied to electronic devices in various fields.

Note that the structure described in this embodiment can be combined with any of the structures described in Embodiments 1 to 5 as appropriate.

### Example 1

### Synthetic Example 1

This example specifically illustrates a synthetic example of tris[3-methyl-1-(2-methylphenyl)-5-phenyl-1H-1,2,4-triazolato]iridium(III) (abbreviation: [Ir(Mptz1-mp)₃]), the organometallic complex represented by the structural formula (100) in Embodiment 1 which is one embodiment of the present invention. A structure of [Ir(Mptz1-mp)₃] (abbreviation) is shown below.

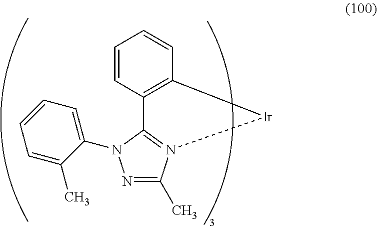

### Step 1: Synthesis of N-(1-Ethoxyethylidene)benzamide

First, 15.5 g of ethyl acetimidate hydrochloride, 150 mL of toluene, and 31.9 g of triethylamine (Et₃N) were put into a 500-mL three-neck flask and stirred at room temperature for 10 minutes. With a 50-mL dropping, funnel, a mixed solution of 17.7 g of benzoyl chloride and 30 mL of toluene were added dropwise to this mixture, and the mixture was stirred at room temperature for 24 hours. After a predetermined time elapsed, the reaction mixture was suction-filtered, and the solid was washed with toluene. The obtained filtrate was concentrated to give N-(1-ethoxyethylidene)benzamide (a red oily substance, 82% yield). The synthesis scheme of Step 1 is shown in (a-1) below.

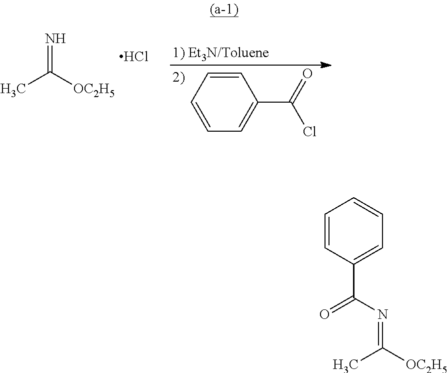

### Step 2: Synthesis of 3-Methyl-1-(2-methylphenyl)-5-phenyl-1H-1,2,4-triazole (abbreviation: HMptz1-mp)

Next, 8.68 g of o-tolyl hydrazine hydrochloride, 100 mL of carbon tetrachloride, and 35 mL of triethylamine (Et₃N) were put into a 300-mL recovery flask and stirred at room temperature for 1 hour. After a predetermined time elapsed, 8.72 g of N-(1-ethoxyethylidene)benzamide obtained in Step 1 above was added to this mixture, and the mixture was stirred at room temperature for 24 hours. After a predetermined time elapsed, water was added to the reaction mixture, the aqueous layer was subjected to extraction with chloroform, and an organic layer was obtained. The organic layer was washed with saturated saline, and dried with anhydrous magnesium sulfate added thereto. The obtained mixture was gravity-filtered, and the filtrate was concentrated to give an oily substance. The given oily substance was purified by silica gel column chromatography. Dichloromethane was used as a developing solvent. The obtained fraction was concentrated to give 3-methyl-1-(2-methylphenyl)-5-phenyl-1H-1,2,4-triazole (abbreviation: HMptz1-mp) (an orange oily substance, 84% yield). The synthesis scheme of Step 2 is shown in (a-2) below.

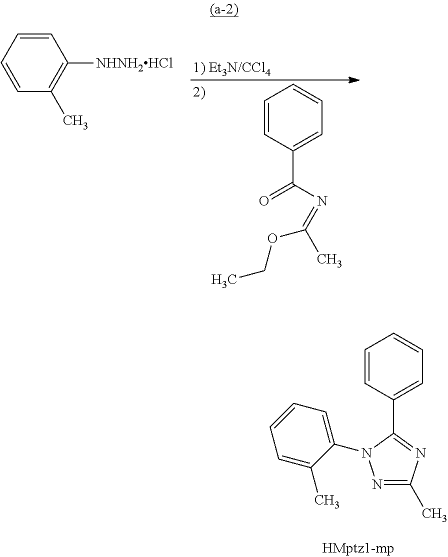

### Step 3: Synthesis of Tris[3-methyl-1-(2-methylphenyl)-5-phenyl-1H-1,2,4-triazolato]iridium(III) (abbreviation: [Ir(Mptz1-mp)₃])

Next, 2.71 g of the ligand HMptz1-mp (abbreviation) obtained in Step 2 above and 1.06 g of tris(acetylacetonato)iridium(III) were put into a reaction container provided with a three-way cock. The air in this reaction container was replaced with argon, and the mixture was heated at 250° C. for 48 hours to be reacted. This reaction mixture was dissolved in dichloromethane and purified by silica gel column chromatography. As the developing solvent, dichloromethane was first used, and a mixed solvent of dichloromethane and ethyl acetate in a ratio of 10:1 (v/v) was then used. The obtained fraction was concentrated to obtain a solid. This solid was washed with ethyl acetate, and recrystallized from a mixed solvent of dichloromethane and ethyl acetate to give the organometallic complex [Ir(Mptz1-mp)₃] (abbreviation), which is one embodiment of the present invention (yellow powder, 35% yield). The synthesis scheme of Step 3 is shown in (a-3) below.

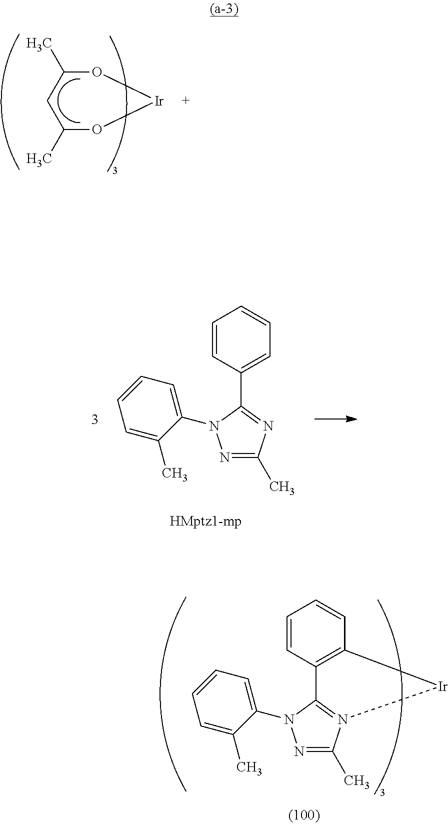

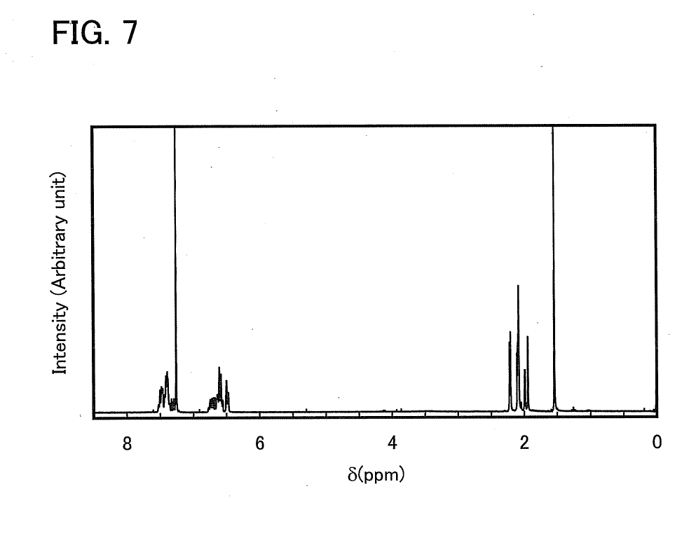

An analysis result by nuclear magnetic resonance spectrometry (¹H NMR) of the yellow powder obtained in Step 3 above is described below. The ¹H NMR chart is shown in FIG. 7. These results revealed that [Ir(Mptz1-mp)₃] (abbreviation), the organometallic complex represented by the structural formula (100) which is one embodiment of the present invention, was obtained in this example.

¹H NMR data of the obtained substance are as follows:

¹H NMR. δ (CDCl₃): 1.94-2.21 (m, 18H), 6.47-6.76 (m, 12H), 7.29-7.52 (m, 12H).

Next, an ultraviolet-visible absorption spectrum (hereinafter, simply referred to as an absorption spectrum) and an emission spectrum of [Ir(Mptz1-mp)₃] (abbreviation) in a dichloromethane solution were measured. The absorption spectrum was measured with the use of an ultraviolet-visible light spectrophotometer (V-550, manufactured by JASCO Corporation) in the state where a dichloromethane solution (0.085 mmol/L) was put in a quartz cell at room temperature. The emission spectrum was measured with the use of a fluorescence spectrophotometer (FS920, manufactured by Hamamatsu Photonics Corporation) in the state where the degassed dichloromethane solution (0.085 mmol/L) was put in a quartz cell at room temperature. FIG. 8 shows measurement results of the absorption spectrum and emission spectrum. The horizontal axis represents wavelength and the vertical axis represents absorption intensity and emission intensity. In FIG. 8, two solid lines are shown; a thin line represents the absorption spectrum, and a thick line represents the emission spectrum. Note that the absorption spectrum in FIG. 8 is a result obtained by subtraction of a measured absorption spectrum of only dichloromethane that was put in a quartz cell from the measured absorption spectrum of the dichloromethane solution (0.085 mmol/L) in a quartz cell.

As shown in FIG. 8, [Ir(Mptz1-mp)₃] (abbreviation), the organometallic complex of one embodiment of the present invention, has an emission peak at 493 nm, and light blue emission was observed from the dichloromethane solution.

### Example 2

### Synthetic Example 2

This example specifically illustrates a synthetic example of tris[3-isopropyl-1-(2-methylphenyl)-5-phenyl-1H-1,2,4-triazolato]iridium(III) (abbreviation: [Ir(iPrptz1-mp)₃]), the organometallic complex represented by the structural formula (102) in Embodiment 1 which is one embodiment of the present invention. A structure of [Ir(iPrptz1-mp)₃] (abbreviation) is shown below.

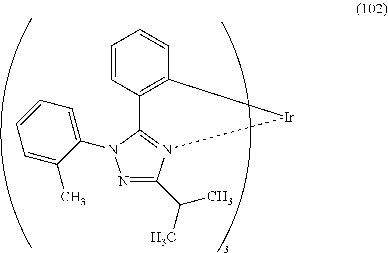

### Step 1: Synthesis of N-(1-Methoxyisobutylidene)benzamide

First, 10.0 g of methyl isobutyrimidate hydrochloride, 150 mL of toluene, and 18.4 g of triethylamine (Et₃N) were put into a 500-mL three-neck flask and stirred at room temperature for 10 minutes. A mixed solution of 10.2 g of benzoyl chloride and 30 mL of toluene were added dropwise to this mixture, and the mixture was stirred at room temperature for 27 hours. After the stirring, this reaction mixture was suction-filtered to give filtrate. The obtained filtrate was washed with water and then with saturated saline. Anhydrate magnesium sulfate was added to the organic layer for drying, and the resulting mixture was gravity-filtered to give filtrate. The obtained filtrate was concentrated to give N-(1-methoxyisobutylidene)benzamide (a brown oily substance, 91% yield). The synthesis scheme of Step 1 is shown in (b-1) below.

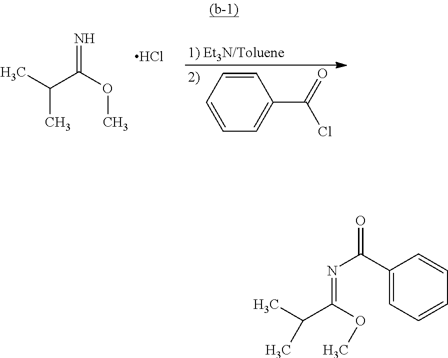

### Step 2: Synthesis of 3-Isopropyl-1-(2-methylphenyl)-5-phenyl-1H-1,2,4-triazole] (abbreviation: HiPrptz1-mp)

Next, 4.64 g of o-tolyl hydrazine hydrochloride, 50 mL of carbon tetrachloride, and 20 mL of triethylamine (Et₃N) were put into a 300-mL three-neck flask and stirred at room temperature for 1 hour. After a predetermined time elapsed, 6.0 g of N-(1-methoxyisobutylidene)benzamide obtained in Step 1 above was added to this mixture, and the mixture was stirred at room temperature for 17 hours. After a predetermined time elapsed, water was added to the reaction mixture, the aqueous layer was subjected to extraction with chloroform, and an organic layer was obtained. The organic layer and the solution of the extract were washed together with saturated saline, and anhydrate magnesium sulfate was added to the organic layer for drying. The mixture was gravity-filtered and the filtrate was concentrated to give an oily substance. This oily substance was purified by silica gel column chromatography. As the developing solvent, hexane and ethyl acetate in a ratio of 10:1 (v/v) was used. The obtained fraction was concentrated to give 3-isopropyl-1-(2-methylphenyl)-5-phenyl-1H-1,2,4-triazole (abbreviation: HiPrptz1-mp) (an orange oily substance, 78% yield). The synthesis scheme of Step 2 is shown in (b-2) below.

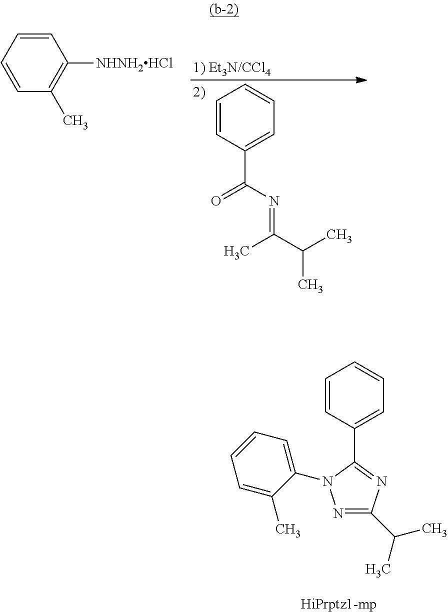

### Step 3: Synthesis of Tris[3-isopropyl-1-(2-methylphenyl)-5-phenyl-1H-1,2,4-triazolato]iridium(III) (abbreviation: [Ir(iPrptz1-mp)₃])

Next, 2.0 g of the ligand HiPrptz1-mp (abbreviation) obtained in Step 2 above and 0.706 g of tris(acetylacetonato)iridium(III) were put into a reaction container provided with a three-way cock, heated at 220° C. for 33 hours, and then heated at 250° C. for 47 hours to be reacted. The resulting reaction mixture was dissolved in dichloromethane and purified by silica gel column chromatography. Dichloromethane was used as a developing solvent. The obtained fraction was concentrated to give [Ir(iPrptz1-mp)₃] (abbreviation), the organometallic complex of one embodiment of the present invention (yellow powder, 5% yield). The synthesis scheme of Step 3 is shown in (b-3).

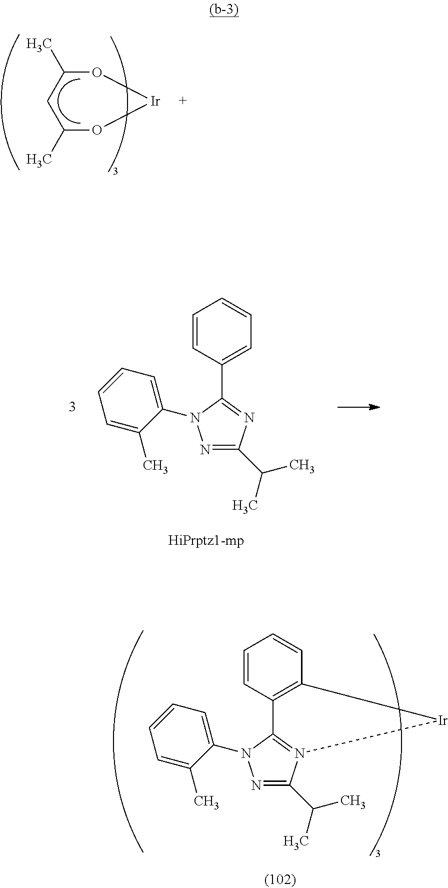

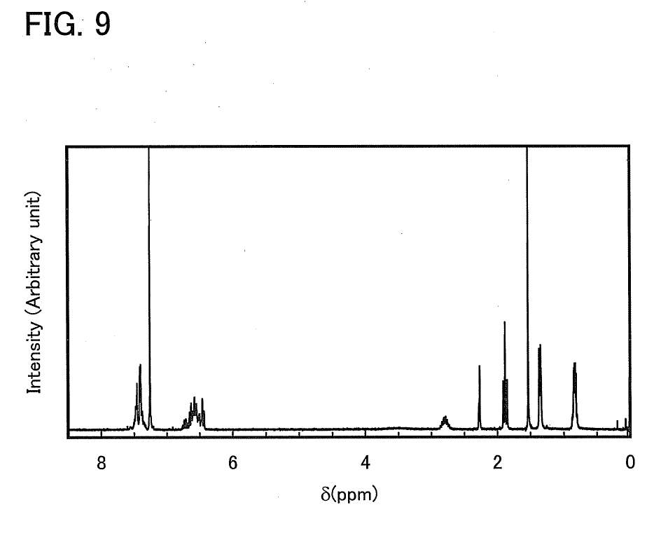

An analysis result by nuclear magnetic resonance spectrometry (¹H NMR) of the yellow powder obtained in Step 3 above is described below. The ¹H NMR chart is shown in FIG. 9. These results revealed that [Ir(iPrptz1-mp)₃] (abbreviation), the organometallic complex represented by the structural formula (102) which is one embodiment of the present invention, was obtained in Synthetic Example 2.

¹H NMR data of the obtained substance are as follows:

¹H NMR. δ (CDCl₃): 0.80-0.87 (m, 9H), 1.36 (d, 9H), 1.85-2.28 (m, 9H), 2.80 (sep, 3H), 6.44-6.76 (m, 12H), 7.36-7.48 (m, 12H).

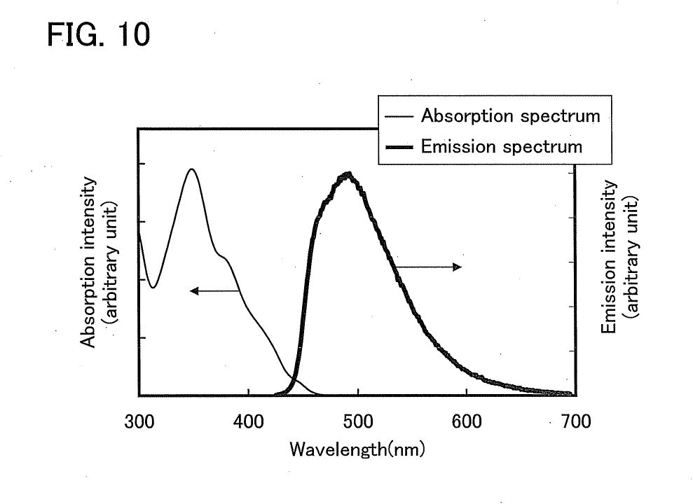

Next, an ultraviolet-visible absorption spectrum (hereinafter, simply referred to as an absorption spectrum) and an emission spectrum of [Ir(iPrptz1-mp)₃] (abbreviation) in a dichloromethane solution were measured. The absorption spectrum was measured with the use of an ultraviolet-visible light spectrophotometer (V-550, manufactured by JASCO Corporation) in the state where a dichloromethane solution (0.077 mmol/L) was put in a quartz cell at room temperature. The emission spectrum was measured with the use of a fluorescence spectrophotometer (FS920, manufactured by Hamamatsu Photonics Corporation) in the state where the degassed dichloromethane solution (0.077 mmol/L) was put in a guard cell at room temperature. FIG. 10 shows measurement results of the absorption spectrum and emission spectrum. The horizontal axis represents wavelength and the vertical axis represents absorption intensity and emission intensity. In FIG. 10, two solid lines are shown; a thin line represents the absorption spectrum, and a thick line represents the emission spectrum. Note that the absorption spectrum in FIG. 10 is a result obtained by subtraction of a measured absorption spectrum of only dichloromethane that was put in a quartz cell from the measured absorption spectrum of the dichloromethane solution (0.077 mmol/L) in a quartz cell.

As shown in FIG. 10, [Ir(iPrptz1-mp)₃] (abbreviation), the organometallic complex of one embodiment of the present invention, has an emission peak at 493 nm, and light blue emission was observed from the dichloromethane solution.

### Example 3

### Synthetic Example 3

This example specifically illustrates a synthetic example of tris[1-(2-methylphenyl)-5-phenyl-3-propyl-1H-1,2,4-triazolato]iridium(III) (abbreviation: [Ir(Prptz1-mp)₃]), the organometallic complex represented by the structural formula (103) in Embodiment 1 which is one embodiment of the present invention. A structure of [Ir(Prptz1-mp)₃] (abbreviation) is shown below.

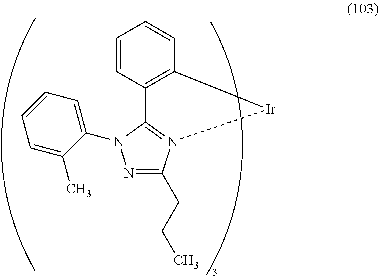

### Step 1: Synthesis of N-(1-Ethoxybutylidene)benzamide

First, 10 g of ethyl butyrimidate hydrochloride, 40 mL of toluene, and 17 g of triethylamine (Et₃N) were put into a 200-mL three-neck flask and stirred at room temperature for 10 minutes. A mixed solution of 9.3 g of benzoyl chloride and 30 mL of toluene were added dropwise to this mixture, and the mixture was stirred at room temperature for 20 hours. After a predetermined time elapsed, this mixture was suction-filtered and the filtrate was washed with a saturated aqueous solution of sodium hydrogen carbonate. After the washing, anhydrous magnesium sulfate was added to the organic layer for drying. The obtained mixture was gravity-filtered and the filtrate was concentrated to give N-(1-ethoxybutylidene)benzamide (a yellow oily substance, 87% yield). The synthesis scheme of Step 1 is shown in (c-1) below.

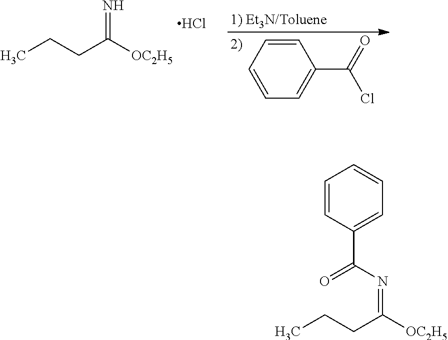

### Step 2: Synthesis of 1-(2-Methylphenyl)-5-phenyl-3-propyl-1H-1,2,4-triazole (abbreviation: HPrptz1-mp)

Next, 4.3 g of o-tolyl hydrazine hydrochloride and 50 mL of carbon tetrachloride were put into a 200-mL three-neck flask, and 20 mL of triethylamine (Et₃N) was added dropwise to this mixture little by little. After the addition, the mixture was stirred at room temperature for 1 hour. To this mixture was added 5.0 g of N-(1-ethoxybutylidene)benzamide, and the mixture was stirred at room temperature for 18 hours. Water was added to the obtained reaction mixture, the aqueous layer was subjected to extraction with chloroform, and an organic layer was obtained. The organic layer was washed with saturated saline, and dried with anhydrous magnesium sulfate added thereto. The resulting mixture was gravity-filtered to give filtrate. This filtrate was concentrated to give 1-(2-methylphenyl)-5-phenyl-3-propyl-1H-1,2,4-triazole (abbreviation: HPrptz1-mp) (a red oily substance, 74% yield). The synthesis scheme of Step 1 is shown in (c-2) below.

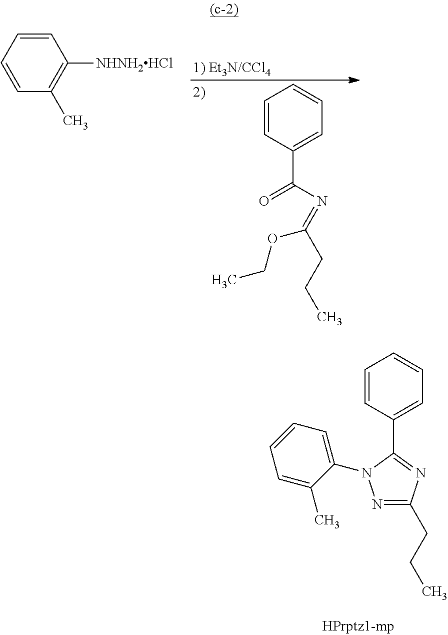

### Step 3: Synthesis Tris[1-(2-methylphenyl)-5-phenyl-3-propyl-1H-1,2,4-triazolato]iridium(III) (abbreviation: [Ir(Prptz1-mp)₃])

Further, 1.57 g of the ligand HPrptz1-mp (abbreviation) obtained in Step 2 above and 0.55 g of tris(acetylacetonato)iridium(III) were put into a reaction container provided with a three-way cock, and the air in the reaction container was replaced with argon. After that, the mixture was heated at 250° C. for 47 hours to be reacted. The reactant was dissolved in dichloromethane, and this solution was filtrated. The solvent of the resulting filtrate was distilled off and purification was conducted by silica gel column chromatography which uses dichloromethane as a developing solvent. Further, recrystallization was carried out with a dichloromethane solvent, so that [Ir(Prptz1-mp)₃] (abbreviation), the organometallic complex of one embodiment of the present invention, was obtained (yellow powder, 65% yield). The synthesis scheme of Step 3 is shown in (c-3) below.

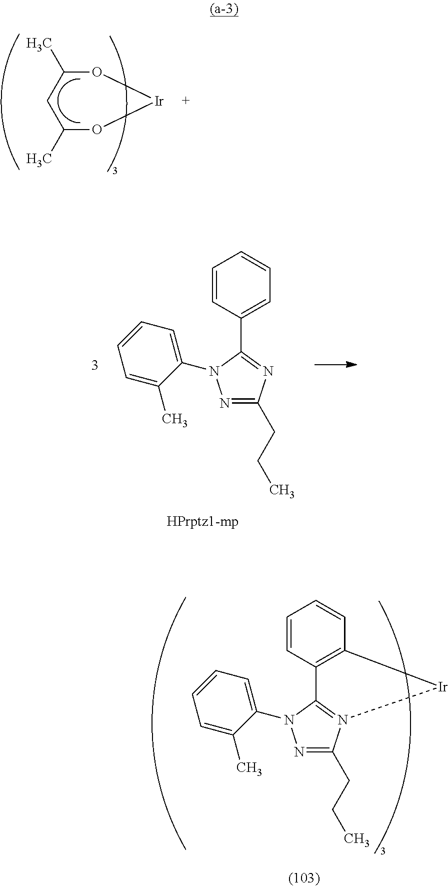

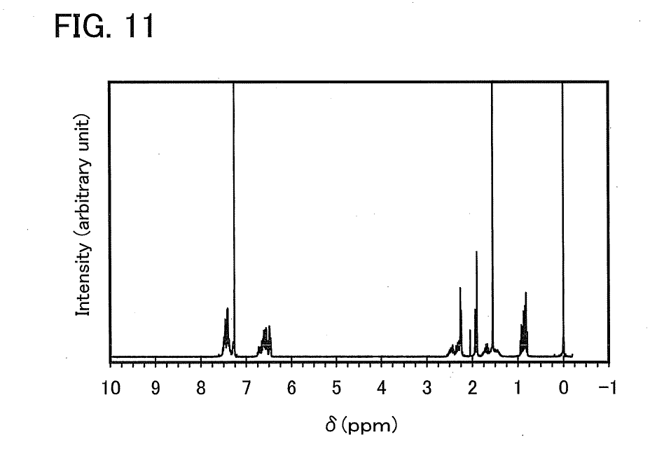

An analysis result by nuclear magnetic resonance spectrometry (¹H NMR) of the yellow powder obtained in Step 3 above is described below. The ¹H NMR chart is shown in FIG. 11. These results revealed that [Ir(Prptz1-mp)₃] (abbreviation), the organometallic complex represented by the structural formula (103) which is one embodiment of the present invention, was obtained in Synthetic Example 3.

¹H NMR data of the obtained substance are as follows:

¹H NMR. δ (CDCl₃): 0.86 (m, 9H), 1.50 (m, 3H), 1.69 (m, 3H), 1.92 (d, 6H), 2.25 (d, 3H), 2.32 (m, 3H), 2.45 (m, 3H), 6.46-6.75 (m, 12H), 7.29 (m, 3H), 7.35-7.52 (m, 9H).

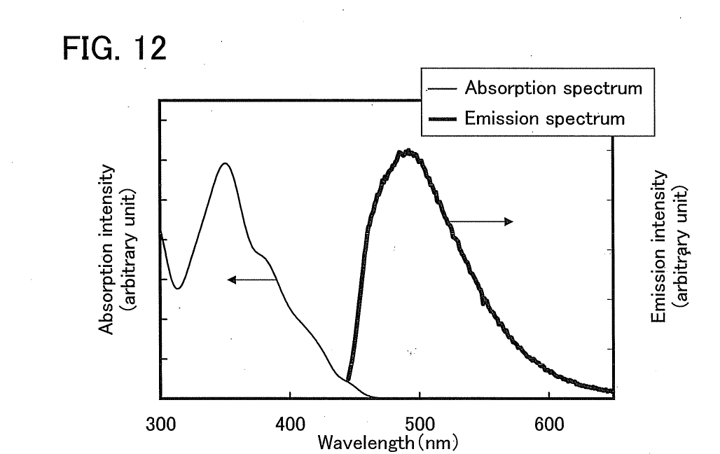

Next, an ultraviolet-visible absorption spectrum (hereinafter, simply referred to as an absorption spectrum) and an emission spectrum of [Ir(Prptz1-mp)₃] (abbreviation) in a dichloromethane solution were measured. The absorption spectrum was measured with the use of an ultraviolet-visible light spectrophotometer (V-550, manufactured by JASCO Corporation) in the state where a dichloromethane solution (0.086 mmol/L) was put in a quartz cell at room temperature. The emission spectrum was measured with the use of a fluorescence spectrophotometer (FS920, manufactured by Hamamatsu Photonics Corporation) in the state where the degassed dichloromethane solution (0.52 mmol/L) was put in a quartz cell at room temperature. FIG. 12 shows measurement results of the absorption spectrum and emission spectrum. The horizontal axis represents wavelength and the vertical axis represents absorption intensity and emission intensity. In FIG. 12, two solid lines are shown; a thin line represents the absorption spectrum, and a thick line represents the emission spectrum. Note that the absorption spectrum in FIG. 12 is a result obtained by subtraction of a measured absorption spectrum of only dichloromethane that was put in a quartz cell from the measured absorption spectrum of the dichloromethane solution (0.086 mmol/L) in a quartz cell.

As shown in FIG. 12, [Ir(Prptz1-mp)₃] (abbreviation), the organometallic complex of one embodiment of the present invention, has an emission peak at 491 nm, and light blue emission was observed from the dichloromethane solution.

### Example 4

### Synthetic Example 4

This example specifically illustrates a synthetic example of tris[3-ethyl-1-(2-methylphenyl)-5-phenyl-1H-1,2,4-triazolato]iridium(III) (abbreviation: [Ir(Eptz1-mp)₃]), the organometallic complex represented by the structural formula (101) in Embodiment 1 which is one embodiment of the present invention. A structure of [Ir(Eptz1-mp)₃] (abbreviation) is shown below.

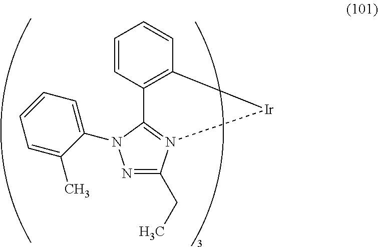

### Step 1: Synthesis of N-(1-Methoxypropylidene)benzamide

First, 5.0 g of ethyl propionimidate hydrochloride, 100 mL of toluene, and 8.5 g of triethylamine (Et₃N) were put into a 300-mL three-neck flask and stirred at room temperature for 10 minutes. After a predetermined time elapsed, with a 50-mL dropping funnel, a mixed solution of 5.6 g of benzoyl chloride and 30 mL of toluene were added dropwise to this mixture, and the mixture was stirred at room temperature for 20 hours. The obtained reaction mixture was suction-filtered and the filtrate was concentrated to give N-(1-methoxypropylidene)benzamide (a yellow oily substance, 82% yield). The synthesis scheme of Step 1 is shown in (g-1) below.

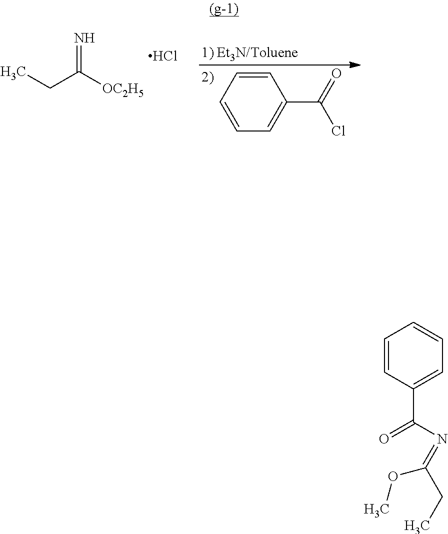

### Step 2: Synthesis of 3-Ethyl-1-(2-methylphenyl)-5-phenyl-1H-1,2,4-triazole (abbreviation: HEptz1-mp)

Next, 5.8 g of o-tolyl hydrazine hydrochloride, 100 mL of carbon tetrachloride, and 11 mL of triethylamine (Et₃N) were put into a 300-mL three-neck flask, and the mixture was stirred at room temperature for 1 hour. After a predetermined time elapsed, 6.3 g of N-(1-methoxypropylidene)benzamide obtained in Step 1 above was added to this mixture, and the mixture was stirred at room temperature for 65 hours. Water was added to the obtained reaction solution, the aqueous layer was subjected to extraction with chloroform, and an organic layer was obtained. The organic layer and the obtained solution of the extract were washed together with saturated saline, and anhydrous magnesium sulfate was added to the organic layer for drying. The obtained mixture was gravity-filtered, and the filtrate was concentrated to give an oily substance. The given oily substance was purified by silica gel column chromatography. Dichloromethane was used as a developing solvent. The obtained fraction was concentrated to give 3-ethyl-(2-methylphenyl)-5-phenyl-1H-1,2,4-triazole (abbreviation: HEptz1-mp) (a brown oily substance, 55% yield). The synthesis scheme of Step 2 is shown in (g-2) below.

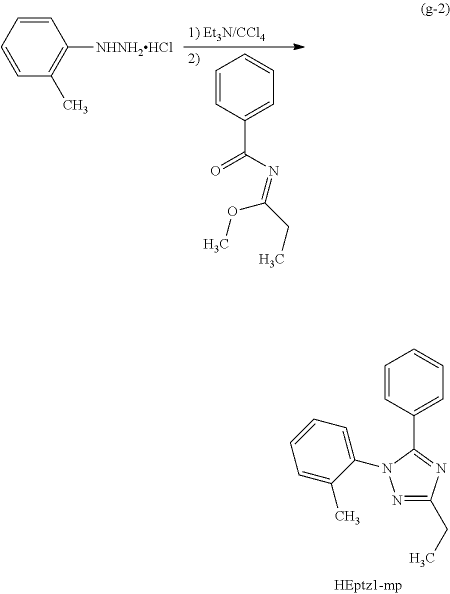

### Step 3: Synthesis of Tris[3-ethyl-1-(2-methylphenyl)-5-phenyl-1H-1,2,4-triazolato]iridium(III) (abbreviation: Ir(Eptz1-mp)₃)

Next, 2.0 g of the ligand HEptz1-mp (abbreviation) obtained in Step 2 above and 0.73 g of tris(acetylacetonato)iridium(III) were put into a reaction container provided with a three-way cock. The air in the reaction container was replaced with argon, and the mixture was heated at 250° C. for 39 hours to be reacted. The obtained reaction mixture was dissolved in dichloromethane and purified by, silica gel column chromatography. As the developing solvent, dichloromethane was first used, and a mixed solvent of dichloromethane and ethyl acetate in a ratio of 50:1 (v/v) was then used. The obtained fraction was concentrated to give a solid. This solid was washed with ethyl acetate and then with methanol. The obtained solid was recrystallized from a mixed solvent of dichloromethane and hexane to give [Ir(Eptz1-mp)₃] (abbreviation), the organometallic complex of one embodiment of the present invention (yellow powder, 35% yield). The synthesis scheme of Step 3 is shown in (g-3) below.

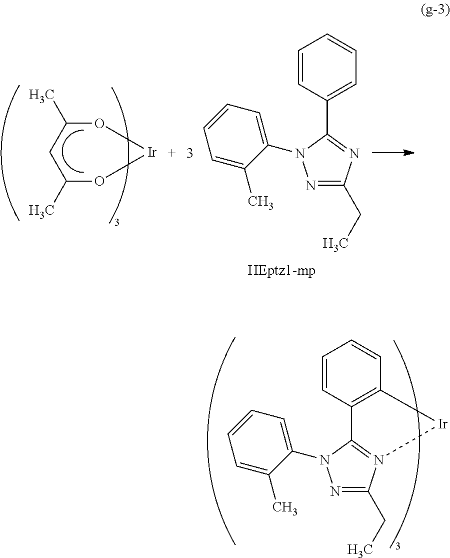

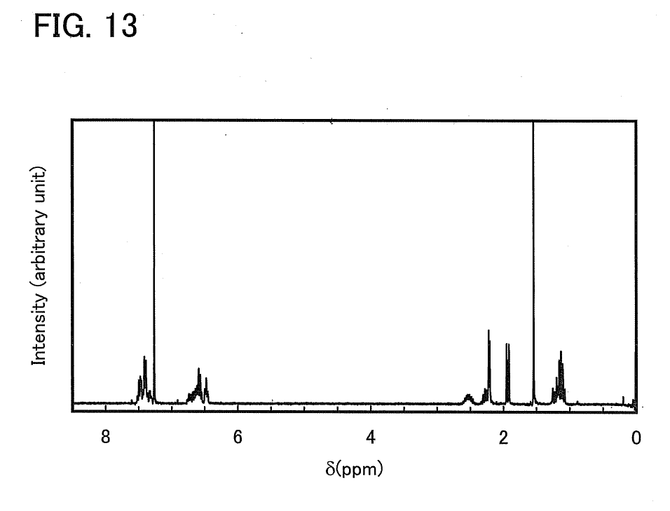

An analysis result by nuclear magnetic resonance spectrometry (¹H NMR) of the yellow powder obtained in Step 3 above is described below. The ¹H NMR chart is shown in FIG. 13. These results revealed that [Ir(Eptz1-mp)₃] (abbreviation), the organometallic complex represented by the structural formula (101) which is one embodiment of the present invention, was obtained in Synthetic Example 4.

¹H NMR data of the obtained substance are as follows:

¹H NMR. δ (CDCl₃): 1.08-1.25 (m, 9H), 1.91-2.61 (m, 15H), 6.45-6.73 (m, 3H), 6.55-6.74 (m, 9H), 7.32-7.52 (m, 12H).

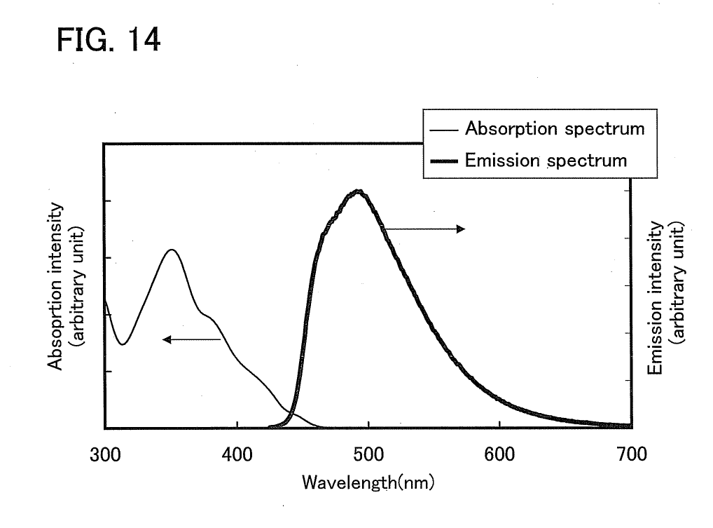

Next, an ultraviolet-visible absorption spectrum (hereinafter, simply referred to as an absorption spectrum) and an emission spectrum of [Ir(Eptz1-mp)₃] (abbreviation) in a dichloromethane solution were measured. The absorption spectrum was measured with the use of an ultraviolet-visible light spectrophotometer (V-550, manufactured by JASCO Corporation) in the state where a dichloromethane solution (0.085 mmol/L) was put in a quartz cell at room temperature. The emission spectrum was measured with the use of a fluorescence spectrophotometer (FS920, manufactured by Hamamatsu Photonics Corporation) in the state where the degassed dichloromethane solution (0.085 mmol/L) was put in a quartz cell at room temperature. FIG. 14 shows measurement results of the absorption spectrum and emission spectrum. The horizontal axis represents wavelength and the vertical axis represents absorption intensity and emission intensity. In FIG. 14, two solid lines are shown; a thin line represents the absorption spectrum, and a thick line represents the emission spectrum. Note that the absorption spectrum in FIG. 14 is a result obtained by subtraction of a measured absorption spectrum of only dichloromethane that was put in a quartz cell from the measured absorption spectrum of the dichloromethane solution (0.085 mmol/L) in a quartz cell.

As shown in FIG. 14, [Ir(Eptz1-mp)₃] (abbreviation), the organometallic complex of one embodiment of the present invention, has an emission peak at 492 nm, and light blue emission was observed from the dichloromethane solution.

### Example 5

### Synthetic Example 5

This example specifically illustrates a synthetic example of tris[1-(5-biphenyl)-3-methyl-5-phenyl-1H-1,2,4-triazolato]iridium(III) (abbreviation: [Ir(Mptz1-3b)₃]), the organometallic complex represented by the structural formula (112) in Embodiment 1 which is one embodiment of the present invention. A structure of [Ir(Mptz1-3b)₃] (abbreviation) is shown below.

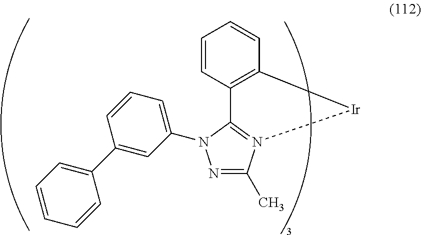

### Step 1: 1-(3-Bromophenyl)-3-methyl-5-phenyl-1H-1,2,4-triazole

First, 18 g of 3-bromophenyl hydrazine hydrochloride and 150 mL of carbon tetrachloride were put into a 300-mL three-neck flask, 9.8 g of triethylamine (Et₃N) was added dropwise to this mixture little by little, and the mixture was stirred at room temperature for 1 hour. After a predetermined time elapsed, 17 g of N-(1-ethoxyethylidene)benzamide obtained in Step 1 of Synthetic Example 1 was added to this mixture, and the mixture was stirred at room temperature for 24 hours. After the reaction, water was added to the reaction mixture, the aqueous layer was subjected to extraction with chloroform, and an organic layer was obtained. The obtained solution of the extract and the organic layer were washed together with saturated saline, and anhydrate magnesium sulfate was added to the organic layer for drying. The obtained mixture was gravity-filtered and the filtrate was concentrated to give an oily substance. The given oily substance was purified by silica gel column chromatography. As the developing solvent, dichloromethane and ethyl acetate in a ratio of 50:1 (v/v) was used. The obtained fraction was concentrated to give 1-(3-bromophenyl)-3-methyl-5-phenyl-1H-1,2,4-triazole (a yellow solid, 50% yield). The synthesis scheme of Step 1 is shown in (h-1) below.

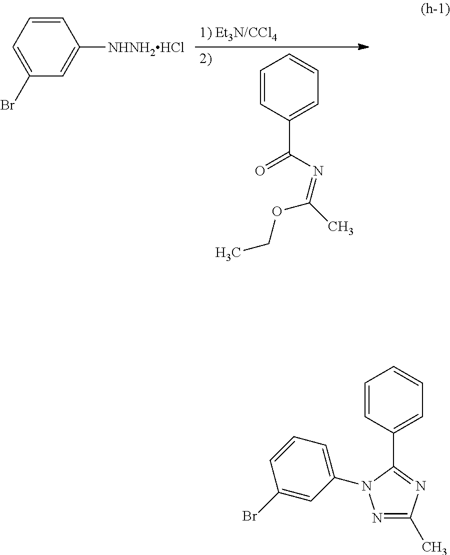

### Step 2: Synthesis of 1-(3-Biphenyl)-3-methyl-5-phenyl-1H-1,2,4-triazole (abbreviation: HMptz1-3b)

Next, 12 g of 1-(3-bromophenyl)-3-methyl-5-phenyl-1H-1,2,4-triazole obtained in Step 1 above, 5.3 g of phenylboronic acid, 0.36 g of tri(ortho-tolyl)phosphine, 100 mL of toluene, 12 mL of ethanol, and 43 mL of 2M aqueous solution of potassium carbonate were put into a 200-mL three-neck flask, and the air in the flask was replaced with nitrogen. To this mixture was added 0.088 g of palladium(II) acetate, and the mixture was heated and stirred at 80° C. for 13 hours. After the reaction, the aqueous layer of the obtained reaction solution was subjected to extraction with chloroform, and an organic layer was obtained. The solution of the extract and the organic layer were washed with a saturated aqueous solution of sodium hydrogen carbonate and then with saturated saline, and anhydrate magnesium sulfate was added to the organic layer for drying. The obtained mixture was gravity-filtered and the filtrate was concentrated to give an oily substance. This oily substance was purified by silica gel column chromatography. As the developing solvent, toluene and ethyl acetate in a ratio of 4:1 (v/v) was used. The obtained fraction was concentrated to give 1-(3-biphenyl)-3-methyl-5-phenyl-1H-1,2,4-triazole (abbreviation: HMptz1-3b) (a yellow brown oily substance, 94% yield). The synthesis scheme of Step 2 is shown in (h-2) below.

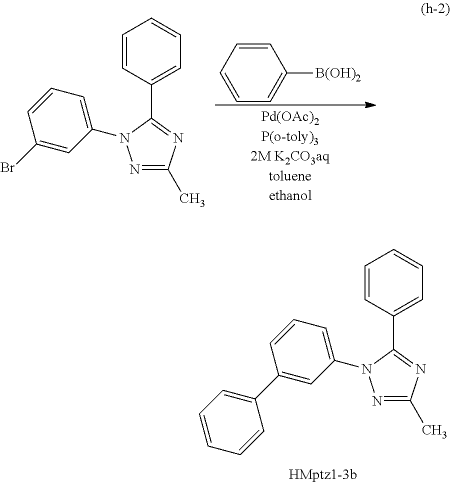

### Step 3: Synthesis of Tris[1-(5-biphenyl)-3-methyl-5-phenyl-1H-1,2,4-triazolato]iridium(III) (abbreviation: [Ir(Mptz1-3b)₃])

Next, 2.35 g of the ligand HMptz1-3b (abbreviation) obtained in Step 2 above and 0.739 g of tris(acetylacetonato)iridium(III) were put into a reaction container provided with a three-way cock, the air in the container was replaced with argon, and the mixture was heated and stirred at 250° C. for 43 hours. The resulting reaction mixture was dissolved in dichloromethane and purified by flash column chromatography. As the developing solvent, dichloromethane and ethyl acetate in a ratio of 20:1 (v/v) was used. The obtained fraction was concentrated to give a solid. This solid was washed with methanol, and the obtained residue was recrystallized from a mixed solvent of dichloromethane and methanol to give [Ir(Mptz1-3b)₃] (abbreviation), the organometallic complex of one embodiment of the present invention (yellow powder, 12% yield). The synthesis scheme of Step 3 is shown in (h-3) below.

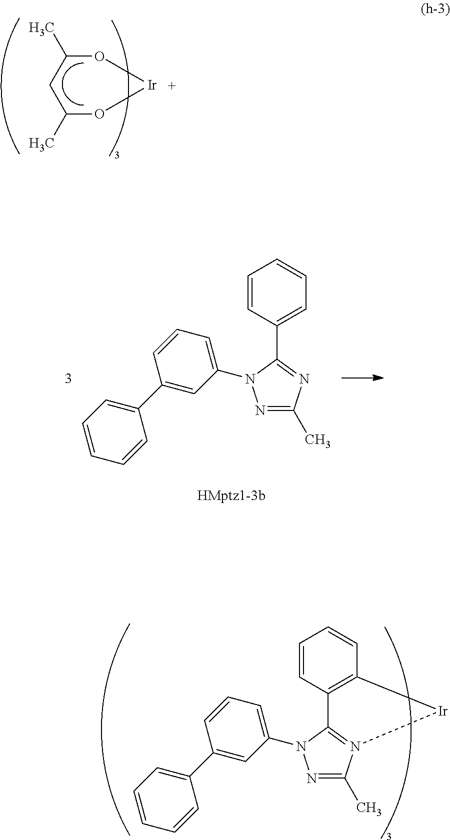

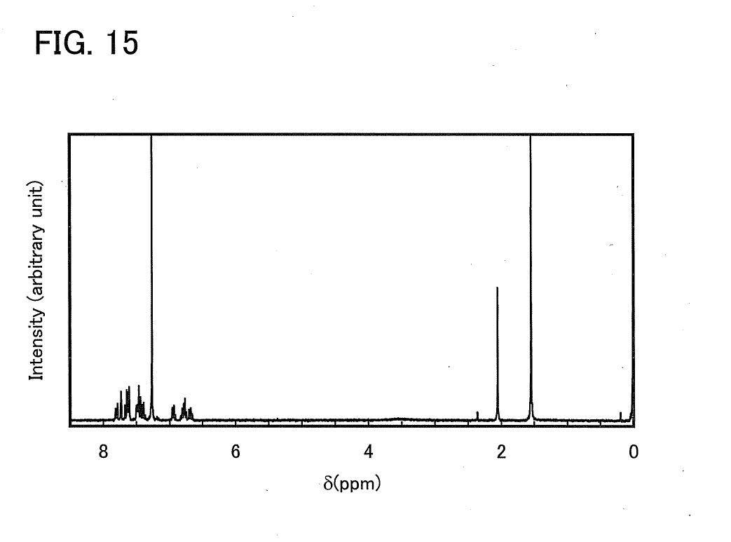

An analysis result by nuclear magnetic resonance spectrometry (¹H NMR) of the yellow powder obtained in Step 3 above is described below. The ¹H NMR chart is shown in FIG. 15. These results revealed that [Ir(Mptz1-3b)₃] (abbreviation), the organometallic complex represented by the structural formula (112) which is one embodiment of the present invention, was obtained in Synthetic Example 5.

¹H NMR data of the obtained substance are as follows:

¹H NMR. δ (CDCl₃): 2.06 (s, 9H), 6.67 (t, 3H), 6.74-6.83 (m, 6H), 6.94 (d, 3H), 7.36-7.50 (m, 12H), 7.61-7.67 (m, 9H), 7.73 (t, 3H), 7.80 (d, 3H).

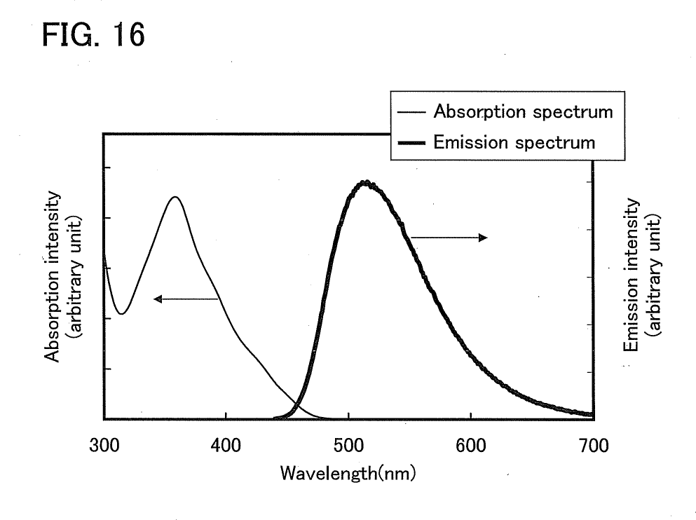

Next, an ultraviolet-visible absorption spectrum (hereinafter, simply referred to as an absorption spectrum) and an emission spectrum of [Ir(Mptz1-3b)₃] (abbreviation) in a dichloromethane solution were measured. The absorption spectrum was measured with the use of an ultraviolet-visible light spectrophotometer (V-550, manufactured by JASCO Corporation) in the state where a dichloromethane solution (0.080 mmol/L) was put in a quartz cell at room temperature. The emission spectrum was measured with the use of a fluorescence spectrophotometer (FS920, manufactured by Hamamatsu Photonics Corporation) in the state where the degassed dichloromethane solution (0.080 mmol/L) was put in a quartz cell at room temperature. FIG. 16 shows measurement results of the absorption spectrum and emission spectrum. The horizontal axis represents wavelength and the vertical axis represents absorption intensity and emission intensity. In FIG. 16, two solid lines are shown; a thin line represents the absorption spectrum, and a thick line represents the emission spectrum. Note that the absorption spectrum in FIG. 16 is a result obtained by subtraction of a measured absorption spectrum of only dichloromethane that was put in a quartz cell from the measured absorption spectrum of the dichloromethane solution (0.080 mmol/L) in a quartz cell.

As shown in FIG. 16, [Ir(Mptz1-3b)₃] (abbreviation), the organometallic complex of one embodiment of the present invention, has an emission peak at 516 nm, and blue green emission was observed from the dichloromethane solution.

### Example 6

### Synthetic Example 6

This example specifically illustrates a synthetic example of tris[1-(2-methylphenyl)-3-methyl-5-(2-naphthyl)-1H-1,2,4-triazolato]iridium(III) (abbreviation: [Ir(Mntz1-mp)₃]), the organometallic complex represented by the structural formula (128) in Embodiment 1 which is one embodiment of the present invention. A structure of [Ir(Mntz1-mp)₃] (abbreviation) is shown below.

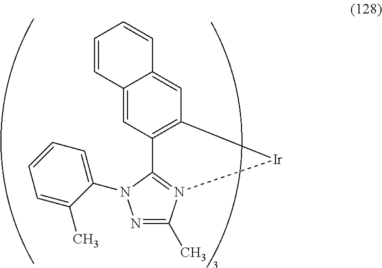

### Step 1: Synthesis of N-(1-Ethoxyethylidene)-2-naphthamide

First, 10 g of ethyl acetimidate hydrochloride, 150 mL of toluene, and 16 g of triethylamine (Et₃N) were put into a 300-mL three-neck flask and stirred at room temperature for 10 minutes. With a 50-mL dropping funnel, a mixed solution of 15 g of 2-naphthoyl chloride and 30 mL of toluene were added dropwise to this mixture, and the mixture was stirred at room temperature for 42 hours. After a predetermined time elapsed, the reaction mixture was suction-filtered and the filtrate was concentrated to give N-(1-ethoxyethylidene)-2-naphthamide (a yellow oily substance, 86% yield).

The synthesis scheme of Step 1 is shown in (j-1) below.

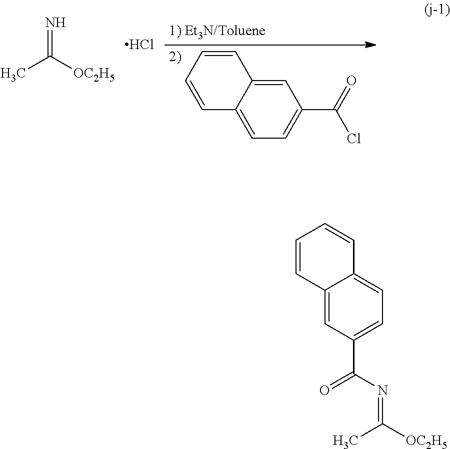

### Step 2: Synthesis of 1-(2-Methylphenyl)-3-methyl-5-(2-naphthyl)-1H-1,2,4-triazole (abbreviation: HMntz1-mp)

Next, 6.4 g of o-tolyl hydrazine hydrochloride and 15.0 mL of carbon tetrachloride were put into a 300-mL three-neck flask, a mixed solvent of 8.8 g of N-(1-ethoxyethylidene)-2-naphthamide obtained in Step 1 above and 20 mL of carbon tetrachloride were added dropwise to this mixture, and the mixture was stirred at room temperature for 20 hours. After the reaction, water was added to this reaction solution, the aqueous layer was subjected to extraction with chloroform, and an organic layer was obtained. The obtained solution of the extract and the organic layer were washed together with saturated saline, and anhydrate magnesium sulfate was added for drying. The obtained mixture was gravity-filtered and the filtrate was concentrated to give an oily substance. The given oily substance was purified by flash column chromatography. As the developing solvent, a mixed solvent of dichloromethane and hexane in a ratio of 1:1 (v/v) was used. The obtained fraction was concentrated to give an oily substance. This oily substance was further purified by silica gel column chromatography. Dichloromethane was used as a developing solvent. The obtained fraction was concentrated to give 1-(2-methylphenyl)-3-methyl-5-(2-naphthyl)-1H-1,2,4-triazole (abbreviation: HMntz1-mp) (a brown solid, 59% yield). The synthesis scheme of Step 2 is shown in (j-2) below.

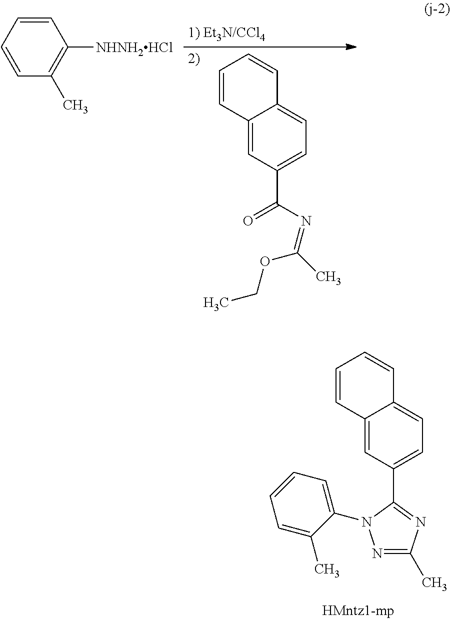

### Step 3: Synthesis of Tris[1-(2-methylphenyl)-3-methyl-5-(2-naphthyl)-1H-1,2,4-triazolato]iridium(III) (abbreviation: [Ir(Mntz1-mp)₃])

Next, 2.35 g of the ligand HMntz1-mp obtained in Step 2 above and 0.739 g of tris(acetylacetonato)iridium(III) were put in a reaction container provided with a three-way cock, the air in the container was replaced with argon and the mixture was heated and stirred at 250° C. for 57 hours. The resulting reaction mixture was dissolved in dichloromethane and purified by flash column chromatography. As the developing solvent, a mixed solvent of dichloromethane and ethyl acetate in a ratio of 20:1 (v/v) was used. The obtained fraction was concentrated to give a solid. This solid was washed with ethyl acetate, and the obtained residue was further purified by silica gel column chromatography. Dichloromethane was used as a developing solvent. The obtained fraction was concentrated to give a solid. This solid was recrystallized from a mixed solvent of dichloromethane and ethyl acetate to give [Ir(Mntz1-mp)₃] (abbreviation), the organometallic complex of one embodiment of the present invention (yellow powder, 8.3% yield). The synthesis scheme of Step 3 is shown in (j-3) below.

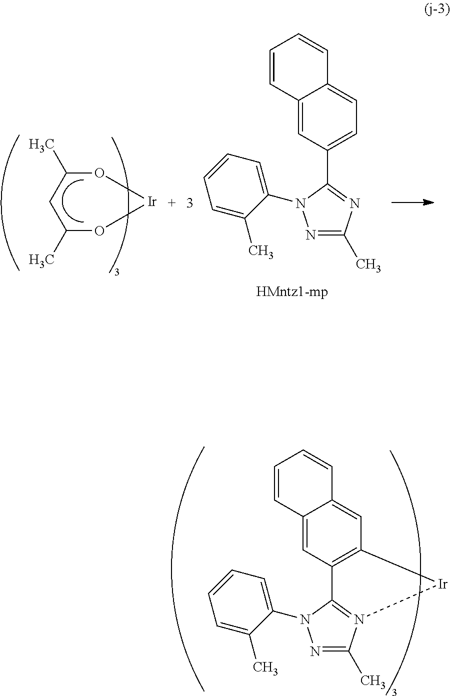

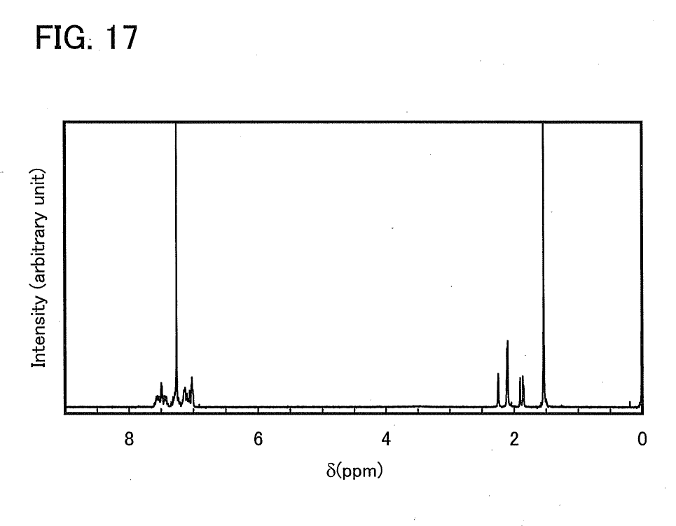

An analysis result by nuclear magnetic resonance spectrometry (¹H NMR) of the yellow powder obtained in Step 3 above is described below. The ¹H NMR chart is shown in FIG. 17. These results revealed that [Ir(Mntz1-mp)₃] (abbreviation), the organometallic complex represented by the structural formula (128) which is one embodiment of the present invention, was obtained in Synthetic Example 6.

¹H NMR data of the obtained substance are as follows:

¹H NMR. δ (CDCl₃): 1.84-2.25 (m, 18H), 7.01-7.18 (m, 15H), 7.21-7.32 (m, 3H), 7.42-7.61 (m, 12H).

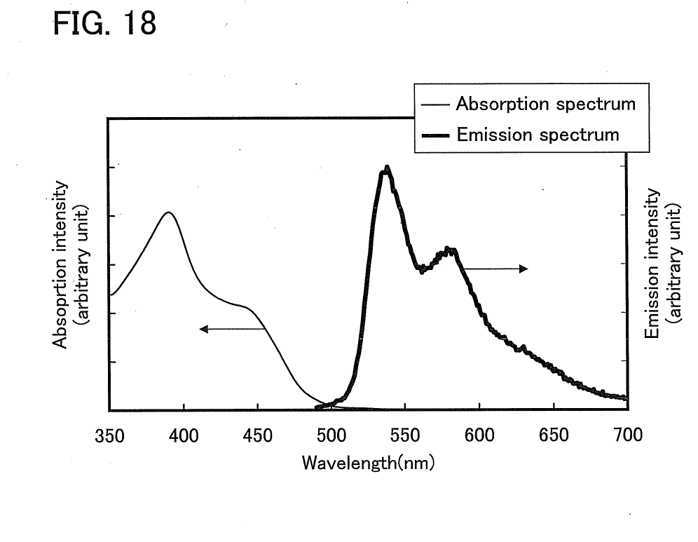

Next, an ultraviolet-visible absorption spectrum (hereinafter, simply referred to as an absorption spectrum) and an emission spectrum of [Ir(Mntz1-mp)₃] (abbreviation) in a dichloromethane solution were measured. The absorption spectrum was measured with the use of an ultraviolet-visible light spectrophotometer (V-550, manufactured by JASCO Corporation) in the state where a dichloromethane solution (0.095 mmol/L) was put in a quartz cell at room temperature. The emission spectrum was measured with the use of a fluorescence spectrophotometer (FS920, manufactured by Hamamatsu Photonics Corporation) in the state where the degassed dichloromethane solution (0.095 mmol/L) was put in a quartz cell at room temperature. FIG. 18 shows measurement results of the absorption spectrum and emission spectrum. The horizontal axis represents wavelength and the vertical axis represents absorption intensity and emission intensity. In FIG. 18, two solid lines are shown; a thin line represents the absorption spectrum, and a thick line represents the emission spectrum. Note that the absorption spectrum in FIG. 18 is a result obtained by subtraction of the absorption spectrum of only dichloromethane that was put in a quartz cell from the measured absorption spectrum of the dichloromethane solution (0.095 mmol/L) in a quartz cell.

As shown in FIG. 18, [Ir(Mntz1-mp)₃] (abbreviation), the organometallic complex of one embodiment of the present invention, has two emission peaks at 539 nm and around 584 nm, and yellow emission was observed from the dichloromethane solution.

### Example 7

In this example, a light-emitting element 1 in which [Ir(Mptz1-mp)₃] (abbreviation) synthesized in Example 1 is used as a light-emitting substance, a light-emitting element 2 in which [Ir(iPrptz1-mp)₃] (abbreviation) synthesized in Example 2 is used as a light-emitting substance, and a light-emitting element 3 in which [Ir(Prptz1-mp)₃] (abbreviation) synthesized in Example 3 is used as a light-emitting substance were evaluated. Chemical formulas of materials used in this example are shown below.

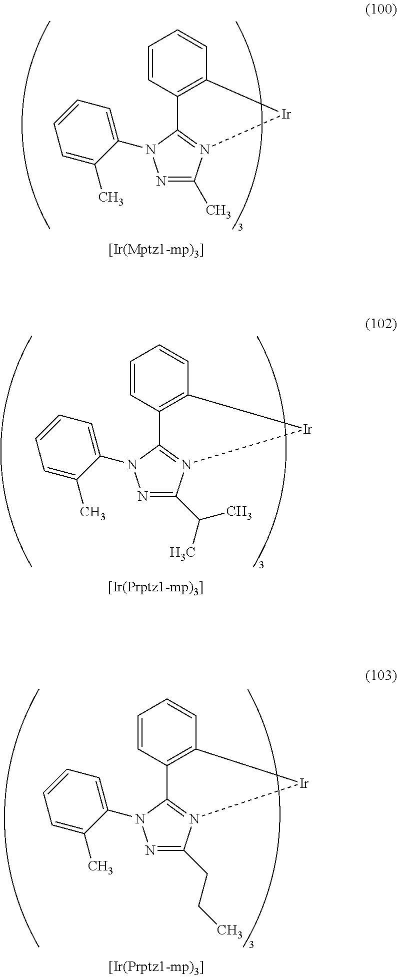

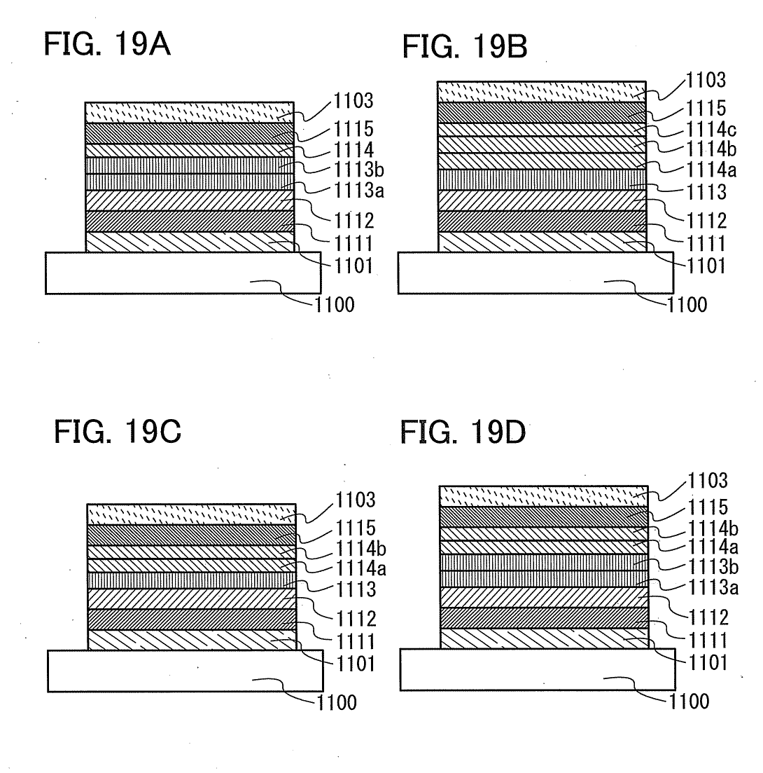

The light-emitting elements 1 to 3 are described with reference to FIG. 19A. A method for fabricating the light-emitting element 1 of this example is described below.

### (Light-Emitting Element 1)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to faun a hole-injection layer 1111 on the first electrode 1101. The thickness of the hole-injection layer 1111 was 60 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, mCP (abbreviation) and tris[3-methyl-1-(2-methylphenyl)-5-phenyl-1H-1,2,4-triazolato]iridium(III) (abbreviation: [Ir(Mptz1-mp)₃]) synthesized in Example 1 were co-evaporated to form a first light-emitting layer 1113a on the hole-transport layer 1112. Here, the weight ratio of mCP (abbreviation) to [Ir(Mptz1-mp)₃] (abbreviation) was adjusted to 1:0.08 (=mCP:[Ir(Mptz1-mp)₃]). The thickness of the first light-emitting layer 1113a was 30 nm.

Next, on the first light-emitting layer 1113a, 2-[3-(dibenzothiophen-4-yl)phenyl]-1-phenyl-1H-benzimidazole (abbreviation: mDBTBIm-II) and tris[3-methyl-1-(2-methylphenyl)-5-phenyl-1H-1,2,4-triazolato]iridium(III) (abbreviation: [Ir(Mptz1-mp)₃]) synthesized in Example 1 were co-evaporated to form a second light-emitting layer 1113b on the first light-emitting layer 1113a. Here, the weight ratio of mDBTBIm-II (abbreviation) to [Ir(Mptz1-mp)₃] (abbreviation) was adjusted to 1:0.08 (=mDBTBIm-II:[Ir(Mptz1-mp)₃]). The thickness of the second light-emitting layer 1113b was 10 nm.

After that, on the second light-emitting layer 1113b, a bathophenanthroline (abbreviation: BPhen) film was formed to a thickness of 15 nm, whereby an electron-transport layer 1114 was formed.

Further, on the electron-transport layer 1114, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 1 of this example was fabricated.

A method for fabricating the light-emitting element 2 of this example is described below.

### (Light-Emitting Element 2)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour; and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 60 nm, and the weight ratio of CBP (abbreviation) to molybdenum oxide was adjusted to 4:2 (=CBP:molybdenum oxide). Note that, the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, mCP (abbreviation) and tris[3-isopropyl-1-(2-methylphenyl)-5-phenyl-1H-1,2,4-triazolato]iridium(III) (abbreviation: [Ir(iPrptz1-mp)₃]) synthesized in Example 2 were co-evaporated to form a first light-emitting layer 1113a on the hole-transport layer 1112. Here, the weight ratio of mCP (abbreviation) to [Ir(iPrptz1-mp)₃] (abbreviation) was adjusted to 1:0.08 (=mCP:[Ir(iPrptz1-mp)₃]). The thickness of the first light-emitting layer 1113a was 30 nm.

Next, on the first light-emitting layer 1113a, 2-[3-(dibenzothiophen-4-yl)phenyl]-1-phenyl-1H-benzimidazole (abbreviation: mDBTBIm-II) and tris[3-isopropyl-1-(2-methylphenyl)-5-phenyl-1H-1,2,4-triazolato]iridium(III) (abbreviation: [Ir(iPrptz1-mp)₃]) synthesized in Example 2 were co-evaporated to form a second light-emitting layer 1113b on the first light-emitting layer 1113a. Here, the weight ratio of mDBTBIm-II (abbreviation) to [Ir(iPrptz1-mp)₃] (abbreviation) was adjusted to 1:0.08 (=mDBTBIm-II:[Ir(iPrptz1-mp)₃]). The thickness of the second light-emitting layer 1113b was 10 nm.

After that, on the second light-emitting layer 1113b, a bathophenanthroline (abbreviation: BPhen) film was formed to a thickness of 15 nm, whereby an electron-transport layer 1114 was formed.

Further, on the electron-transport layer 1114, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 2 of this example was fabricated.

A method for fabricating the light-emitting element 3 of this example is described below.

### (Light-Emitting Element 3)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10 Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to faun a hole-injection layer 1111 on the first electrode 1101. The thickness of the hole-injection layer 1111 was 60 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was foamed to a thickness of 20 nm, whereby a hole-transport layer 1112 was formed.

Further, mCP (abbreviation) and tris[1-(2-methylphenyl)-5-phenyl-3-propyl-1H-1,2,4-triazolato]iridium(III) (abbreviation: [Ir(Prptz1-mp)₃]) synthesized in Example 3 were co-evaporated to form a first light-emitting layer 1113a on the hole-transport layer 1112. Here, the weight ratio of mCP (abbreviation) to [Ir(Prptz1-mp)₃] (abbreviation) was adjusted to 1:0.08 (=mCP:[Ir(Prptz1-mp)₃]). The thickness of the first light-emitting layer 1113a was 30 nm.

Next, on the first light-emitting layer 1113a, 2-[3-(dibenzothiophen-4-yl)phenyl]-1-phenyl-1H-benzimidazole (abbreviation: mDBTBIm-II) and tris[1-(2-methylphenyl)-5-phenyl-3-propyl-1H-1,2,4-triazolato]iridium(III) (abbreviation: [Ir(Prptz1-mp)₃]) synthesized in Example 3 were co-evaporated to form a second light-emitting layer 1113b on the first light-emitting layer 1113a. Here, the weight ratio of mDBTBIm-II (abbreviation) to [Ir(Prptz1-mp)₃] (abbreviation) was adjusted to 1:0.08 (=mDBTBIm-II:[Ir(Prptz1-mp)₃]). The thickness of the second light-emitting layer 1113b was 10 nm.

After that, on the second light-emitting layer 1113b, a bathophenanthroline (abbreviation: BPhen) film was formed to a thickness of 15 nm, whereby an electron-transport layer 1114 was formed.

Further, on the electron-transport layer 1114, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 3 of this example was fabricated.

Note that in all of the above evaporation steps, a resistance heating method was employed for evaporation in fabrication of the light-emitting elements 1 to 3.

Table 1 shows element structures of the thus obtained light-emitting elements 1 to 3.

TABLE 1

| | | Hole- | Hole- | First Light- |
|---|---|---|---|---|
| | First | injection | transport | emitting |
| | Electrode | Layer | Layer | Layer |
| Light-emitting | ITSO | CBP:MoOx | mCP | mCP: |
| Element 1 | 110 nm | (=4:2) | 20 nm | [Ir(Mptz1-mp)₃] |
| | | 60 nm | | (=1:0.08) |
| | | | | 30 nm |
| Light-emitting | ITSO | CBP:MoOx | mCP | mCP: |
| Element 2 | 110 nm | (=4:2) | 20 nm | [Ir(iPrptz1-mp)₃] |
| | | 60 nm | | 30 nm |
| Light-emitting | ITSO | CBP:MoOx | mCP | mCP: |
| Element 3 | 110 nm | (=4:2) | 20 nm | [Ir(Prptz1-mp)₃] |
| | | 60 nm | | (=1:0.08) |
| | | | | 30 nm |

| | Second Light- | Electron- | Electron- |
|---|---|---|---|
| | emitting | transport | injection |
| | Layer | Layer | Layer |
| Light-emitting | mDBTBIm-II: | BPhen | LiF |
| Element 1 | [Ir(Mptz1-mp)₃] | 15 nm | 1 nm |
| | (=1:0.08) | | |
| | 10 nm | | |
| Light-emitting | mDBTBIm-II: | BPhen | LiF |
| Element 2 | [Ir(iPrptz1-mp)₃] | 15 nm | 1 nm |
| | (=1:0.08) | | |
| | 10 nm | | |
| Light-emitting | mDBTBIm-II: | BPhen | LiF |
| Element 3 | [Ir(Prptz1-mp)₃] | 15 nm | 1 nm |
| | (=1:0.08) | | |
| | 10 nm | | |

| | Second | |
|---|---|---|
| | Electrode | Note |
| Light-emitting | Al | Synthetic |
| Element 1 | 200 nm | Example 1 |
| Light-emitting | Al | Synthetic |
| Element 2 | 200 nm | Example 2 |
| Light-emitting | Al | Synthetic |
| Element 3 | 200 nm | Example 3 |

In a glove box containing a nitrogen atmosphere, the light-emitting elements 1 to 3 were sealed so as not to be exposed to the air. After that, operating characteristics of the light-emitting elements 1 to 3 were measured. Note that the measurements were carried out at room temperature (in an atmosphere kept at 25° C.).

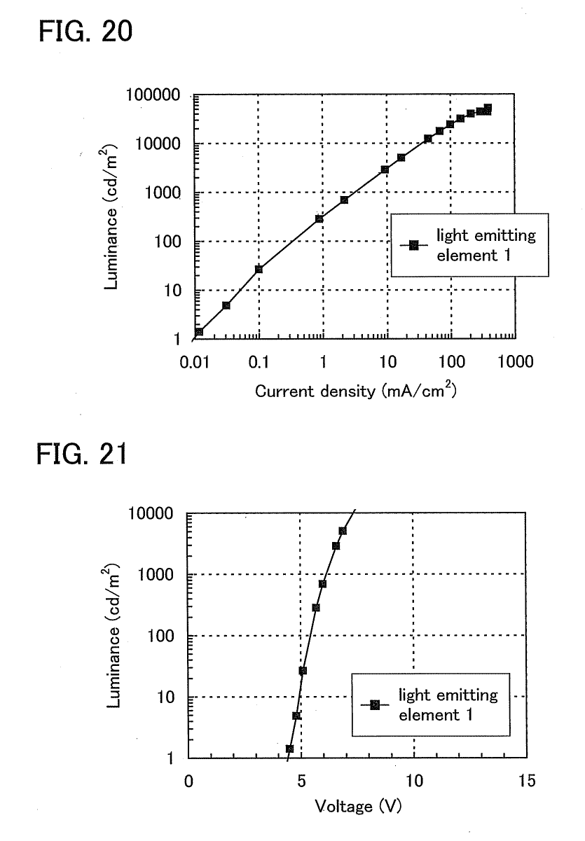

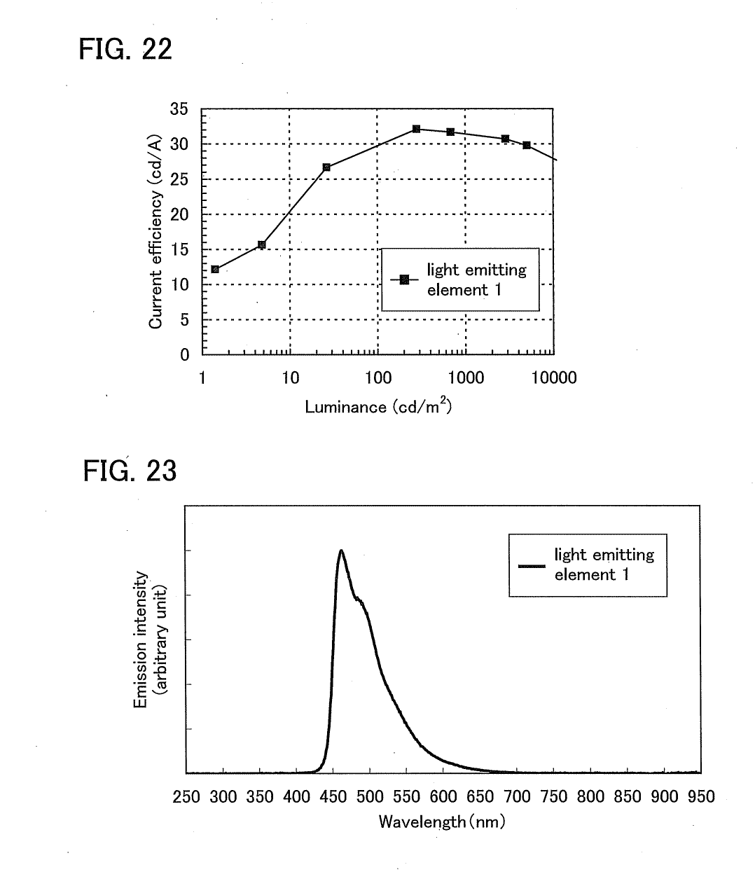

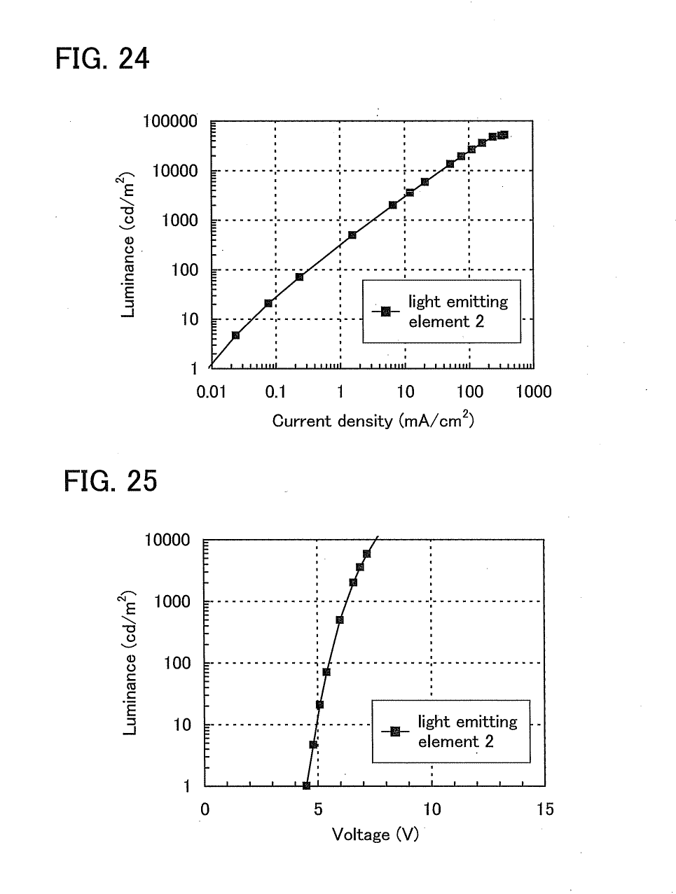

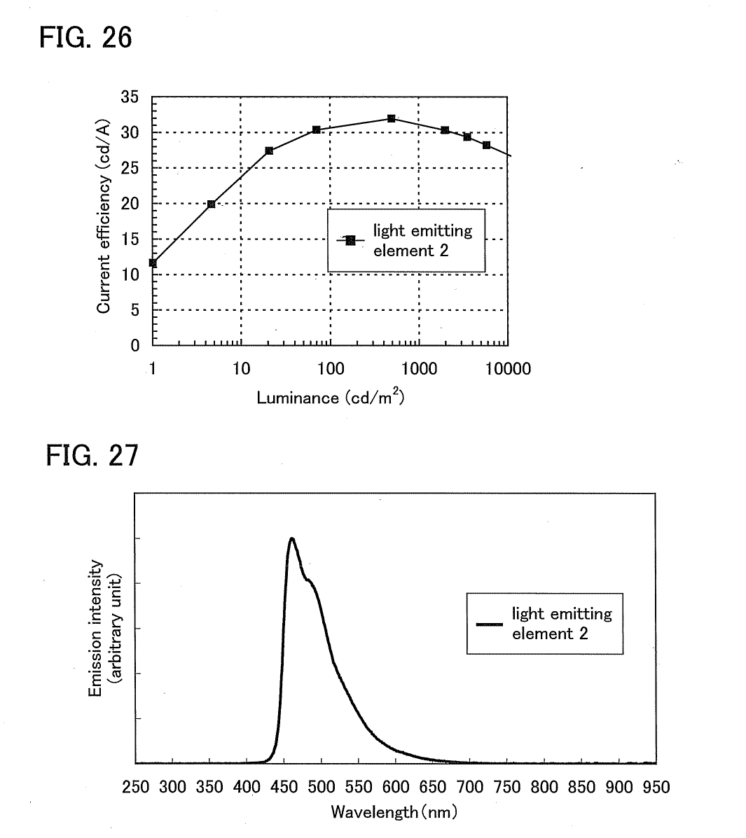

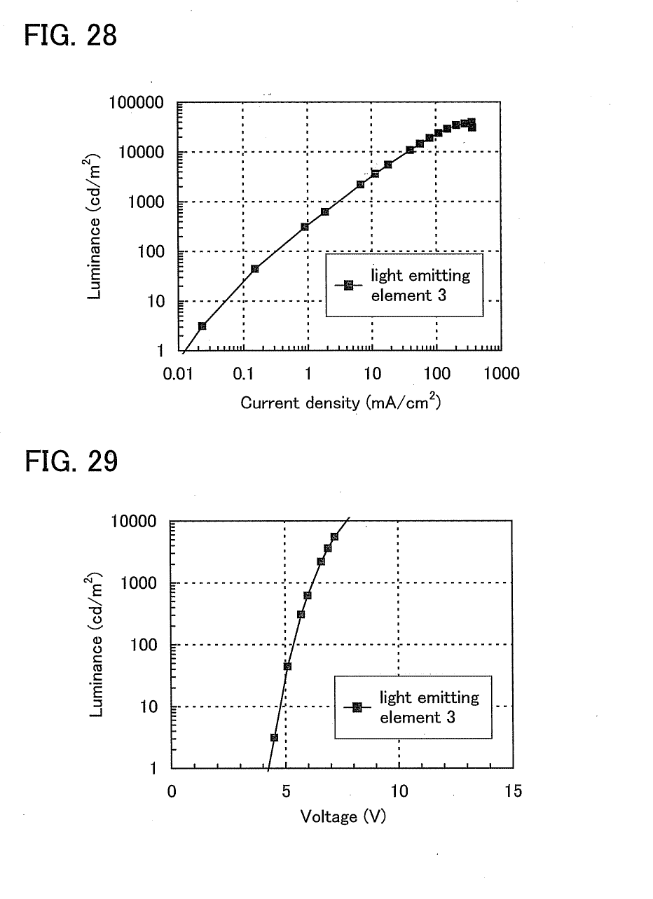

FIG. 20, FIG. 24, and FIG. 28 show current density versus luminance characteristics of the light-emitting element 1, the light-emitting element 2, and the light-emitting element 3, respectively. In each of FIG. 20, FIG. 24, and FIG. 28, the horizontal axis represents current density (mA/cm²) and the vertical axis represents luminance (cd/m²). In addition, FIG. 21, FIG. 25, and FIG. 29 show voltage versus luminance characteristics of the light-emitting element 1, the light-emitting element 2, and the light-emitting element 3, respectively. In each of FIG. 21, FIG. 25, and FIG. 29, the horizontal axis represents voltage (V) and the vertical axis represents luminance (cd/m²). Further, FIG. 22, FIG. 26, and FIG. 30 show luminance versus current efficiency characteristics of the light-emitting element 1, the light-emitting element 2, and the light-emitting element 3, respectively. In each of FIG. 22, FIG. 26, and FIG. 30, the horizontal axis represents luminance (cd/m²) and the vertical axis represents current efficiency (cd/A).

Further, Table 2 shows the voltage (V), current density (mA/cm²), CIE chromaticity coordinates (x, y), current efficiency (cd/A), and external quantum efficiency (%) of each of the light-emitting elements 1 to 3 at a luminance of 600 cd/m².

TABLE 2

| | | Current | | Current | External | |
|---|---|---|---|---|---|---|
| | Volt- | Density | Chro- | Effi- | Quantum | |
| | age | (mA/ | maticity | ciency | Efficiency | |
| | (V) | cm²) | x, y | (cd/A) | (°) | Note |
| Light- | 6.0 | 2.2 | 0.17, 0.27 | 31.7 | 17.8 | Synthetic |
| emitting | | | | | | Example 1 |
| Element 1 | | | | | | |
| Light- | 6.0 | 1.6 | 0.17, 0.26 | 31.9 | 18.3 | Synthetic |
| emitting | | | | | | Example 2 |
| Element 2 | | | | | | |
| Light- | 6.0 | 1.9 | 0.17, 0.27 | 33.1 | 18.5 | Synthetic |
| emitting | | | | | | Example 3 |
| Element 3 | | | | | | |

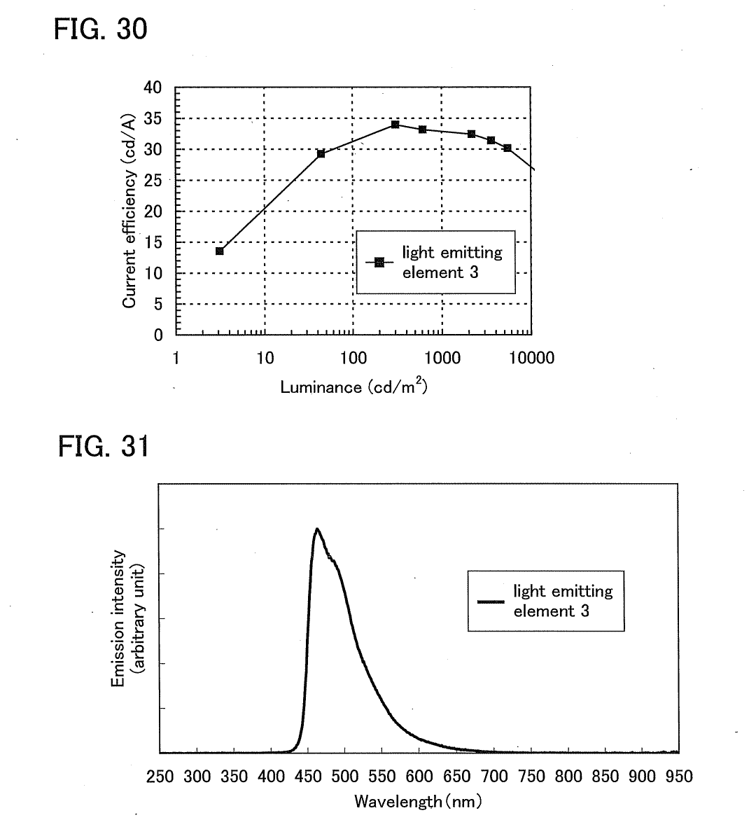

FIG. 23, FIG. 27, and FIG. 31 show emission spectra when a current was supplied at a current density of 2.5 mA/cm² to the light-emitting element 1, the light-emitting element 2, and the light-emitting element 3, respectively. As shown in FIG. 23, FIG. 27, and FIG. 31, the emission spectra of the light-emitting element 1, the light-emitting element 2, and the light-emitting element 3 have peaks at 463 nm, 462 nm, and 464 nm, respectively.

In addition, as shown in Table 2, the CIE chromaticity coordinates of the light-emitting element 1, the light-emitting element 2, and the light-emitting element 3 were (x, y)=(0.17, 0.27), (x, y)=(0.17, 0.26), and (x, y)=(0.17, 0.27), respectively, at a luminance of 600 cd/m².

As described above, it was found that the light-emitting elements 1 to 3 each using the organometallic complex of one embodiment of the present invention can efficiently emit light in a wavelength region of green to blue.

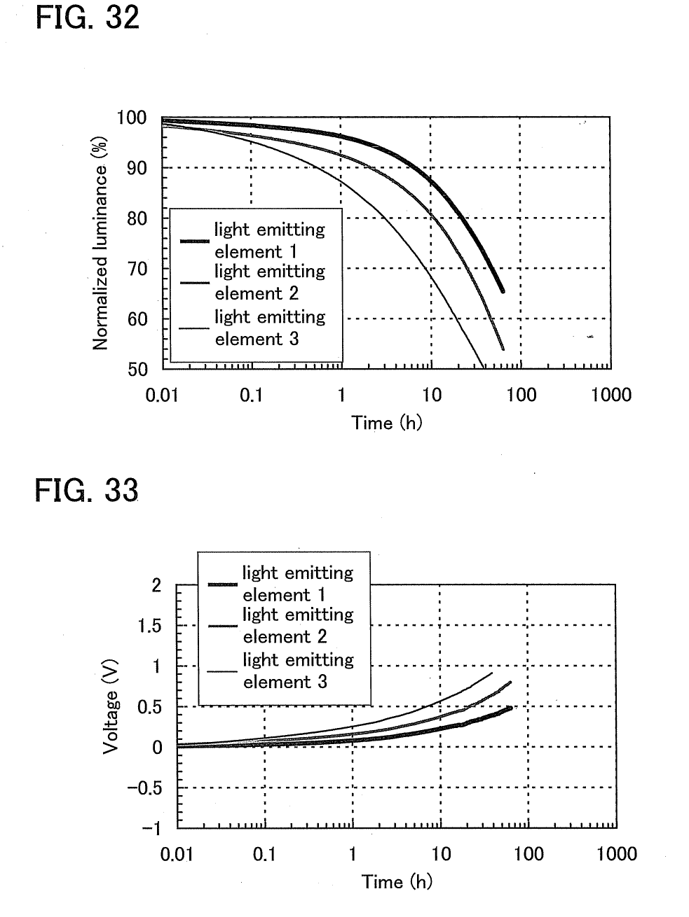

Next, reliability testing of the light-emitting elements 1 to 3 was carried out. Results of the reliability testing are shown in FIG. 32 and FIG. 33.

In FIG. 32, changes in luminance of the light-emitting elements 1 to 3 over time are shown, which were obtained by driving the light-emitting elements 1 to 3 under the conditions where each initial luminance was set to 300 cd/m² and each current density was constant. The horizontal axis represents driving time (h) of the elements, and the vertical axis represents normalized luminance (%) on the assumption that an initial luminance is 100%. From FIG. 32, it was found that normalized luminance values of the light-emitting element 1, the light-emitting element 2, and the light-emitting element 3 became 70% or lower after 47 hours, 25 hours, and 8 hours, respectively.

In FIG. 33, changes in voltage of the light-emitting elements 1 to 3 over time are shown, which were obtained by driving the light-emitting elements 1 to 3 under the conditions where each initial luminance was set to 300 cd/m² and each current density was constant. The horizontal axis represents driving time (h) of the elements, and the vertical axis represents voltage (V). From FIG. 33, it was found that the increase in voltage over time is the smallest in the light-emitting element 1, followed by the light-emitting element 2 and the light-emitting element 3. That is, substituents at the 3-positions of 1H-1,2,4-triazole rings are different among the light-emitting elements 1 to 3, and thus the reliability varies.

As shown above, the light-emitting elements 1 to 3 each using the organometallic complex which is one embodiment of the present invention can efficiently emit light in a wavelength region of green to blue. Note that in the case where the reliability is taken into consideration, the substituent at the 3-position of the 1H-1,2,4-triazole ring is preferably a methyl group or an isopropyl group, more preferably, a methyl group.

### Example 8

In this example, a light-emitting element 4 in which tris[1-(2-methylphenyl)-5-phenyl-3-propyl-1H-1,2,4-triazolato]iridium(III) (abbreviation: [Ir(Prptz1-mp)₃]) synthesized in Example 3 is used as a light-emitting substance, and for comparison with the present invention, a light-emitting element 5 in which tris[1-methyl-5-phenyl-3-propyl-1H-1,2,4-triazolato]iridium(III) (abbreviation: [Ir(Prptz1-Me)₃]) described in Non-Patent Document 1 is used as a light-emitting substance were evaluated. The chemical formula of the material for the light-emitting element 4 used in this example is the same as that in Example 7, and the description thereof can be referred to. The chemical formula of the material for the light-emitting element 5 used for comparison in this example is shown below.

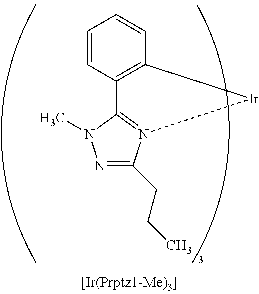

The light-emitting elements 4 and 5 are described with reference to FIG. 19B. A method for fabricating the light-emitting element 4 of this example is described below.

### (Light-Emitting Element 4)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 50 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 10 nm, whereby a hole-transport layer 1112 was formed.

Further, mCP (abbreviation) and tris[1-(2-methylphenyl)-5-phenyl-3-propyl-1H-1,2,4-triazolato]iridium(III) (abbreviation: [Ir(Prptz1-mp)₃]) synthesized in Example 3 were co-evaporated to form a light-emitting layer 1113 on the hole-transport layer 1112. Here, the weight ratio of mCP (abbreviation) to [Ir(Prptz1-mp)₃] (abbreviation) was adjusted to 1:0.08 (=mCP:[Ir(Prptz1-mp)₃]). The thickness of the light-emitting layer 1113 was 30 nm.

Next, on the light-emitting layer 1113, a film of 2-[3-(dibenzothiophen-4-yl)phenyl]-1-phenyl-1H-benzimidazole (abbreviation: mDBTBIm-II) was formed to a thickness of 10 nm to form a first electron-transport layer 1114a.

Further, on the first electron-transport layer 1114a, a film of tris(8-quinolinolato)aluminum(III) (abbreviation: Alq) was formed to a thickness of 10 nm to form a second electron-transport layer 1114b.

After that, on the second electron-transport layer 1114b, a bathophenanthroline (abbreviation: BPhen) film was formed to a thickness of 15 nm, whereby a third electron-transport layer 1114c was formed.

Further, on the third electron-transport layer 1114c, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 4 of this example was fabricated.

Next, a method for fabricating the light-emitting element 5 for comparison is described below.

### (Light-Emitting Element 5)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 50 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 10 nm, whereby a hole-transport layer 1112 was formed.

Further, mCP (abbreviation) and tris[1-methyl-5-phenyl-3-propyl-1H-1,2,4-triazolato]iridium(III) (abbreviation: [Ir(Prptz1-Me)₃]) were co-evaporated to form a light-emitting layer 1113 on the hole-transport layer 1112. Here, the weight ratio of mCP (abbreviation) to [Ir(Prptz1-Me)₃] (abbreviation) was adjusted to 1:0.08 (=mCP:[Ir(Prptz1-Me)₃]). The thickness of the light-emitting layer 1113 was 30 nm.

Next, on the light-emitting layer 1113, a film of 2-[3-(dibenzothiophen-4-yl)phenyl]-1-phenyl-1H-benzimidazole (abbreviation: mDBTBIm-II) was formed to a thickness of 10 nm to form a first electron-transport layer 1114a.

Further, on the first electron-transport layer 1114a, a film of tris(8-quinolinolato)aluminum(III) (abbreviation: Alq) was formed to a thickness of 10 nm to form a second electron-transport layer 1114b.

After that, on the second electron-transport layer 1114b, a bathophenanthroline (abbreviation: BPhen) film was formed to a thickness of 15 nm, whereby a third electron-transport layer 1114c was formed.

Further, on the third electron-transport layer 1114c, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 5 for comparison was fabricated.

Note that in all of the above evaporation steps, a resistance heating method was employed for evaporation in fabrication of both of the light-emitting elements 4 and 5.

The light-emitting elements 4 and 5 in this example are different from the light-emitting elements 1 to 3 described in Example 7 in structures such as thicknesses and the like of the hole-injection layer, the hole-transport layer, the first electron-transport layer, the second electron-transport layer, and the third electron-transport layer.

Table 3 shows element structures of the thus obtained light-emitting elements 4 and 5.

TABLE 3

| | | Hole- | Hole- | Light- |
|---|---|---|---|---|
| | First | injection | transport | emitting |
| | Electrode | Layer | Layer | Layer |
| Light-emitting | ITSO | CBP:MoOx | mCP | mCP: |
| Element 4 | 110 nm | (=4:2) | 10 nm | [Ir(Prptz1-mp)₃] |
| | | 50 nm | | (□ 1:0.08) |
| | | | | 30 nm |
| Light-emitting | ITSO | CBP:MoOx | mCP | mCP: |
| Element 5 | 110 nm | (=4:2) | 10 nm | [Ir(Prptz1-Me)₃] |
| | | 50 nm | | (□ 1:0.08) |
| | | | | 30 nm |

| | First Electron- | Second Electron- | Third Electron- |
|---|---|---|---|
| | transport | transport | transport |
| | Layer | Layer | Layer |
| Light-emitting | mDBTBIm-II | Alq | BPhen |
| Element 4 | 10 nm | 15 nm | 15 nm |
| Light-emitting | mDBTBIm-II | Alq | BPhen |
| Element 5 | 10 nm | 15 nm | 15 nm |

| | Electron- | | |
|---|---|---|---|
| | injection | Second | |
| | Layer | Electrode | Note |
| Light-emitting | LiF | Al | Synthetic |
| Element 4 | 1 nm | 200 nm | Example 3 |
| Light-emitting | LiF | Al | Comparative |
| Element 5 | 1 nm | 200 nm | Example |

In a glove box containing a nitrogen atmosphere, the light-emitting elements 4 and 5 were sealed so as not to be exposed to the air. After that, operating characteristics of the light-emitting elements 4 and 5 were measured. Note that the measurements were carried out at room temperature (in an atmosphere kept at 25° C.).

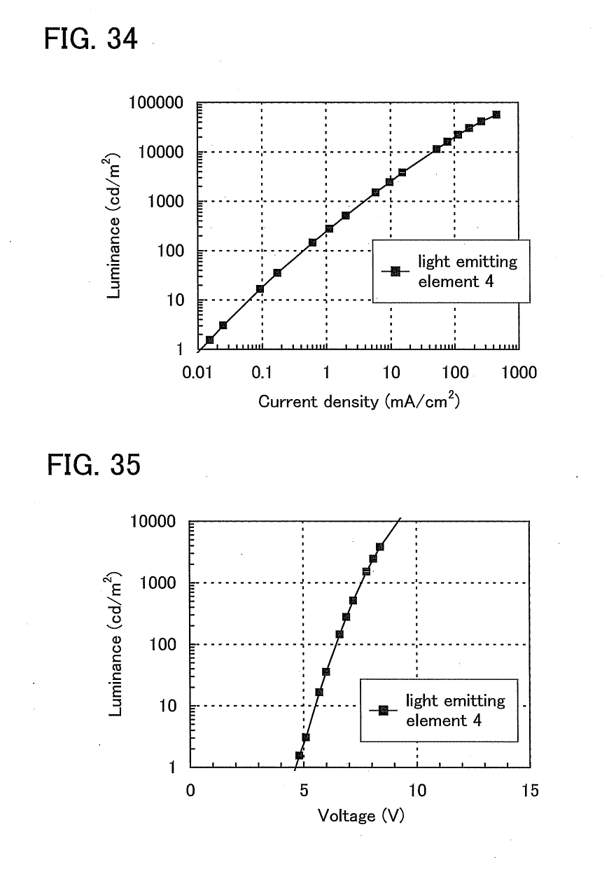

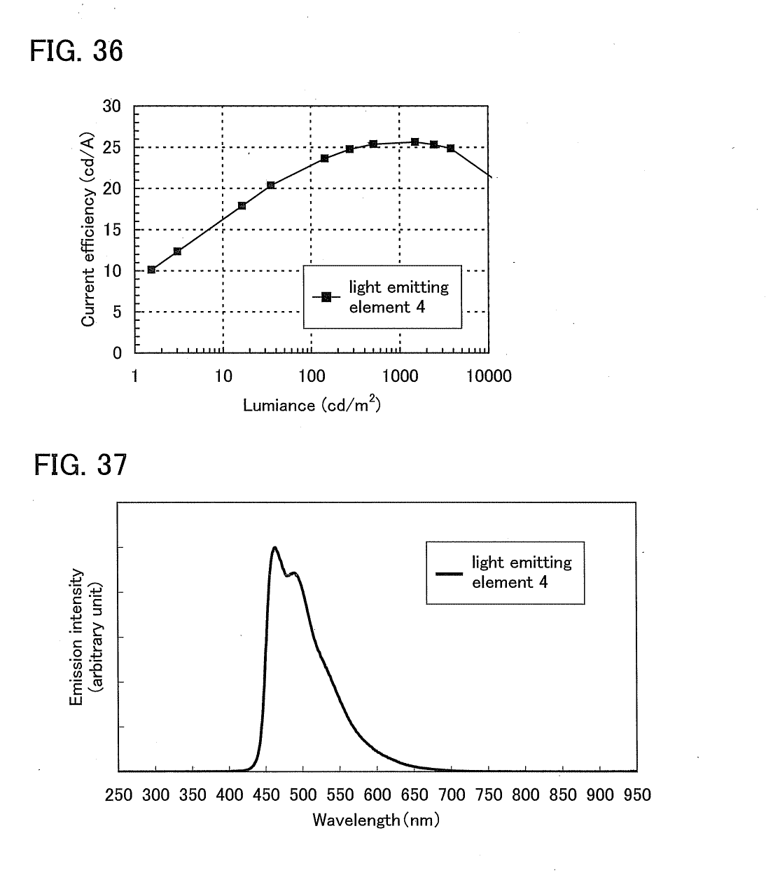

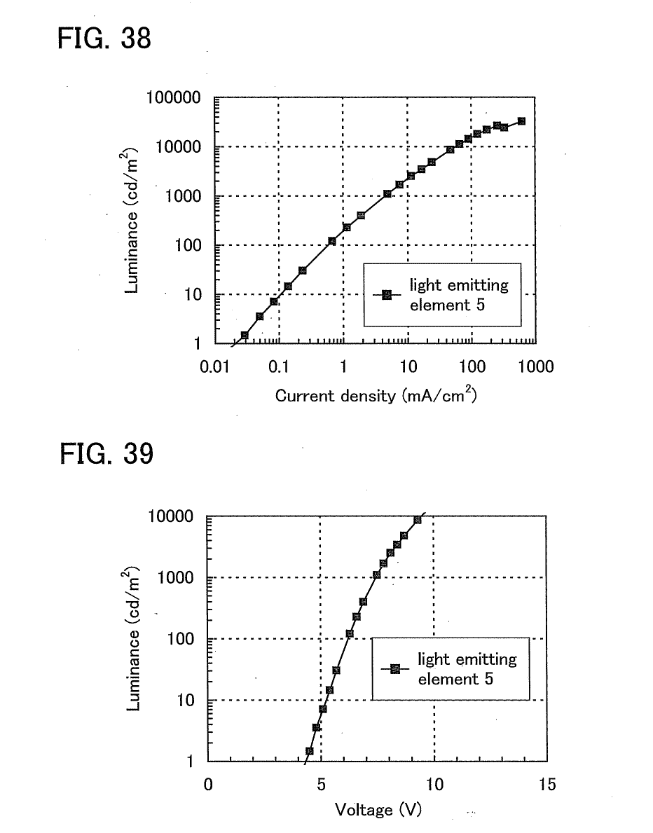

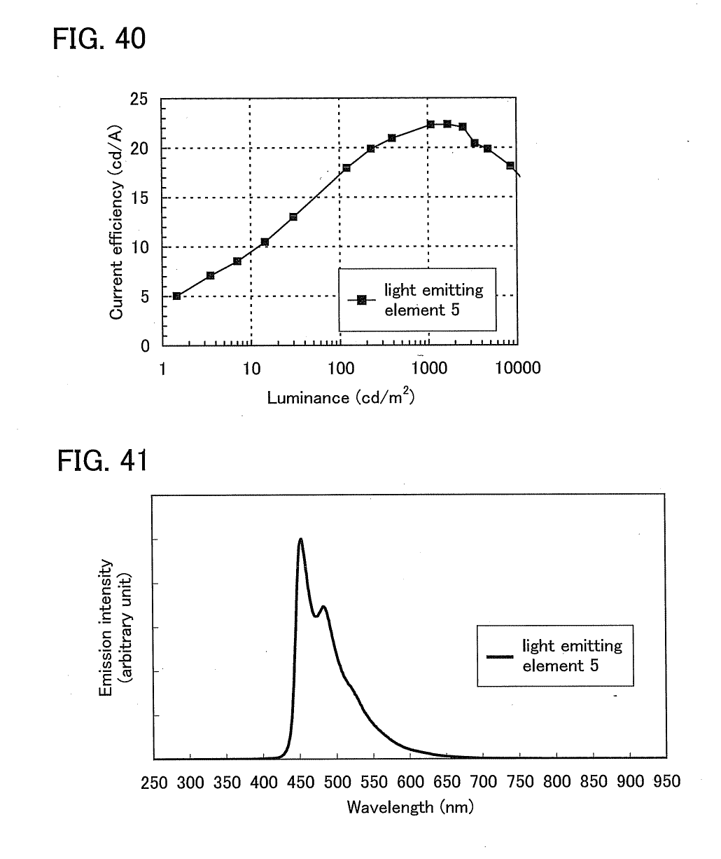

FIG. 34 and FIG. 38 show current density versus luminance characteristics of the light-emitting element 4 and the light-emitting element 5, respectively. In each of FIG. 34 and FIG. 38, the horizontal axis represents current density (mA/cm²) and the vertical axis represents luminance (cd/m²). In addition, FIG. 35 and FIG. 39 show voltage versus luminance characteristics of the light-emitting element 4 and the light-emitting element 5, respectively. In each of FIG. 35 and FIG. 39, the horizontal axis represents voltage (V) and the vertical axis represents luminance (cd/m²). Further, FIG. 36 and FIG. 40 show luminance versus current efficiency characteristics of the light-emitting element 4 and the light-emitting element 5, respectively. In each of FIG. 36 and FIG. 40, the horizontal axis represents luminance (cd/m²) and the vertical axis represents current efficiency (cd/A).

Further, Table 4 shows the voltage (V), current density (mA/cm²), CIE chromaticity coordinates (x, y), current efficiency (cd/A), and external quantum efficiency (%) of each of the light-emitting elements 4 and 5 at a luminance of 1500 cd/m².

TABLE 4

| | | Current | | Current | External | |
|---|---|---|---|---|---|---|
| | Volt- | Density | Chro- | Effi- | Quantum | |
| | age | (mA/ | maticity | ciency | Efficiency | |
| | (V) | cm²) | x, y | (cd/A) | (⋄) | Note |
| Light- | 7.8 | 5.9 | 0.19, | 25.6 | 13 | Synthetic |
| emitting | | | 0.30 | | | Example 3 |
| Element 4 | | | | | | of the |
| | | | | | | Present |
| Light- | 7.8 | 7.6 | 0.17, | 22.3 | 14.6 | Comparative |
| emitting | | | 0.21 | | | Example |
| Element 5 | | | | | | |

FIG. 37 and FIG. 41 show emission spectra when a current was supplied at a current density of 2.5 mA/cm² to the light-emitting element 4 and the light-emitting element 5, respectively. As shown in FIG. 37 and FIG. 41, the emission spectrum of the light-emitting element 4 has a peak at 464 nm, and the emission spectrum of the light-emitting element 5 has a peak at 453 nm.

In addition, as shown in Table 4, the CIE chromaticity coordinates of the light-emitting element 4 and the light-emitting element 5 of the comparative example were (x, y)=(0.19, 0.30) and (x, y)=(0.17, 0.21), respectively, at a luminance of 1500 cd/m².

As described above, the light-emitting element 4 was found to provide light emission from [Ir(Prptz1-mp)₃] (abbreviation). It was found that the light-emitting element using the organometallic complex of one embodiment of the present invention can efficiently emit light in a wavelength region of green to blue.

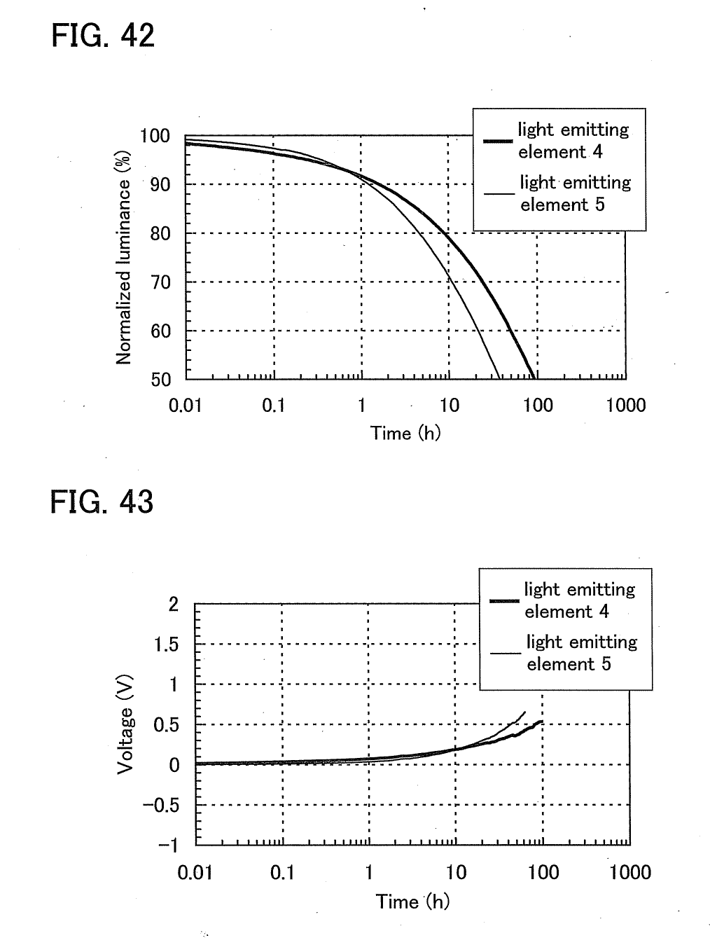

Next, reliability testing of the light-emitting elements 4 and 5 was carried out. Results of the reliability testing are shown in FIG. 42 and FIG. 43.

In FIG. 42, changes in luminance of the light-emitting elements 4 and 5 over time are shown, which were obtained by driving the light-emitting elements 4 and 5 under the conditions where each initial luminance was set to 300 cd/m² and each current density was constant. The horizontal axis represents driving time (h) of the elements, and the vertical axis represents normalized luminance (%) on the assumption that an initial luminance is 100%. From FIG. 42, it was found that normalized luminance values of the light-emitting element 4 and the light-emitting element 5 became 70% or lower after 24 hours and 11 hours, respectively. Therefore, it was turned out that the light-emitting element 4 of one embodiment of the present invention has higher reliability than the light-emitting element 5 of the comparative example.

In FIG. 43, changes in voltage of the light-emitting elements 4 and 5 over time are shown, which were obtained by driving the light-emitting elements 1 to 3 under the conditions where each initial luminance was set to 300 cd/m² and each current density was constant. The horizontal axis represents driving time (h) of the elements, and the vertical axis represents voltage (V). From FIG. 43, it was found that the increase in voltage over time is smaller in the light-emitting element 4 of one embodiment of the present invention than in the light-emitting element 5 of the comparative example. Accordingly, it was found that the light-emitting element 4 using the light-emitting substance of one embodiment of the present invention has long lifetime and high reliability.

As shown above, by using a light-emitting element in which tris[1-(2-methylphenyl)-5-phenyl-3-propyl-1H-1,2,4-triazolato]iridium(III) (abbreviation: [Ir(Prptz1-mp)₃]), which is one embodiment of the present invention, is used as a light-emitting substance, a light-emitting element that can emit light in a wavelength region of green to blue with favorable chromaticity and high emission efficiency and has high reliability can be provided. The organometallic complexes of embodiments of the present invention described in Examples 1 to 6, which include a substituted phenyl group at the 1-position of a 1H-1,2,4-triazole ring, did not cause a composition reaction in a reaction for synthesizing a ligand and tris(acetylacetonato)iridium(III) in an argon atmosphere at 250° C. However, it was confirmed by mass spectrometry that as for [Ir(Prptz1-Me)₃] (abbreviation), which is the comparative example, when a reaction for synthesizing a ligand and tris(acetylacetonato)iridium(III) was performed in an argon atmosphere at 250° C., a reaction of generating a complex proceeded in which a methyl group that was substituted at the 1-position of a 1H-1,2,4-triazole ring was decomposed. That is, it can be said that the organometallic complex of one embodiment of the present invention has a higher thermal property than [Ir(Prptz1-Me)₃] (abbreviation).

In addition, as described in this comparative example, a light-emitting element in which [Ir(Prptz1-Me)₃] (abbreviation) is used as a light-emitting substance has lower reliability than a light-emitting element in which tris[1-(2-methylphenyl)-5-phenyl-3-propyl-1H-1,2,4-triazolato]iridium(III) (abbreviation: [Ir(Prptz1-mp)₃]), which is one embodiment of the present invention, is used as a light-emitting substance. As shown above, it was turned out that in the case where a substituted phenyl group is not included at the 1-position of a 1H-1,2,4-triazole ring, the reliability is lower than that of a light-emitting element in which the organometallic complex of one embodiment of the present invention described in Examples 1 to 6, which includes a substituted phenyl group at the 1-position of a 1H-1,2,4-triazole ring, is used as a light-emitting substance. This is because by including a substituted phenyl group at the 1-position of a 1H-1,2,4-triazole ring, the thermal property is improved and the stability to evaporation is increased. That is, the organometallic complex of one embodiment of the present invention is excellent in thermal property, and thus the reliability of the element is improved as compared to [Ir(Prptz1-Me)₃] (abbreviation).

Next, for comparison with the light-emitting substance of one embodiment of the present invention, light-emitting substances of Comparative Examples 1 and 2 were synthesized and evaluated. Specific description thereof is given below.

### Comparative Example 1

This comparative example illustrates a method for synthesizing tris[1-(2-methylphenyl)-5-phenyl-1H-1,2,4-triazolato]iridium(III) (abbreviation: [Ir(ptz1-mp)₃]) in which hydrogen is bonded to the 3-position of a 1H-1,2,4-triazole ring, which is described in Patent Document 2 and Patent Document 3. A structure of [Ir(ptz1-mp)₃] (abbreviation) is shown below.

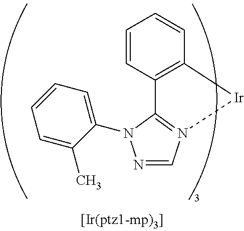

### Step 1: Synthesis of N-[(Dimethylamino)methylidene]benzamide

First, 20.4 g of benzamide, 25 mL of N,N-dimethylformamide dimethyl acetal, and 85 mL of dioxane were put into a 200-mL three-neck flask provided with a cold tube at an end of a Dean-Stark apparatus, and heated and stirred at 110° C. for 2.5 hours. The obtained reaction solution was concentrated under a reduced pressure to give an oily substance. This oily substance was allowed to stand, so that a solid was precipitated. This solid was washed with hexane to give N-[(dimethylamino)methylidene]benzamide (a white solid, 95% yield). The synthesis scheme of Step 1 is shown in (d-1) below.

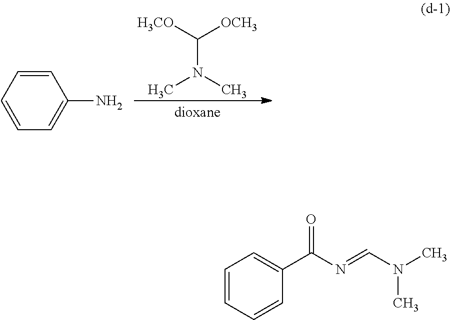

### Step 2: Synthesis of 1-(2-Methylphenyl)-5-phenyl-1H-1,2,4-triazole (abbreviation: Hptz1-mp)

Next, 10.8 g of o-tolyl hydrazine hydrochloride and 50 mL of dioxane were put into a 500-mL three-neck flask, 14 mL of an aqueous solution of sodium hydroxide (5 mol/L) was added dropwise to this mixture, and the mixture was stirred at room temperature for 15 minutes. After a predetermined time elapsed, 100 mL of 70% acetic acid aqueous solution and 10.0 g of N-[(dimethylamino)methylidene]benzamide obtained in Step 1 above were added to this mixture, and the mixture was heated and stirred at 90° C. for 2.5 hours. The obtained reaction solution was poured into 200 mL of water and the mixture was stirred at room temperature to precipitate a solid. This mixture was suction-filtered and the solid was washed with water. The obtained solid was recrystallized from a mixed solvent of ethanol and hexane, so that 1-(2-methylphenyl)-5-phenyl-1H-1,2,4-triazole (abbreviation: Hptz1-mp) was obtained (a white solid, 57% yield). The synthesis scheme of Step 2 is shown in (d-2) below.

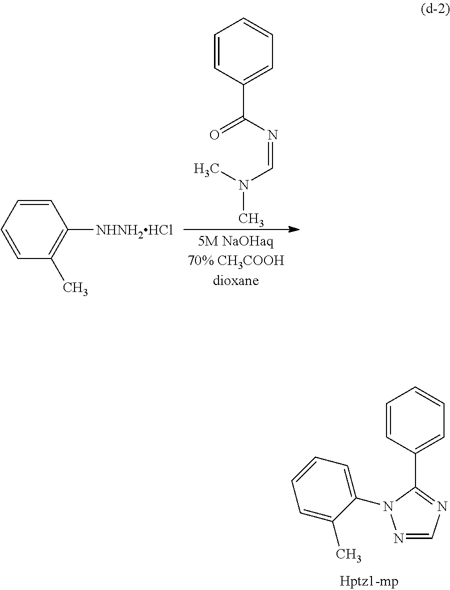

### Step 3: Synthesis of Tris[1-(2-methylphenyl)-5-phenyl-1H-1,2,4-triazolato]iridium(III) (abbreviation: [Ir(ptz1-mp)₃])

Next, 2.0 g of the ligand Hptz1-mp (abbreviation) obtained in Step 2 above and 0.835 g of tris(acetylacetonato)iridium(III) were put in a reaction container provided with a three-way cock. The air in the reaction container was replaced with argon, and the reaction container was heated at 250° C. for 11 hours; then, it was confirmed that a spot of the ligand Hptz1-mp (abbreviation) disappeared by thin layer chromatography (TLC) of this reaction mixture. However, a peak of a molecular ion of an iridium complex that is the objective substance was not observed from the mass spectrum of the reaction mixture. Thus, the ligand Hptz1-mp was decomposed and the objective substance was not generated. The synthesis scheme of Step 3 is shown in (d-3) below.

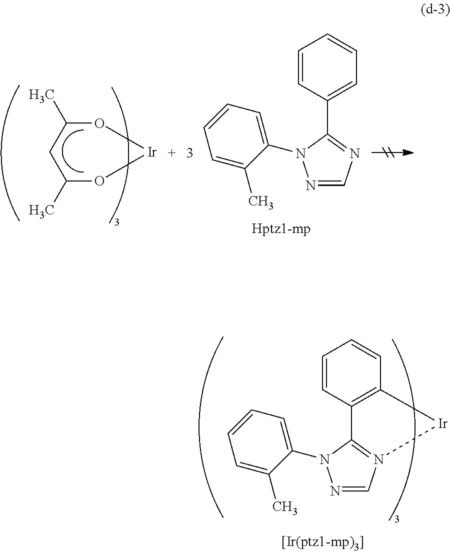

As described in this comparative example, the synthesis of [Ir(ptz1-mp)₃] (abbreviation) was difficult. In this manner, it was turned out that the organometallic complex in which hydrogen is bonded to the 3-position of a 1H-1,2,4-triazole ring is synthesized with extremely low yield or cannot be synthesized unlike the organometallic complex of one embodiment of the present invention described in Examples 1 to 6, which includes a substituent at the 3-position of a 1H-1,2,4-triazole ring. This is because, as described above, the ligand Hptz1-mp (abbreviation) is decomposed. That is, the decomposition reaction can be suppressed in the synthesis reaction of the organometallic complex which is one embodiment of the present invention; therefore, the yield of the synthesis is drastically improved as compared with [Ir(ptz1-mp)₃] (abbreviation).

### Comparative Example 2

This comparative example illustrates a method for synthesizing tris[1,5-d]phenyl-3-propyl-1H-1,2,4-triazolato]iridium(III) (abbreviation: [Ir(Prptz1-Ph)₃]) which does not have a substituent in a phenyl group at the 1-position of a 1H-1,2,4-triazole ring. A structure of [Ir(Prptz1-Ph)₃] (abbreviation) is shown below.

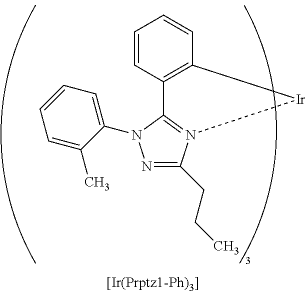

### Step 1: Synthesis of N-(1-Ethoxybutylidene)benzamide

First, 10.0 g of ethyl butyrimidate hydrochloride, 120 mL of toluene, and 20.0 g of triethylamine (Et₃N) were put into a 500-mL three-neck flask and stirred at room temperature for 10 minutes. With a 50 mL dropping funnel, a mixed solution of 9.26 g of benzoyl chloride and 30 mL of toluene was added dropwise to this mixture, and the mixture was stirred at room temperature for 15 hours. After a predetermined time elapsed, the reaction mixture was suction-filtered and the filtrate was concentrated to give N-(1-ethoxybutylidene)benzamide (a pale yellow oily substance, 93% rough yield). The synthesis scheme of Step 1 is shown in (e-1) below.

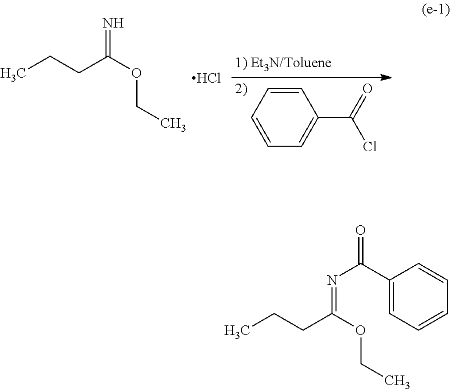

### Step 2: Synthesis of 1,5-Diphenyl-3-propyl-1H-1,2,4-triazole (abbreviation: HPrptz1-Ph)

Next, 5.00 g of phenylhydrazine and 80 mL of carbon tetrachloride were put into a 200-mL three-neck flask, a mixed solvent of 10.1 g of N-(1-ethoxybutylidene)benzamide obtained in Step 1 above and 30 mL of carbon tetrachloride was added dropwise to this mixture, and the mixture was stirred at room temperature for 17 hours. After a predetermined time elapsed, water was added to this reaction solution, the aqueous layer was subjected to extraction with chloroform, and an organic layer was obtained. The obtained solution of the extract and the organic layer were washed together with saturated saline, and anhydrate magnesium sulfate was added to the organic layer for drying. The obtained mixture was gravity-filtered and the filtrate was concentrated to give an oily substance. This oily substance was purified by silica gel column chromatography. As the developing solvent, dichloromethane was first used, and a mixed solvent of dichloromethane and ethyl acetate in a ratio of 1:1 (v/v) was then used. The resulting fraction was concentrated, so that 1,5-diphenyl-3-propyl-1H-1,2,4-triazole (abbreviation: HPrptz1-Ph) was obtained (a red oily substance, 67% yield). The synthesis scheme of Step 2 is shown in (e-2) below.

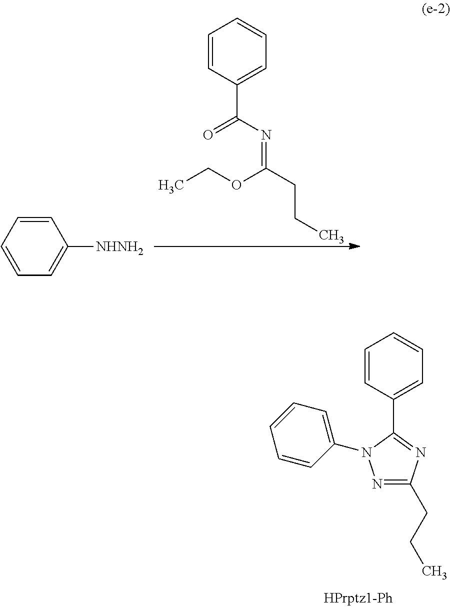

### Step 3: Synthesis of Tris[1,5-d]phenyl-3-propyl-1H-1,2,4-triazolato]iridium(III) (abbreviation: [Ir(Prptz1-Ph)₃]

Next, 2.00 g of the ligand HPrptz1-Ph (abbreviation) obtained in Step 2 above and 0.743 g of tris(acetylacetonato)iridium(III) were put in a reaction container provided with a three-way cock. The air in this reaction container was replaced with argon, and the mixture was heated at 250° C. for 21 hours to be reacted. This reaction mixture was dissolved in dichloromethane and purified by silica gel column chromatography. As the developing solvent, a mixed solvent of dichloromethane and ethyl acetate in a ratio of 20:1 (v/v) was used. The obtained fraction was concentrated to give a solid, and the solid was further purified by silica gel column chromatography. Dichloromethane was used as a developing solvent. As a result of the purification, three fractions were obtained in each of which a mass spectrum of an objective iridium complex is observed. The three fractions were each further concentrated to give a minute amount of solid. The synthesis scheme of Step 3 is shown in (e-3) below.

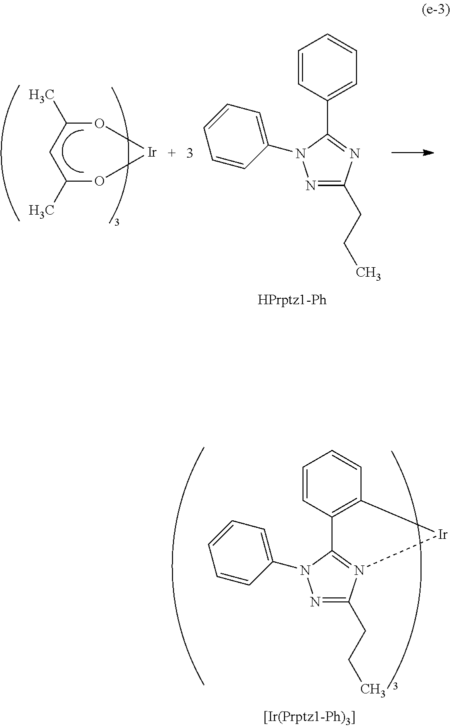

Each of the minute amounts of solid obtained in Step 3 above was analyzed by nuclear magnetic resonance spectrometry (¹H NMR); however, the structures were not confirmed. Since orthometalation occurs at two sites in the ligand HPrptz1-Ph (abbreviation) of this comparative example, a tris complex in which each bonding between a ligand and iridium is not uniform is generated; therefore, the yield of the objective substance is very low and the synthesis thereof is difficult. That is, as shown in a partial structural formula below, iridium is ortho-metalated also on an N-phenyl group side, the yield is low and the synthesis thereof is difficult.

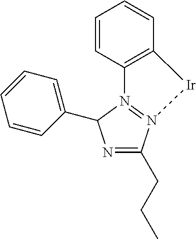

As described in this comparative example, the synthesis of [Ir(Prptz1-Ph)₃] (abbreviation) was difficult. In this manner, it was turned out that the organometallic complex which does not include a substituent at no substitution site other than the para-position of a phenyl group at the 1-position of a 1H-1,2,4-triazole ring is synthesized with extremely low yield or the synthesis of the objective substance is difficult unlike the organometallic complex of one embodiment of the present invention described in Examples 1 to 6, which includes a substituent at any substitution site other than the para-position of a phenyl group at the 1-position of a 1H-1,2,4-triazole ring. This is because, as described above, since orthometalation occurs at two sites in the ligand HPrptz1-Ph (abbreviation), a tris complex in which each bonding between a ligand and iridium is not uniform is generated. That is, in the case of an organometallic complex which is one embodiment of the present invention, it is possible to suppress a reaction of generating an impurity in the synthesis reaction of the complex; therefore, the yield of the synthesis is drastically improved as compared with [Ir(Prptz1-Ph)₃] (abbreviation).

### Example 9

In this example, a light-emitting element 6 in which an organometallic complex of one embodiment of the present invention represented by the structural formula (100) in Embodiment 1 is used as a light-emitting substance, a light-emitting element 7 which an organometallic complex of one embodiment of the present invention represented by the structural formula (103) is used as a light-emitting substance, and a light-emitting element 8 in which an organometallic complex of one embodiment of the present invention represented by the structural formula (101) is used as a light-emitting substance were evaluated. Chemical formulas of materials used in this example are shown below.

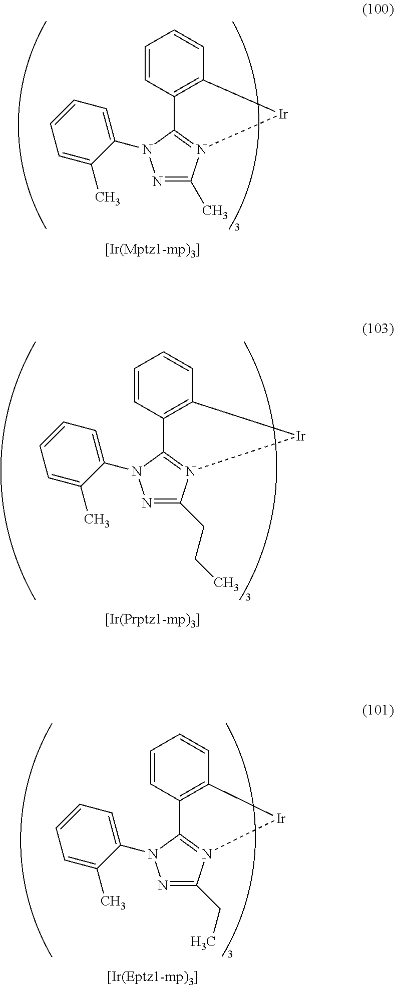

The light-emitting element 6 is described with reference to FIG. 19A. A method of fabricating the light-emitting element 6 of this example is described.

### (Light-Emitting Element 6)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 60 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, mCP (abbreviation) and tris[3-methyl-1-(2-methylphenyl)-5-phenyl-1H-1,2,4-triazolato]iridium(III) (abbreviation: [Ir(Mptz1-mp)₃]) synthesized in Example 1 were co-evaporated to form a first light-emitting layer 1113a on the hole-transport layer 1112. Here, the weight ratio of mCP (abbreviation) to [Ir(Mptz1-mp)₃] (abbreviation) was adjusted to 1:0.08 (=mCP:[Ir(Mptz1-mp)₃]). The thickness of the first light-emitting layer 1113a was 30 nm.

Next, on the first light-emitting layer 1113a, 2-[3-(dibenzothiophen-4-yl)phenyl]-1-phenyl-1H-benzimidazole (abbreviation: mDBTBIm-II) and [Ir(Mptz1-mp)₃] (abbreviation) were co-evaporated to form a second light-emitting layer 1113b on the first light-emitting layer 1113a. Here, the weight ratio of mDBTBIm-II (abbreviation) to [Ir(Mptz1-mp)₃] (abbreviation) was adjusted to 1:0.08 (=mDBTBIm-II:[Ir(Mptz1-mp)₃]). The thickness of the second light-emitting layer 1113b was 10 nm.

After that, on the second light-emitting layer 1113b, a bathophenanthroline (abbreviation: BPhen) film was formed to a thickness of 15 nm, whereby an electron-transport layer 1114 was formed.

Further, a lithium fluoride (LiF) film was formed to a thickness of 1 nm on the electron-transport layer 1114 by evaporation, whereby an electron-injection layer 1115 was formed.

Lastly, an aluminum film was formed to a thickness of 200 nm by evaporation as a second electrode 1103 functioning as a cathode. Thus, the light-emitting element 6 of this example was fabricated.

Next, the light-emitting element 7 is described with reference to FIG. 19A. A method for fabricating the light-emitting element 7 of this example is described below.

### (Light-Emitting Element 7)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 60 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, mCP (abbreviation) and tris[1-(2-methylphenyl)-5-phenyl-3-propyl-1H-1,2,4-triazolato]iridium(III) (abbreviation: [Ir(Prptz1-mp)₃]) synthesized in Example 3 were co-evaporated to foam a first light-emitting layer 1113a on the hole-transport layer 1112. Here, the weight ratio of mCP (abbreviation) to [Ir(Prptz1-mp)₃] (abbreviation) was adjusted to 1:0.08 (=mCP:[Ir(Prptz1-mp)₃]). The thickness of the first light-emitting layer 1113a was 30 nm.

Next, on the first light-emitting layer 1113a, 2-[3-(dibenzothiophen-4-yl)phenyl]-1-phenyl-1H-benzimidazole (abbreviation: mDBTBIm-II) and [Ir(Prptz1-mp)₃] (abbreviation) were co-evaporated to form a second light-emitting layer 1113b on the first light-emitting layer 1113a. Here, the weight ratio of mDBTBIm-II (abbreviation) to [Ir(Prptz1-mp)₃] (abbreviation) was adjusted to 1:0.08 (=mDBTBIm-II:[Ir(Prptz1-mp)₃]). The thickness of the second light-emitting layer 1113b was 10 nm.

After that, on the second light-emitting layer 1113b, a bathophenanthroline (abbreviation: BPhen) film was formed to a thickness of 15 nm, whereby an electron-transport layer 1114 was formed.

Further, on the electron-transport layer 1114, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 7 of this example was fabricated.

Next, the light-emitting element 8 is described with reference to FIG. 19A. A method for fabricating the light-emitting element 8 of this example is described below.

### (Light-Emitting Element 8)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 60 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, mCP (abbreviation) and tris[3-ethyl-1-(2-methylphenyl)-5-phenyl-1H-1,2,4-triazolato]iridium(III) (abbreviation: [Ir(Eptz1-mp)₃]) synthesized in Example 4 were co-evaporated to form a first light-emitting layer 1113a on the hole-transport layer 1112. Here, the weight ratio of mCP (abbreviation) to [Ir(Eptz1-mp)₃] (abbreviation) was adjusted to 1:0.08 (=mCP:[Ir(Eptz1-mp)₃]). The thickness of the first light-emitting layer 1113a was 30 nm.

Next, on the first light-emitting layer 1113a, 2-[3-(dibenzothiophen-4-yl)phenyl]-1-phenyl-1H-benzimidazole (abbreviation: mDBTBIm-II) and [Ir(Eptz1-mp)₃] (abbreviation) were co-evaporated to form a second light-emitting layer 1113b on the first light-emitting layer 1113a. Here, the weight ratio of mDBTBIm-H (abbreviation) to [Ir(Eptz1-mp)₃] (abbreviation) was adjusted to 1:0.08 (=mDBTBIm-II:[Ir(Eptz1-mp)₃]). The thickness of the second light-emitting layer 1113b was 10 nm.

After that, on the second light-emitting layer 1113b, a bathophenanthroline (abbreviation: BPhen) film was formed to a thickness of 15 nm, whereby an electron-transport layer 1114 was fowled.

Further, on the electron-transport layer 1114, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 8 of this example was fabricated.

Table 5 shows element structures of the thus obtained light-emitting elements 6 to 8.

TABLE 5

| | | Hole- | Hole- | First Light- |
|---|---|---|---|---|
| | First | injection | transport | emitting |
| | Electrode | Layer | Layer | Layer |
| Light-emitting | ITSO | CBP:MoOx | mCP | mCP: |
| Element 6 | 110 mm | (=4:2) | 20 nm | [Ir(Mptz1-mp)₃] |
| | | 60 nm | | (=1:0.08) |
| | | | | 30 nm |
| Light-emitting | ITSO | CBP:MoOx | mCP | mCP: |
| Element 7 | 110 nm | (=4:2) | 20 nm | [Ir(Prptz1-mp)₃] |
| | | 60 nm | | (=1:0.08) |
| | | | | 30 nm |
| Light-emitting | ITSO | CBP:MoOx | mCP | mCP: |
| Element 8 | 110 nm | (=4:2) | 20 nm | [Ir(Eptz1-mp)₃] |
| | | 60 nm | | (=1:0.08) |
| | | | | 30 nm |

| | Second Light- | Electron- | Electron- | |
|---|---|---|---|---|
| | emitting | transport | injection | Second |
| | Layer | Layer | Layer | Electrode |
| Light-emitting | mDBTBIm-II: | BPhen | LiF | Al |
| Element 6 | [Ir(Mptz1-mp)₃] | 15 nm | 1 nm | 200 nm |
| | (=1:0.08) | | | |
| | 10 nm | | | |
| Light-emitting | mDBTBIm-II: | BPhen | LiF | Al |
| Element 7 | [Ir(Prptz1-mp)₃] | 15 nm | 1 nm | 200 nm |
| | (=1:0.08) | | | |
| | 10 nm | | | |
| Light-emitting | mDBTBIm-II: | BPhen | LiF | Al |
| Element 8 | [Ir(Eptz1-mp)₃] | 15 nm | 1 nm | 200 nm |
| | (=1:0.08) | | | |
| | 10 nm | | | |

In a glove box containing a nitrogen atmosphere, the light-emitting elements 6 to 8 were sealed so as not to be exposed to the air. After that, operating characteristics of the light-emitting elements 6 to 8 were measured. Note that the measurements were carried out at room temperature (in an atmosphere kept at 25° C.).

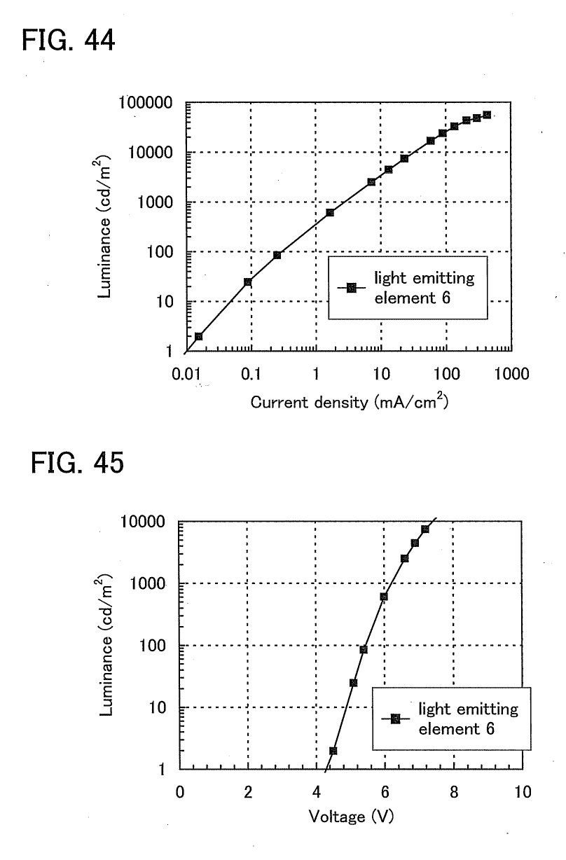

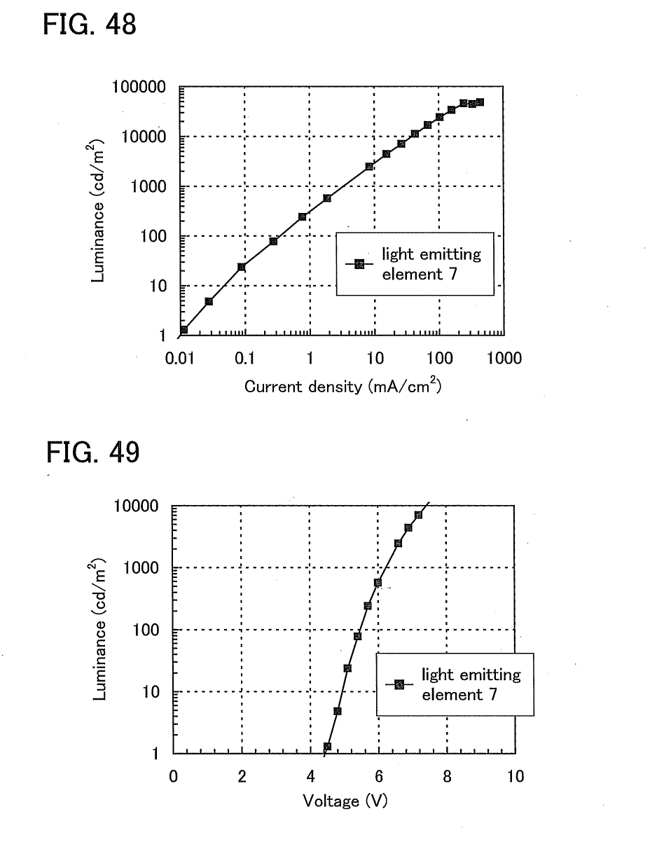

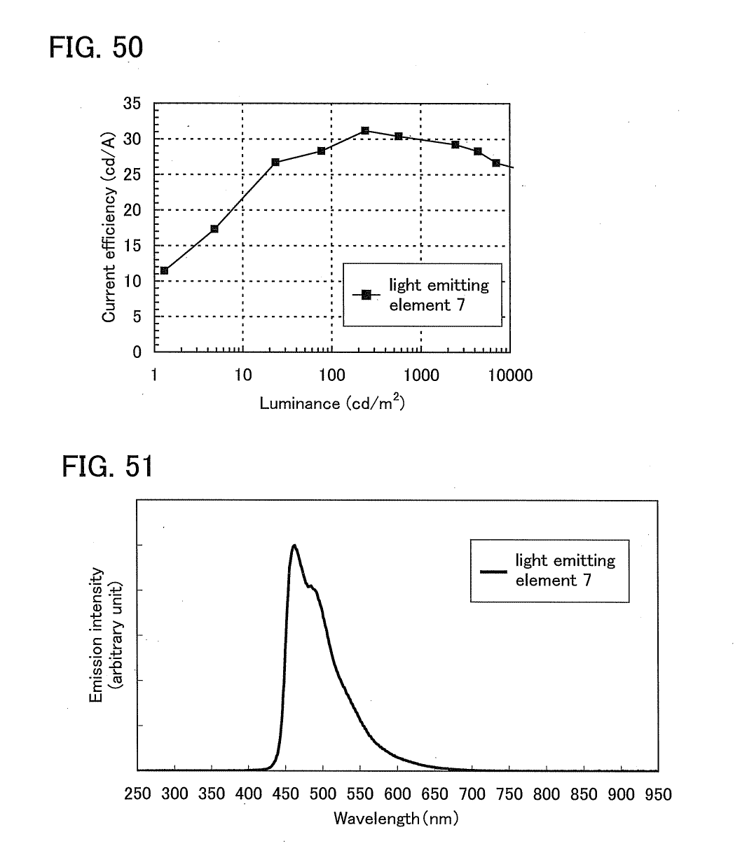

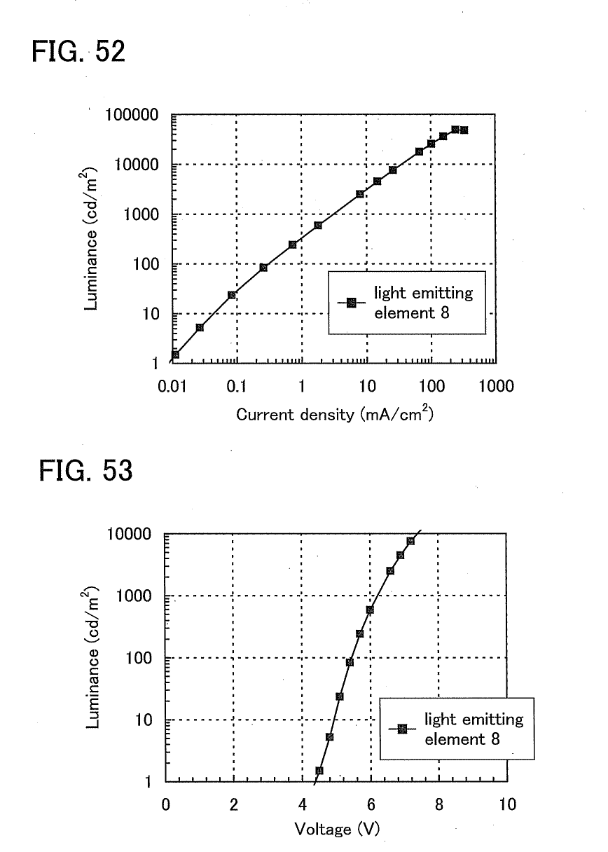

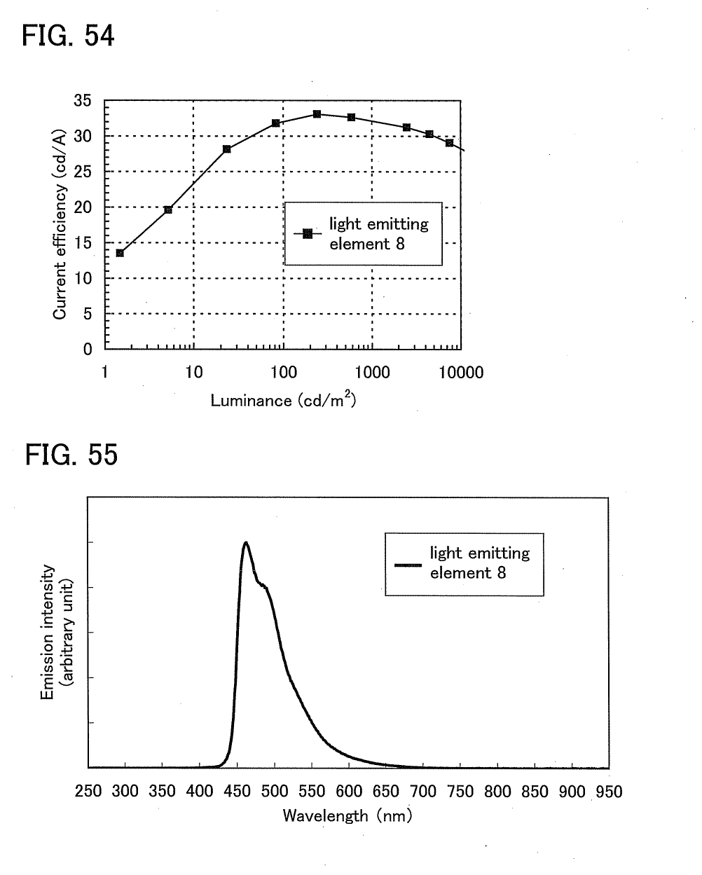

FIG. 44, FIG. 48, and FIG. 52 show current density versus luminance characteristics of the light-emitting element 6, the light-emitting element 7, and the light-emitting element 8, respectively. In each of FIG. 44, FIG. 48, and FIG. 52, the horizontal axis represents current density (mA/cm²) and the vertical axis represents luminance (cd/m²). In addition, FIG. 45, FIG. 49, and FIG. 53 show voltage versus luminance characteristics of the light-emitting element 6, the light-emitting element 7, and the light-emitting element 8, respectively. In each of FIG. 45, FIG. 49, and FIG. 53, the horizontal axis represents voltage (V) and the vertical axis represents luminance (cd/m²). Further, FIG. 46, FIG. 50, and FIG. 54 show luminance versus current efficiency characteristics of the light-emitting element 6, the light-emitting element 7, and the light-emitting element 8, respectively. In each of FIG. 46, FIG. 50, and FIG. 54, the horizontal axis represents luminance (cd/m²) and the vertical axis represents current efficiency (cd/A).

Further, Table 6 shows the voltage (V), current density (mA/cm²), CIE chromaticity coordinates (x, y), luminance (cd/m²), current efficiency (cd/A), and external quantum efficiency (%) of each of the light-emitting elements 6 to 8 at a luminance of approximately 1000 cd/m².

TABLE 6

| | | Current | | | | External |
|---|---|---|---|---|---|---|
| | Volt- | Density | Chro- | Lumi- | Current | Quantum |
| | age | (mA/ | maticity | nance | Efficiency | Efficiency |
| | (V) | cm²) | x, y | (cd/m²) | (cd/A) | ( ) |
| Light- | 6.0 | 1.7 | 0.17, 0.28 | 606 | 36.2 | 20.1 |
| emitting | | | | | | |
| Element 6 | | | | | | |
| Light- | 6.0 | 1.9 | 0.17, 0.26 | 570 | 30.4 | 17.1 |
| emitting | | | | | | |
| Element 7 | | | | | | |
| Light- | 6.0 | 1.8 | 0.17, 0.26 | 589 | 32.6 | 18.9 |
| emitting | | | | | | |
| Element 8 | | | | | | |

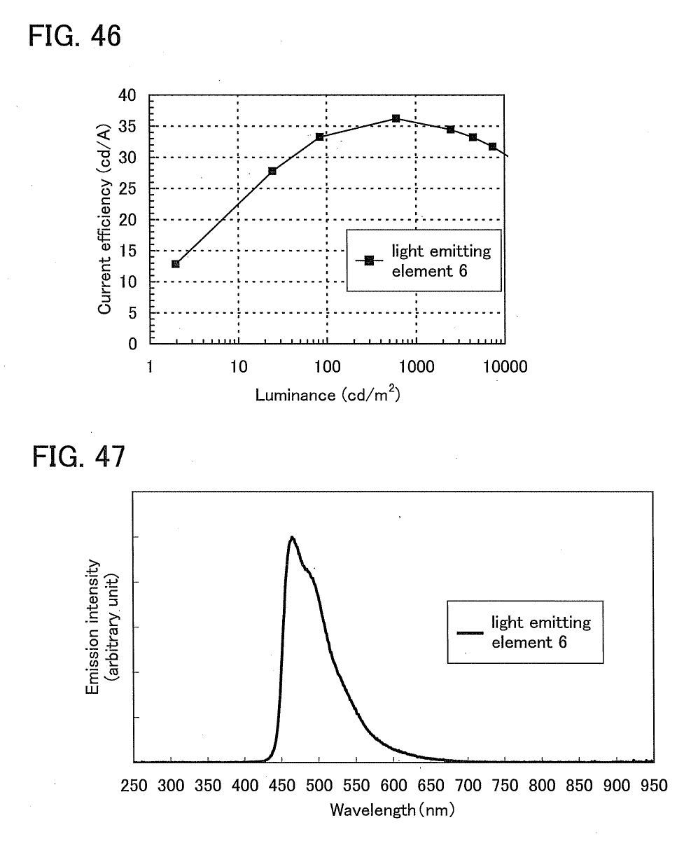

FIG. 47, FIG. 51, and FIG. 55 show emission spectra when a current was supplied at a current density of 2.5 mA/cm² to the light-emitting element 6, the light-emitting element 7, and the light-emitting element 8, respectively. As shown in FIG. 47, FIG. 51, and FIG. 55, the emission spectra of the light-emitting element 6, the light-emitting element 7, and the light-emitting element 8 have peaks at 465 nm, 463 nm, and 463 nm, respectively.

In addition, as shown in Table 6, the CIE chromaticity coordinates of the light-emitting element 6, the light-emitting element 7, and the light-emitting element 8 were (x, y)=(0.17, 0.28), (x, y)=(0.17, 0.26), and (x, y)=(0.17, 0.26), at a luminance of 606 cd/m², a luminance of 570 cd/m², and a luminance of 589 cd/m², respectively.

As described above, it was found that the light-emitting elements 6 to 8 each using the organometallic complex of one embodiment of the present invention can efficiently emit light in a wavelength region of green to blue.

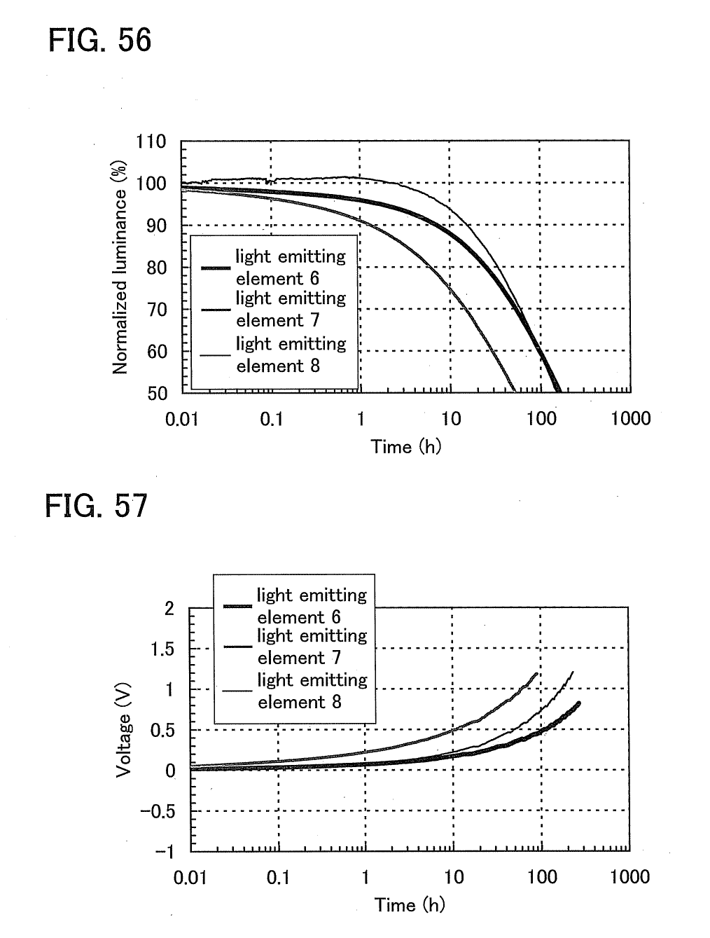

Next, reliability testing of the light-emitting elements 6 to 8 was carried out. Results of the reliability testing are shown in FIG. 56 and FIG. 57.

In FIG. 56, changes in luminance of the light-emitting elements 6 to 8 over time are shown, which were obtained by driving the light-emitting elements 6 to 8 under the conditions where each initial luminance was set to 300 cd/m² and each current density was constant. The horizontal axis represents driving time (h) of the elements, and the vertical axis represents normalized luminance (%) on the assumption that an initial luminance is 100%. From FIG. 56, it was found that normalized luminance values of the light-emitting element 6, the light-emitting element 7, and the light-emitting element 8 became 70% or lower after 53 hours, 15 hours, and 60 hours, respectively.

In FIG. 57, changes in voltage of the light-emitting elements 6 to 8 over time are shown, which were obtained by driving the light-emitting elements 6 to 8 under the conditions where each initial luminance was set to 300 cd/m² and each current density was constant. The horizontal axis represents driving time (h) of the elements, and the vertical axis represents voltage (V). From FIG. 57, it was found that the increase in voltage over time is the smallest in the light-emitting element 6, followed by the light-emitting element 8 and the light-emitting element 7.

### Example 10

In this example, a light-emitting element 9 in which an organometallic complex of one embodiment of the present invention represented by the structural formula (112) in Embodiment 1 is used as a light-emitting substance was evaluated. A chemical formula of the material used in this example is shown below.

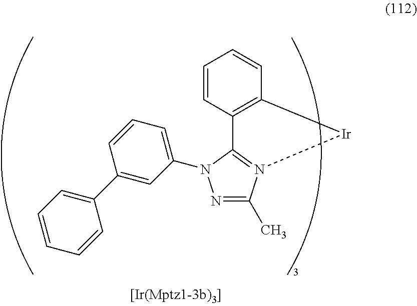

The light-emitting element 9 is described with reference to FIG. 19A. A method for fabricating the light-emitting element 9 of this example is described below.

### (Light-Emitting Element 9)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 60 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, 2-[3-(dibenzothiophen-4-yl)phenyl]-1-phenyl-1H-benzimidazole (abbreviation: mDBTBIm-II) and tris[1-(5-biphenyl)-3-methyl-5-phenyl-1H-1,2,4-triazolato]iridium(III) (abbreviation: [Ir(Mptz1-3b)₃]) synthesized in Example 5 were co-evaporated to form a first light-emitting layer 1113a on the hole-transport layer 1112. Here, the weight ratio of mDBTBIm-II (abbreviation) to [Ir(Mptz1-3b)₃] (abbreviation) was adjusted to 1:0.08 (=mDBTBIm-II:[Ir(Mptz1-3b)₃]). The thickness of the first light-emitting layer 1113a was 30 nm.

Next, on the first light-emitting layer 1113a, mDBTBIm-II (abbreviation) and [Ir(Mptz1-3b)₃] (abbreviation) were co-evaporated to form a second light-emitting layer 1113b on the first light-emitting layer 1113a. Here, the weight ratio of mDBTBIm-II (abbreviation) to [Ir(Mptz1-3b)₃] (abbreviation) was adjusted to 1:0.08 (=mDBTBIm-II:[Ir(Mptz1-3b)₃]). The thickness of the second light-emitting layer 1113b was 10 nm.

After that, on the second light-emitting layer 1113b, a bathophenanthroline (abbreviation: BPhen) film was formed to a thickness of 15 nm, whereby an electron-transport layer 1114 was formed.

Further, a lithium fluoride (LiF) film was formed to a thickness of 1 nm on the electron-transport layer 1114 by evaporation, whereby an electron-injection layer 1115 was formed.

Lastly, an aluminum film was formed to a thickness of 200 nm by evaporation as a second electrode 1103 functioning as a cathode. Thus, the light-emitting element 9 of this example was fabricated.

Table 7 shows an element structure of the thus obtained light-emitting element 9.

TABLE 7

| | | Hole- | Hole- | First Light- |
|---|---|---|---|---|
| | First | injection | transport | emitting |
| | Electrode | Layer | Layer | Layer |
| Light-emitting | ITSO | CBP:MoOx | mCP | mDBTBIm-II: |
| Element 9 | 110 nm | (=4:2) | 20 nm | [Ir(Mptz1-3b)₃] |
| | | 60 nm | | (=1:0.08) |
| | | | | 30 nm |

| | Second Light- | Electron- | Electron- | |
|---|---|---|---|---|
| | emitting | transport | injection | Second |
| | Layer | Layer | Layer | Electrode |
| Light-emitting | mDBTBIm-II: | BPhen | LiF | Al |
| Element 9 | [Ir(Mptz1-3b)₃] | 15 nm | 1 nm | 200 nm |
| | (=1:0.08) | | | |
| | 10 nm | | | |

In a glove box containing a nitrogen atmosphere, the light-emitting element 9 was sealed so as not to be exposed to the air. After that, operating characteristics of the light-emitting element 9 were measured. Note that the measurement was carried out at room temperature (in an atmosphere kept at 25° C.).

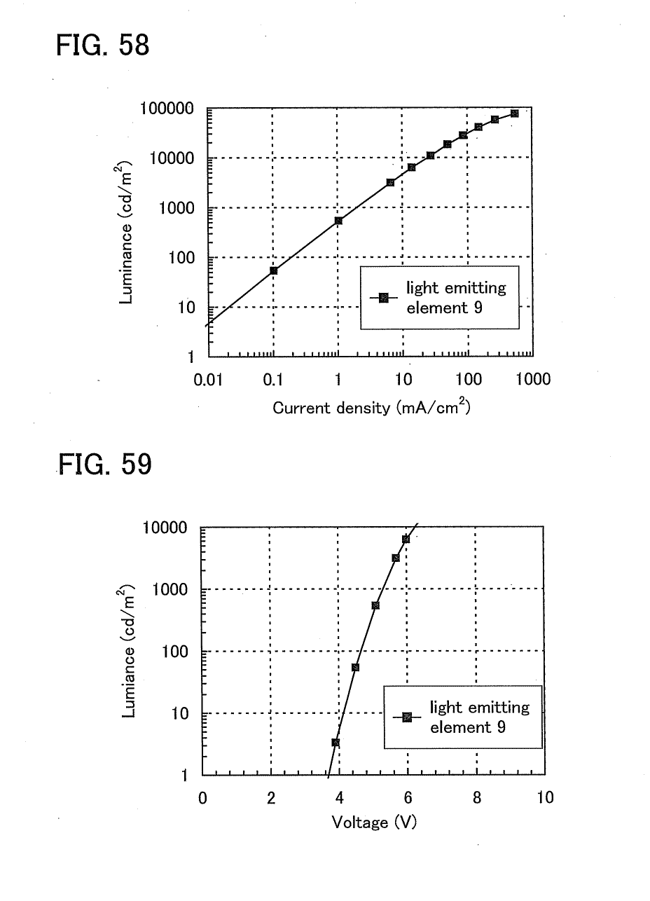

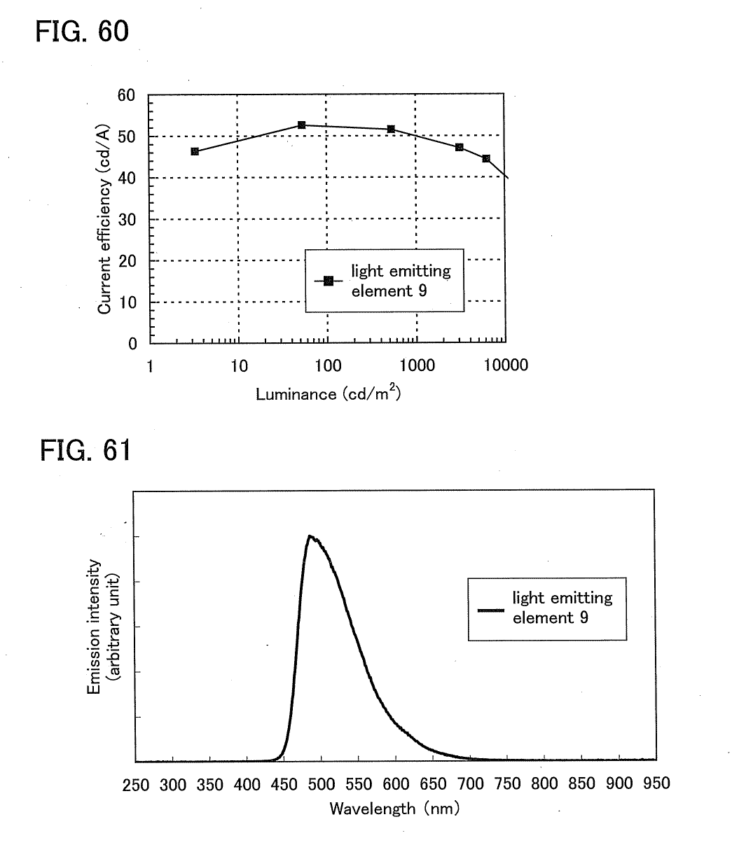

FIG. 58 shows current density versus luminance characteristics of the light-emitting element 9. In FIG. 58, the horizontal axis represents current density (mA/cm²) and the vertical axis represents luminance (cd/m²). In addition, FIG. 59 shows voltage versus luminance characteristics of the light-emitting element 9. In FIG. 59, the horizontal axis represents voltage (V) and the vertical axis represents luminance (cd/m²). Further, FIG. 60 shows luminance versus current efficiency characteristics of the light-emitting element 9. In FIG. 60, the horizontal axis represents luminance (cd/m²) and the vertical axis represents current efficiency (cd/A).

Further, Table 8 shows the voltage (V), current density (mA/cm²), CIE chromaticity coordinates (x, y), luminance (cd/m²), current efficiency (cd/A), and external quantum efficiency (%) of the light-emitting element 9 at a luminance of approximately 1000 cd/m².

TABLE 8

| | | | | | | External |
|---|---|---|---|---|---|---|
| | Volt- | Current | Chro- | Lumi- | Current | Quantum |
| | age | Density | maticity | nance | Efficiency | Efficiency |
| | (V) | (mA/cm²) | x, y | (cd/m²) | (cd/A) | ( ) |
| Light- | 5.1 | 1.1 | 0.24, | 539 | 51.5 | 19.5 |
| emitting | | | 0.48 | | | |
| Element 9 | | | | | | |

FIG. 61 shows an emission spectrum when a current was supplied at a current density of 2.5 mA/cm² to the light-emitting element 9. As shown in FIG. 61, the emission spectrum of the light-emitting element 9 has a peak at 487 nm.

In addition, as shown in Table 8, the CIE chromaticity coordinates of the light-emitting element 9 were (x, y)=(0.24, 0.48) at a luminance of 539 cd/m².

As described above, it was found that the light-emitting element 9 using the organometallic complex of one embodiment of the present invention can efficiently emit light in a wavelength region of green to blue.

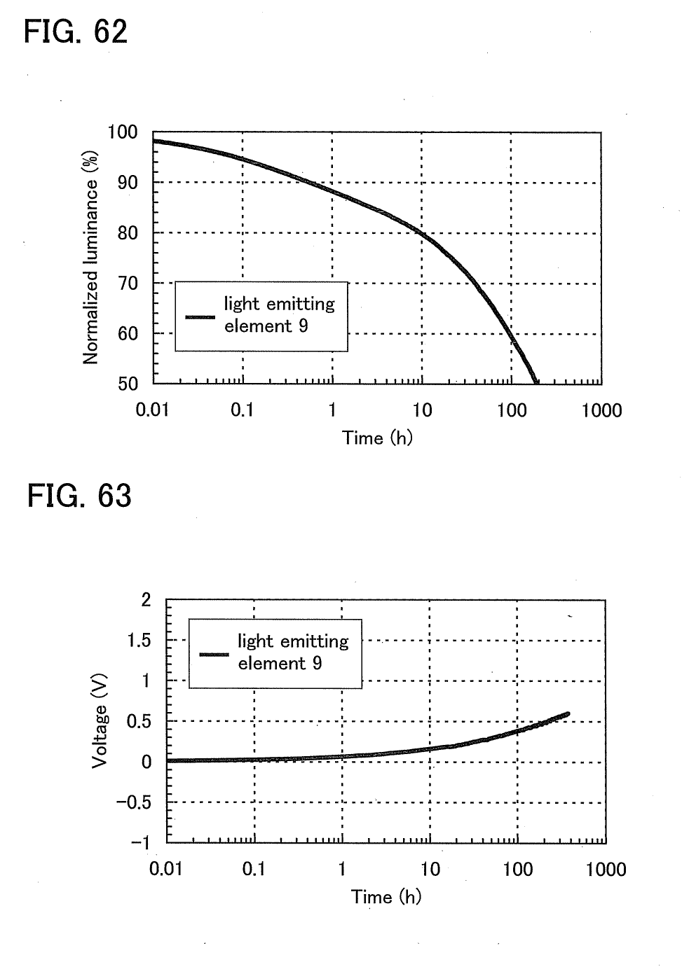

Next, reliability testing of the light-emitting element 9 was carried out. Results of the reliability testing are shown in FIG. 62 and FIG. 63.

In FIG. 62, changes in luminance of the light-emitting element 9 over time are shown, which were obtained by driving the light-emitting element 9 under the conditions where an initial luminance was set to 300 cd/m² and current density was constant. The horizontal axis represents driving time (h) of the element, and the vertical axis represents normalized luminance (%) on the assumption that an initial luminance is 100%. From FIG. 62, it was found that a normalized luminance value of the light-emitting element 9 became 70% or lower after 39 hours.

In FIG. 63, changes in voltage of the light-emitting element 9 over time are shown, which were obtained by driving the light-emitting element 9 under the conditions where an initial luminance was set to 300 cd/m² and current density was constant. The horizontal axis represents driving time (h) of the element, and the vertical axis represents voltage (V). From FIG. 63, it was found that the increase in voltage over time is the smaller in the light-emitting element 9 fabricated in this example, as compared with any of the light-emitting elements 6 to 8 described in Example 9.

### Example 11

In this example, a light-emitting element 10 and a light-emitting element 11 in each of which an organometallic complex of one embodiment of the present invention represented by the structural formula (128) in Embodiment 1 is used as a light-emitting substance were evaluated. Note that the light-emitting element 10 and the light-emitting element 11 are different from each other in element structure and host material into which the organometallic complex of one embodiment of the present invention was introduced. A chemical formula of the material used in this example is shown below.

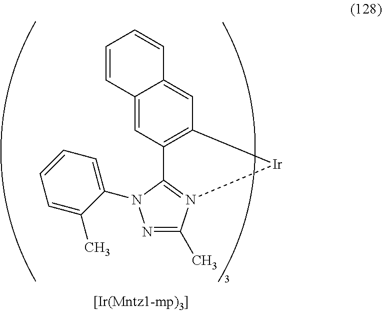

The light-emitting element 10 is described with reference to FIG. 19C. A method for fabricating the light-emitting element 10 of this example is described below.

### (Light-Emitting Element 10)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 80 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, mCP (abbreviation) and tris[1-(2-methylphenyl)-3-methyl-5-(2-naphthyl)-1H-1,2,4-triazolato]iridium(III) (abbreviation: [Ir(Mntz1-mp)₃]) synthesized in Example 6 were co-evaporated to form a light-emitting layer 1113 on the hole-transport layer 1112. Here, the weight ratio of mCP (abbreviation) to [Ir(Mntz1-mp)₃] (abbreviation) was adjusted to 1:0.08 (=mCP:[Ir(Mntz1-mp)₃]). The thickness of the light-emitting layer 1113 was 40 nm.

Next, on the light-emitting layer 1113, a film of 2-[3-(dibenzothiophen-4-yl)phenyl]-1-phenyl-1H-benzimidazole (abbreviation: mDBTBIm-II) was formed by evaporation to form a first electron-transport layer 1114a on the light-emitting layer 1113. The thickness of the first electron-transport layer 1114a was 20 nm.

After that, on the first electron-transport layer 1114a, a bathophenanthroline (abbreviation: BPhen) film was formed to a thickness of 20 nm, whereby a second electron-transport layer 1114b was formed.

Further, on the second electron-transport layer 1114b, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 10 of this example was fabricated.

Table 9 shows an element structure of the thus obtained light-emitting element 10.

TABLE 9

| | | Hole- | Hole- | Light- |
|---|---|---|---|---|
| | First | injection | transport | emitting |
| | Electrode | Layer | Layer | Layer |
| Light-emitting | ITSO | CBP:MoOx | mCP | mCP: |
| Element 10 | 110 nm | (=4:2) | 20 nm | [Ir(Mntz1-mp)₃] |
| | | 80 nm | | (=1:0.08) |
| | | | | 40 nm |

| | First | Second | | |
|---|---|---|---|---|
| | Electron- | Electron- | Electron- | |
| | transport | transport | injection | Second |
| | Layer | Layer | Layer | Electrode |
| Light-emitting | mDBTBIm-II | BPhen | LiF | Al |
| Element 10 | 20 nm | 20 nm | 1 nm | 200 nm |

Next, a light-emitting element 11 is described with reference to FIG. 19D. A method of fabricating the light-emitting element 11 of this example is described below.

### (Light-Emitting Element 11)

First, a film of indium tin oxide containing silicon oxide (ITSO) was formed over a substrate 1100 by a sputtering method, whereby a first electrode 1101 was formed. The thickness was 110 nm and the electrode area was 2 mm×2 mm.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down naturally for about 30 minutes.

Next, the substrate 1100 provided with the first electrode 1101 was fixed to a substrate holder in the vacuum evaporation apparatus so that a surface on which the first electrode 1101 was provided faced downward. The pressure in the vacuum evaporation apparatus was reduced to about 10⁻⁴ Pa. Then, 4,4′-di(N-carbazolyl)biphenyl (abbreviation: CBP) and molybdenum(VI) oxide were co-evaporated to form a hole-injection layer 1111 on the first electrode 1101. The thickness of the hole-injection layer 1111 was 80 nm, and the weight ratio of CBP (abbreviation) to molybdenum oxide was adjusted to 4:2 (=CBP:molybdenum oxide). Note that the co-evaporation method refers to an evaporation method in which evaporation is carried out from a plurality of evaporation sources at the same time in one treatment chamber.

Next, on the hole-injection layer 1111, a film of 1,3-bis(N-carbazolyl)benzene (abbreviation: mCP) was formed to a thickness of 20 nm, whereby a hole-transport layer 1112 was formed.

Further, 2-[3-(dibenzothiophen-4-yl)phenyl]dibenzo[f,h]quinoxaline (abbreviation: 2mDBTPDBq-II), 4-phenyl-4′-(9-phenyl-9H-carbazol-3-yl)triphenylamine (abbreviation: PCBA1BP), and tris[1-(2-methylphenyl)-3-methyl-5-(2-naphthyl)-1H-1,2,4-triazolato]iridium(III) (abbreviation: [Ir(Mntz1-mp)₃]) synthesized in Example 6 were co-evaporated to form a first light-emitting layer 1113a on the hole-transport layer 1112. Here, the weight ratio of 2mDBTPDBq-II (abbreviation) to PCBA1BP (abbreviation) and [Ir(Mntz1-mp)₃] (abbreviation) was adjusted to 1:0.3:0.08 (=2mDBTPDBq-II:PCBA1BP:[Ir(Mntz1-mp)₃]). The thickness of the first light-emitting layer 1113a was 20 nm.

Next, on the first light-emitting layer 1113a, 2mDBTPDBq-II (abbreviation) and [Ir(Mntz1-mp)₃] (abbreviation) were co-evaporated to form a second light-emitting layer 1113b on the first light-emitting layer 1113a. The thickness of the second light-emitting layer 1113b was 20 nm.

Next, on the second light-emitting layer 1113b, a film of 2mDBTPDBq-II (abbreviation) was formed by evaporation to form a first electron-transport layer 1114a on the second light-emitting layer 1113b. The thickness of the first electron-transport layer 1114a was 20 nm.

After that, on the first electron-transport layer 1114a, a bathophenanthroline (abbreviation: BPhen) film was formed to a thickness of 20 nm, whereby a second electron-transport layer 1114b was formed.

Further, on the second electron-transport layer 1114b, a lithium fluoride (LiF) film was formed to a thickness of 1 nm by evaporation, whereby an electron-injection layer 1115 was formed.

Lastly, an aluminum film was formed to a thickness of 200 nm by evaporation as a second electrode 1103 functioning as a cathode. Thus, the light-emitting element 11 of this example was fabricated.

Table 10 shows an element structure of the thus obtained light-emitting element 11.

TABLE 10

| | | Hole- | Hole- | First Light- |
|---|---|---|---|---|
| | First | injection | transport | emitting |
| | Electrode | Layer | Layer | Layer |
| Light-emitting | ITSO | CBP:MoOx | mCP | 2mDBTPDBq-II: |
| Element 11 | 110 nm | (=4:2) | 20 nm | PCBA1BP: |
| | | 80 nm | | [Ir(Mntz1-mp)₃] |
| | | | | (° 1:0.3:0.08) |
| | | | | 20 nm |

| | Second Light- | First Electron- | Second Electron- |
|---|---|---|---|
| | emitting | transport | transport |
| | Layer | Layer | Layer |
| Light-emitting | 2mDBTPDBq-II: | 2mDBTPDBq-II | BPhen |
| Element 11 | [Ir(Mntz1-mp)₃] | 20 nm | 20 nm |
| | (=1:0.08) | | |
| | 20 nm | | |

| | Electron- | |
|---|---|---|
| | injection | Second |
| | Layer | Electrode |
| Light-emitting | LiF | Al |
| Element 11 | 1 nm | 200 nm |

In a glove box containing a nitrogen atmosphere, the light-emitting elements 10 and 11 were sealed so as not to be exposed to the air. After that, operating characteristics of the light-emitting elements 10 and 11 were measured. Note that the measurements were carried out at room temperature (in an atmosphere kept at 25° C.).

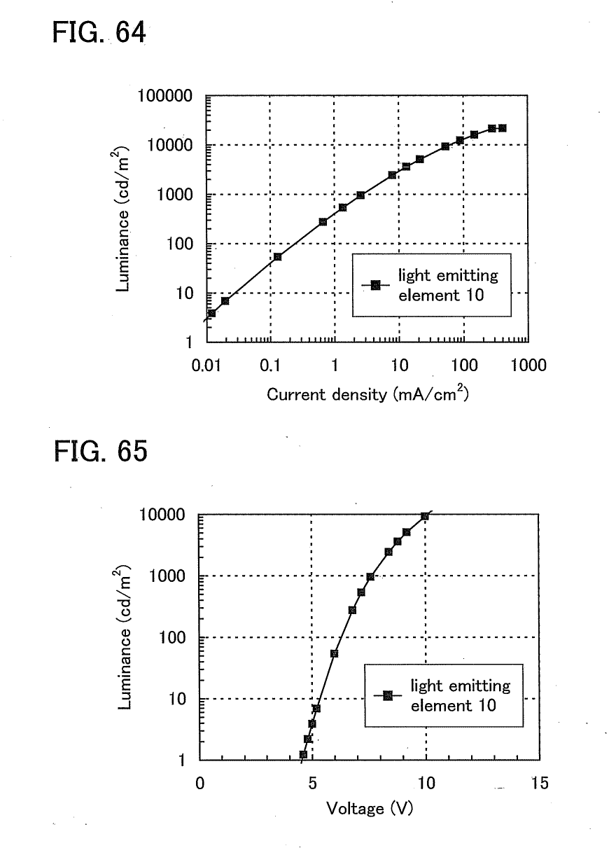

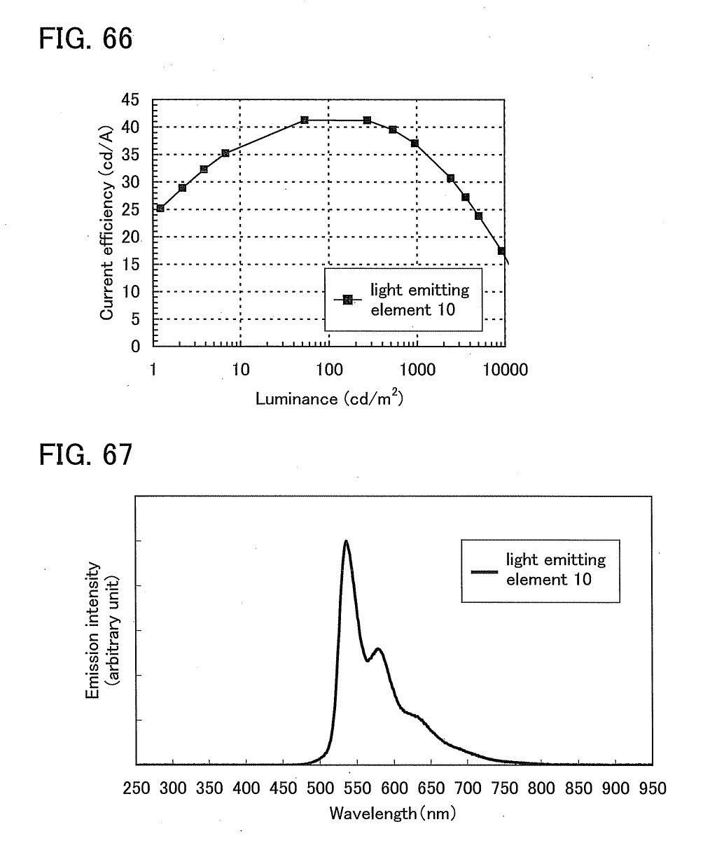

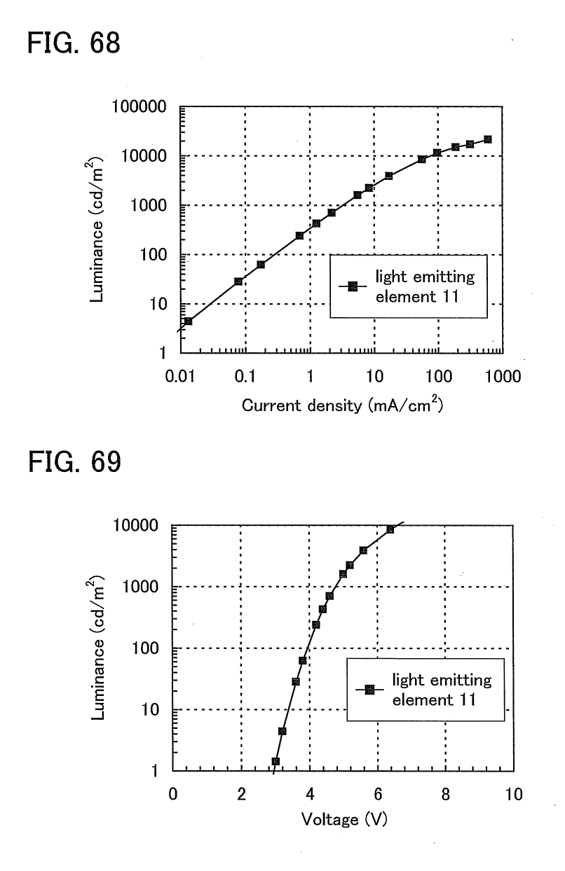

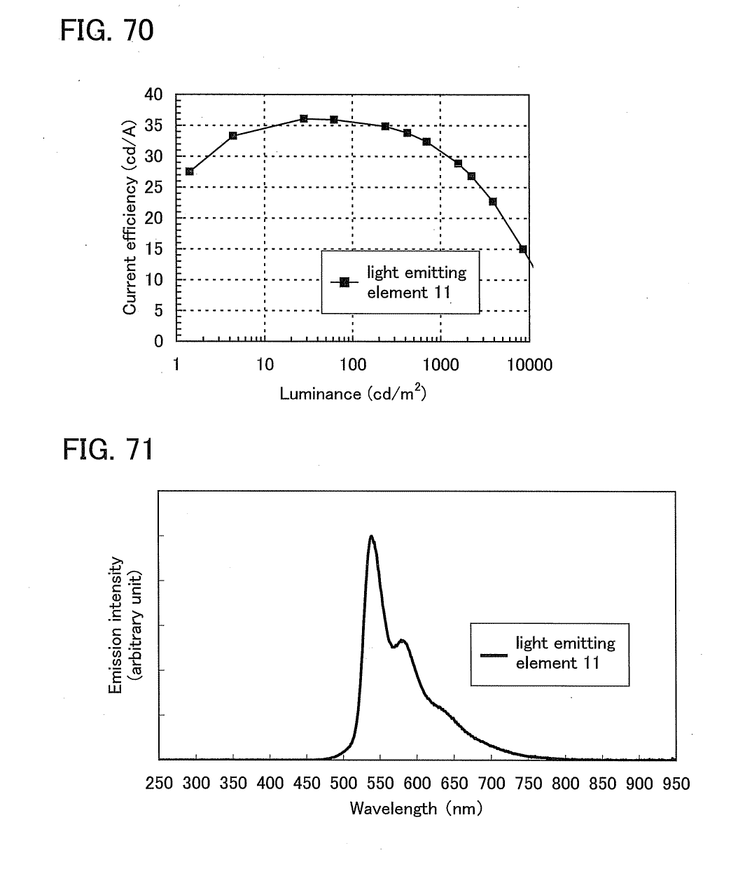

FIG. 64 and FIG. 68 show current density versus luminance characteristics of the light-emitting element 10 and the light-emitting element 11, respectively. In each of FIG. 64 and FIG. 68, the horizontal axis represents current density (mA/cm²) and the vertical axis represents luminance (cd/m²). In addition, FIG. 65 and FIG. 69 show voltage versus luminance characteristics of the light-emitting element 10 and the light-emitting element 11, respectively. In each of FIG. 65 and FIG. 69, the horizontal axis represents voltage (V) and the vertical axis represents luminance (cd/m²). Further, FIG. 66 and FIG. 70 show luminance versus current efficiency characteristics of the light-emitting element 10 and the light-emitting element 11, respectively. In each of FIG. 66 and FIG. 70, the horizontal axis represents luminance (cd/m²) and the vertical axis represents current efficiency (cd/A).

Further, Table 11 shows the voltage (V), current density (mA/cm²), CIE chromaticity coordinates (x, y), luminance (cd/m²), current efficiency (cd/A), and external quantum efficiency (%) of each of the light-emitting elements 10 and 11 at a luminance of approximately 1000 cd/m².

TABLE 11

| | | Current | | | | External |
|---|---|---|---|---|---|---|
| | Volt- | Density | Chro- | Lumi- | Current | Quantum |
| | age | (mA/ | maticity | nance | Efficiency | Efficiency |
| | (V) | cm²) | x, y | (cd/m²) | (cd/A) | (%) |
| Light- | 7.6 | 2.6 | 0.41, | 954 | 37.1 | 10.9 |
| emitting | | | 0.58 | | | |
| Element 10 | | | | | | |
| Light- | 4.6 | 2.2 | 0.42, | 704 | 32.3 | 9.7 |
| emitting | | | 0.57 | | | |
| Element 11 | | | | | | |

FIG. 67 and FIG. 71 show emission spectra when a current was supplied at a current density of 2.5 mA/cm² to the light-emitting element 10 and the light-emitting element 11, respectively. As shown in FIG. 67 and FIG. 71, the emission spectra of the light-emitting element 10 and the light-emitting element 11 have peaks at 536 nm and 539 nm, respectively.

In addition, as shown in Table 11, the CIE chromaticity coordinates of the light-emitting element 10 and the light-emitting element 11 were (x, y)=(0.41, 0.58) and (x, y)=(0.42, 0.57), at a luminance of 954 cd/m² and a luminance of 704 cd/m², respectively.

As described above, each of the light-emitting elements 10 and 11 in which the organometallic complex of one embodiment of the present invention is used has high emission efficiency.

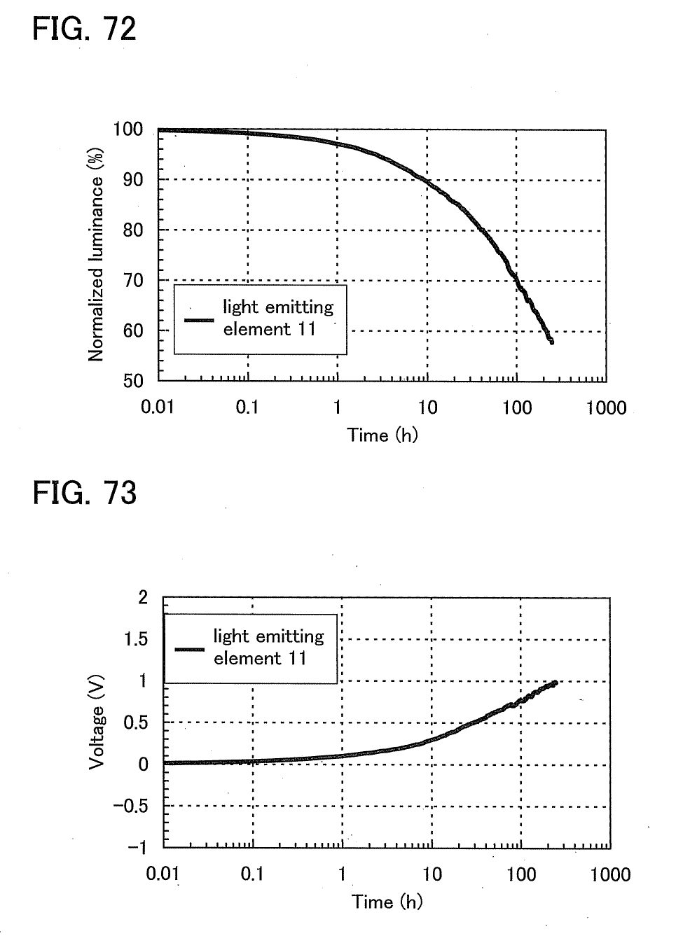

Next, reliability testing of the light-emitting element 11 was carried out. Results of the reliability testing are shown in FIG. 72 and FIG. 73.

In FIG. 72, changes in luminance of the light-emitting element 11 over time are shown, which were obtained by driving the light-emitting element 11 under the conditions where an initial luminance was set to 300 cd/m² and current density was constant. The horizontal axis represents driving time (h) of the element, and the vertical axis represents normalized luminance (%) on the assumption that an initial luminance is 100%. From FIG. 72, it was found that a normalized luminance value of the light-emitting element 11 became 70% or lower after 103 hours.

In FIG. 73, changes in voltage of the light-emitting element 11 over time are shown, which were obtained by driving the light-emitting element 11 under the conditions where an initial luminance was set to 300 cd/m² and current density was constant. The horizontal axis represents driving time (h) of the element, and the vertical axis represents voltage (V). From FIG. 73, it was found that the increase in voltage over time is the smaller in the light-emitting element 11 fabricated in this example, as compared with the light-emitting elements 6 to 8 described in Example 9.

### Reference Example 1

A method of synthesizing 2-[3-(dibenzothiophen-4-yl)phenyl]-1-phenyl-1H-benzimidazole (abbreviation: mDBTBIm-II) used in the above Examples is specifically described. A structure of mDBTBIm-II is shown below.

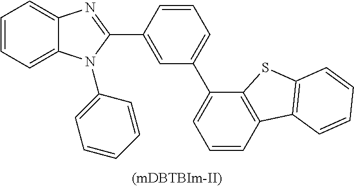

### Synthesis of 2-[3-(Dibenzothiophen-4-yl)phenyl]-1-phenyl-1H-benzimidazole (abbreviation: mDBTBIm-II)

The synthesis scheme of 2-[3-(dibenzothiophen-4-yl)phenyl]-1-phenyl-1H-benzimidazole (abbreviation: mDBTBIm-II) is shown in (f-1).

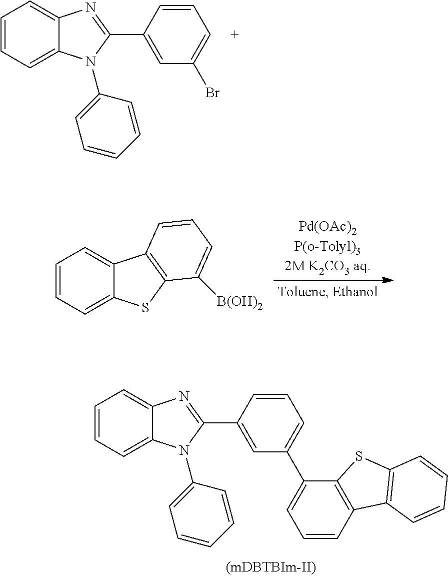

Into a 50-mL three-neck flask were put 1.2 g (3.3 mmol) of 2-(3-bromophenyl)-1-phenyl-1H-benzimidazole, 0.8 g (3.3 mmol) of dibenzothiophene-4-boronic acid, and 50 mg (0.2 mmol) of tri(ortho-tolyl)phosphine. The air in the flask was replaced with nitrogen. To this mixture were added 3.3 mL of a 2.0 mmol/L potassium carbonate aqueous solution, 12 mL of toluene, and 4 mL of ethanol. Under reduced pressure, this mixture was stirred to be degassed. Then, 7.4 mg (33 μmol) of palladium(II) acetate was added to this mixture, and the mixture was stirred at 80° C. for 6 hours under a nitrogen stream.

After a predetermined time, the aqueous layer of the obtained mixture was subjected to extraction with toluene, and an organic layer was obtained. The obtained solution of the extract and the organic layer were washed together with saturated saline and then dried with magnesium sulfate. This mixture was separated by gravity filtration, and the filtrate was concentrated to give an oily substance. This oily substance was purified by silica gel column chromatography. The silica gel column chromatography was carried out using toluene as a developing solvent. The obtained fraction was concentrated to give an oily substance. This oily substance was purified by high performance liquid column chromatography. The high performance liquid column chromatography was performed using chloroform as a developing solvent. The obtained fraction was concentrated to give an oily substance. This oily substance was recrystallized from a mixed solvent of toluene and hexane, so that the objective substance was obtained as 0.8 g of pale yellow powder in 51% yield.

By a train sublimation method, 0.8 g of the obtained pale yellow powder was purified. In the purification, the pale yellow powder was heated at 215° C. under a pressure of 3.0 Pa with a flow rate of argon gas of 5 mL/min. After the purification, 0.6 g of white powder which was the objective substance was obtained in 82% yield.

It was found that this obtained compound was 2-[3-(dibenzothiophen-4-yl)phenyl]-1-phenyl-1H-benzimidazole (abbreviation: mDBTBIm-II), which was the objective substance, by nuclear magnetic resonance (NMR) spectroscopy.

¹H NMR data of the obtained compound are shown below.

¹H NMR (CDCl₃, 300 MHz): δ=7.23-7.60 (m, 13H), 7.71-7.82 (m, 3H), 7.90-7.92 (m, 2H), 8.10-8.17 (m, 2H).

### EXPLANATION OF REFERENCE

101: first electrode, 102: EL layer, 103: second electrode, 111: hole-injection layer, 112: hole-transport layer, 113: light-emitting layer, 114: electron-transport layer, 115: electron-injection layer, 213: first light-emitting layer, 214: separation layer, 215: second light-emitting layer, 305: charge generation layer, 401: substrate, 402: insulating layer, 403: first electrode, 404: partition, 405: opening, 406: partition, 407: EL layer, 408: second electrode, 501: substrate, 503: scan line, 505: region, 506: partition, 508: data line, 509: connection wiring, 510: input terminal, 511a: FPC, 511b: FPC, 512: input terminal, 601: element substrate, 602: pixel portion, 603: driver circuit portion, 604: driver circuit portion, 605: sealing material, 606: sealing substrate, 607: wiring, 608: FPC, 609: n-channel TFT, 610: p-channel TFT, 611: switching TFT, 612: current control TFT, 613: anode, 614: insulator, 615: EL layer, 616: cathode, 617: light-emitting element, 618: space, 700: first EL layer, 701: second EL layer, 801: lighting device, 802: lighting device, 803: desk lamp, 1100: substrate, 1101: first electrode, 1103: second electrode, 1111: hole-injection layer, 1112: hole-transport layer, 1113: light-emitting layer, 1113a: first light-emitting layer, 1113b: second light-emitting layer, 1114: electron-transport layer, 1114a: first electron-transport layer, 1114b: second electron-transport layer, 1114c: third electron-transport layer, 1115: electron-injection layer, 7100: television device, 7101: housing, 7103: display portion, 7105: stand, 7107: display portion, 7109: operation key, 7110: remote controller, 7201: main body, 7202: housing, 7203: display portion, 7204: keyboard, 7205: external connection port, 7206: pointing device, 7301: housing, 7302: housing, 7303: joint portion, 7304: display portion, 7305: display portion, 7306: speaker portion, 7307: recording medium insertion portion, 7308: LED lamp, 7309: operation key, 7310: connection terminal, 7311: sensor, 7312: microphone, 7400: cellular phone, 7401: housing, 7402: display portion, 7403: operation button, 7404: external connection port, 7405: speaker, 7406: microphone, 7501: lighting portion, 7502: shade, 7503: adjustable arm, 7504: support, 7505: base, 7506: power switch.

This application is based on Japanese Patent Application serial no. 2010-264378 filed with Japan Patent Office on Nov. 26, 2010, and 2011-159263 filed with Japan Patent Office on Jul. 20, 2011, the entire contents of which are hereby incorporated by reference.

1. An organometallic complex comprising a partial structure represented by a general formula (G1): 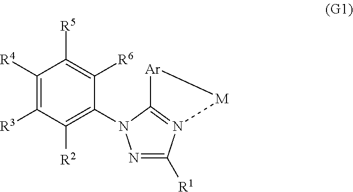
wherein Ar represents an arylene group having 6 to 13 carbon atoms,
wherein R¹ represents an alkyl group having 1 to 3 carbon atoms,
wherein R² to R⁶ individually represent any of hydrogen, an alkyl group having 1 to 4 carbon atoms, and a substituted or unsubstituted phenyl group,
wherein at least one of R², R³, R⁵, and R⁶ represents an alkyl group having 1 to 4 carbon atoms or a substituted or unsubstituted phenyl group, and
wherein M is a central metal and represents either an element belonging to Group 9 or an element belonging to Group 10.

2. The organometallic complex according to claim 1, represented by a general formula (G3): 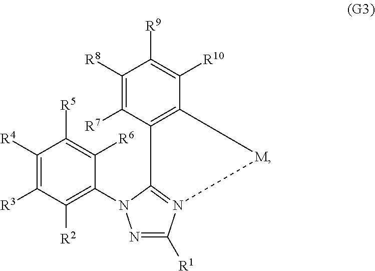
wherein R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group.

3. The organometallic complex according to claim 1, represented by a general formula (G5): 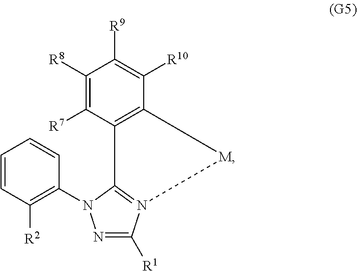
wherein R² represents either an alkyl group having 1 to 4 carbon atoms or a substituted or unsubstituted phenyl group.

4. The organometallic complex according to claim 1,
wherein R¹ represents any of a methyl group, an ethyl group, a propyl group, and an isopropyl group.

5. The organometallic complex according to claim 1,
wherein M is an iridium or a platinum.

6. A light-emitting element comprising the organometallic complex according to claim 1 between a pair of electrodes.

7. A light-emitting element comprising a light-emitting layer between a pair of electrodes,
wherein the light-emitting layer comprises the organometallic complex according to claim 1.

8. A light-emitting device comprising the light-emitting element according to claim 7.

9. An electronic device comprising the light-emitting element according to claim 7.

10. A lighting device comprising the light-emitting element according to claim 7.

11. An organometallic complex represented by a general formula (G2), 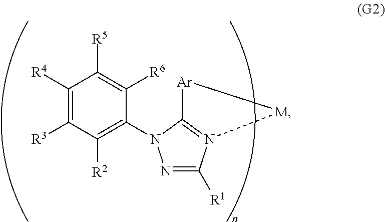
wherein Ar represents an arylene group having 6 to 13 carbon atoms,
wherein R¹ represents an alkyl group having 1 to 3 carbon atoms,
wherein R² to R⁶ individually represent any of hydrogen, an alkyl group having 1 to 4 carbon atoms, and a substituted or unsubstituted phenyl group,
wherein at least one of R², R³, R⁵, and R⁶ represents an alkyl group having 1 to 4 carbon atoms or a substituted or unsubstituted phenyl group,
wherein M is a central metal and represents either an element belonging to Group 9 or an element belonging to Group 10, and
wherein n is 3 when the central metal M is an element belonging to Group 9, or
n is 2 when the central metal M is an element belonging to Group 10.

12. The organometallic complex according to claim 11, represented by a general formula (G4): 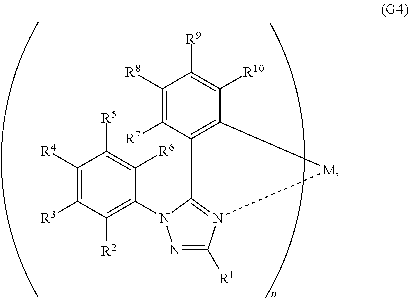
wherein R⁷ to R¹⁰ individually represent any of hydrogen, an alkyl group having 1 to 4 carbon atoms, an alkoxy group having 1 to 4 carbon atoms, an alkylthio group having 1 to 4 carbon atoms, a haloalkyl group having 1 to 4 carbon atoms, a halogen group, and a phenyl group.

13. The organometallic complex according to claim 11, represented by a general formula (G6): 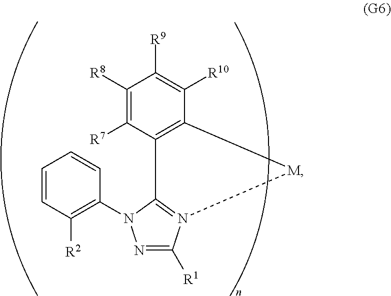
wherein R² represents either an alkyl group having 1 to 4 carbon atoms or a substituted or unsubstituted phenyl group.

14. The organometallic complex according to claim 11,
wherein R¹ represents any of a methyl group, an ethyl group, a propyl group, and an isopropyl group.

15. The organometallic complex according to claim 11,
wherein M is an iridium or a platinum.

16. A light-emitting element comprising the organometallic complex according to claim 11 between a pair of electrodes.

17. A light-emitting element comprising a light-emitting layer between a pair of electrodes,
wherein the light-emitting layer comprises the organometallic complex according to claim 11.

18. A light-emitting device comprising the light-emitting element according to claim 17.

19. An electronic device comprising the light-emitting element according to claim 17.

20. A lighting device comprising the light-emitting element according to claim 17.
